(19) United States
(12) Patent Application Publication
(10) Pub. No.: US 2023/0319808 A1
(43) Pub. Date: Oct. 5, 2023

(54) METHOD AND APPARATUS FOR BANDWIDTH PART SWITCHING AND DOWNLINK CONTROL INFORMATION INTERPRETATION IN WIRELESS COMMUNICATION SYSTEMS

(71) Applicant: Samsung Electronics Co., Ltd., Suwon-si (KR)

(72) Inventors: Kyungjun CHOI, Suwon-si (KR); Youngrok JANG, Suwon-si (KR); Hyoungju JI, Suwon-si (KR)

(21) Appl. No.: 18/192,307

(22) Filed: Mar. 29, 2023

(30) Foreign Application Priority Data
Mar. 31, 2022 (KR) 10-2022-0040787

(51) Int. Cl. H04W 72/0457; H04W 72/232; H04W 72/1273

(52) U.S. Cl. CPC H04W 72/0457; H04W 72/232; H04W 72/1273

(57) ABSTRACT

The disclosure relates to a 5G or 6G communication system for supporting a higher data transmission rate. A method for interpreting a DCI field in case that a BWP is switched by a UE that has received multi PDSCH scheduling and multi PUSCH scheduling configuration is provided. The method includes receiving a RRC message comprising a TDRA table information for scheduling multiple PDSCHs for at least one bandwidth part from a base station, receiving DCI comprising a bandwidth part indicator field and a TDRA field from an activated BWP, determining whether to switch the activated BWP, based on the bandwidth part indicator field, and when the bandwidth part indicator field indicates switching the activated BWP, receiving at least one PDSCH in an indicated BWP, based on at least one of the TDRA field, first TDRA table information of the activated BWP, or second TDRA table information of the indicated BWP.

### CROSS-REFERENCE TO RELATED APPLICATION(S)

This application is based on and claims priority under 35 U.S.C. § 119(a) of a Korean patent application number 10-2022-0040787, filed on Mar. 31, 2022, in the Korean Intellectual Property Office, the disclosure of which is incorporated by reference herein in its entirety.

### BACKGROUND

### 1. Field

The disclosure relates to operations of a user equipment (UE) and a base station in a wireless communication system. More particularly, the disclosure relates to a method for interpreting a downlink control information (DCI) format indicating bandwidth part switching in a case that a user equipment (UE) receives the DCI format, and an apparatus capable of performing the method.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as mmWave including 28 GHz and 39 GHz. In addition, it has been considered to implement 6^{th} generation 6G mobile communication technologies (referred to as Beyond 5G systems) in terahertz bands (e.g., 95 GHz to 3 terahertz (THz) bands) in order to accomplish transmission rates fifty times faster than 5G mobile communication technologies and ultra-low latencies one-tenth of 5G.

In the initial state of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive multiple input multiple output (MIMO) for alleviating radio-wave path loss and increasing radio-wave transmission distances in mmWave, numerology (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service fields regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting augmented reality (AR), virtual reality (VR), and the like (XR=AR+VR+MR), 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for schemes to smoothly provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for effectively providing a service in mobile communication systems.

More specifically, in a case that some fields of downlink control information (DCI) fields interpreted in the active bandwidth part are smaller than fields required for the indicated bandwidth part, the user equipment (UE) of the disclosure may interpret the DCI field by performing zero padding on the fields. In this case, the UE may not be able to operate according to scheduling intended by the base station. Accordingly, the disclosure provides a method by the UE for interpreting a DCI field without performing of zero padding or interpreting a DCI field by performing zero padding while considering a zero padded bit.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving a radio resource control (RRC) message including a time domain resource assignment (TDRA) table information for scheduling multiple physical downlink shared channels (PDSCHs) for each of at least one bandwidth part from a base station, receiving downlink control information (DCI) including a bandwidth part indicator field and a time domain resource assignment (TDRA) field from an active bandwidth part (BWP) of the base station, determining whether to switch the activated BWP, based on the bandwidth part indicator field, and in a case that the bandwidth part indicator field indicates switching of the activated BWP, receiving at least one PDSCH in an indicated BWP, based on at least one of the TDRA field, first TDRA table information of the activated BWP, or second TDRA table information of the indicated BWP.

In accordance with another aspect of the disclosure, a method performed by a base station in a wireless communication system is provided. The method includes transmitting a radio resource control (RRC) message including a time domain resource assignment (TDRA) table information for scheduling multiple physical downlink shared channels (PDSCHs) for each of at least one bandwidth part to a UE, and transmitting downlink control information (DCI) including a bandwidth part indicator field and a time domain resource assignment (TDRA) field in an active bandwidth part (BWP) to the UE, wherein whether to switch the activated BWP is determined based on the bandwidth part indicator field, and at least one PDSCH is received in the indicated BWP based on at least one of the TDRA field, first TDRA table information of the activated BWP, or second TDRA table information of an indicated BWP.

In accordance with another aspect of the disclosure, a user equipment (UE) in a wireless communication system is provided. The UE includes a transceiver configured to transmit or receive a signal and a processor, wherein the processor receives a radio resource control (RRC) message including a time domain resource assignment (TDRA) table information for scheduling multiple physical downlink shared channels (PDSCHs) for each of at least one bandwidth part from a base station, receives downlink control information (DCI) including a bandwidth part indicator field and a time domain resource assignment (TDRA) field from an active bandwidth part (BWP) of the base station, determines whether to switch the activated BWP, based on the bandwidth part indicator field, and in a case that the bandwidth part indicator field indicates switching of the activated BWP, receives at least one PDSCH in an indicated BWP, based on at least one of the TDRA field, first TDRA table information of the activated BWP, or second TDRA table information of the indicated BWP.

In accordance with another aspect of the disclosure, a base station in a wireless communication system is provided. The base station includes a transceiver configured to transmit or receive a signal and a processor, wherein the processor transmits a radio resource control (RRC) message including a time domain resource assignment (TDRA) table information for scheduling multiple physical downlink shared channels (PDSCHs) for each of at least one bandwidth part to a UE, and transmits downlink control information (DCI) including a bandwidth part indicator field and a time domain resource assignment (TDRA) field in an active bandwidth part (BWP) to the UE, whether to switch the activated BWP is determined based on the bandwidth part indicator field, and at least one PDSCH is received in the indicated BWP based on at least one of the TDRA field, first TDRA table information of the activated BWP, or second TDRA table information of an indicated BWP.

Various embodiments of the disclosure provide a method and an apparatus for effectively providing a service in mobile communication systems. Furthermore, an embodiment of the disclosure provides a method for interpreting a DCI field and an apparatus capable of performing the method in a case that downlink control information (DCI) indicating bandwidth part (BWP) switching is received by a UE.

As such, the UE may correctly interpret a field (e.g., scheduling information) within DCI so that a base station performs an intended operation for the UE, thus realizing effective communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a basic structure of a time-frequency domain in a wireless communication system according to an embodiment of the disclosure;

FIG. 2 is a view illustrating a structure of a frame, a subframe, and a slot in a wireless communication system according to an embodiment of the disclosure;

FIG. 3 is a view illustrating an example of a bandwidth part configuration in a wireless communication system according to an embodiment of the disclosure;

FIG. 4 is a view illustrating an example of a control resource set configuration of a downlink control channel in a wireless communication system according to an embodiment of the disclosure;

FIG. 5 is a view illustrating a structure of a downlink control channel in a wireless communication system according to an embodiment of the disclosure;

FIG. 6 is a view illustrating an example of a frequency axis resource allocation for a physical downlink shared channel (PDSCH) in a wireless communication system according to an embodiment of the disclosure;

FIG. 7 is a view illustrating an example of a time axis resource allocation for a physical downlink shared channel (PDSCH) in a wireless communication system according to an embodiment of the disclosure;

FIG. 8 is a view illustrating an example of a time axis resource allocation according to subcarrier spacings of a data channel and control channel in a wireless communication system according to an embodiment of the disclosure;

FIGS. 9A, 9B, and 9C are views illustrating a physical downlink shared channel (PDSCH) scheduling scheme according to various embodiments of the disclosure;

FIGS. 10A and 10B are views illustrating downlink control information (DCI) for single-PDSCH scheduling and multi-PDSCH scheduling according to various embodiments of the disclosure;

FIG. 11 is a view illustrating a method for transmitting hybrid automatic repeat request-acknowledgment (HARQ-ACK) of multiple physical downlink shared channels (PDSCHs) according to an embodiment of the disclosure;

FIG. 12 is a view illustrating bandwidth part switching and physical downlink shared channel (PDSCH) scheduling in a downlink control information (DCI) format according to an embodiment of the disclosure;

FIG. 13 is a view illustrating applying of zero padding and truncation to a downlink control information (DCI) field in case of switching a downlink control information (DCI) format according to an embodiment of the disclosure;

FIG. 14 is a view illustrating an operation of a UE according to an embodiment of the disclosure;

FIG. 15 is a view illustrating an operation of a UE according to an embodiment of the disclosure;

FIG. 16 is a view illustrating an operation of a UE according to an embodiment of the disclosure;

FIG. 17 is a view illustrating a structure of a UE in a wireless communication system according to an embodiment of the disclosure; and

FIG. 18 is a view illustrating a structure of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession are in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, in the embodiments, the “unit” may include one or more processors.

A wireless communication system is advancing to a broadband wireless communication system for providing high-speed and high-quality packet data services using communication standards, such as high-speed packet access (HSPA) of 3rd generation partnership project (3GPP), {long-term evolution (LTE) or evolved universal terrestrial radio access (E-UTRA)}, LTE-Advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) {or a mobile station (MS)} transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

First of all, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 16 years, because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and may also require a design to assign a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the above-described three services.

New Radio (NR) Time-Frequency Resource

Hereinafter, a frame structure of a 5G system will be described in detail with reference to the drawings.

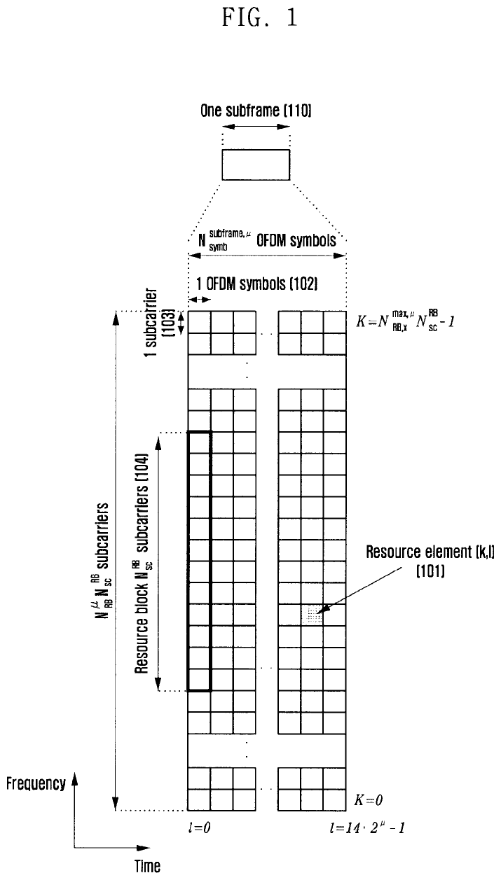

FIG. 1 is a view illustrating a basic structure of a time-frequency domain in a wireless communication system according to an embodiment of the disclosure.

Referring to FIG. 1, a horizontal axis indicates a time domain, and a vertical axis indicates a frequency domain. A basic unit of a resource in the time-frequency domain is a resource element (RE) 101 and may be defined as one orthogonal frequency division multiplexing (OFDM) symbol 102 in the time axis and one subcarrier 103 in the frequency axis. In the frequency domain, (e.g., 12) consecutive REs may constitute one resource block (RB) 104. Furthermore, N_{symb}^{subframe} consecutive OFDM symbols in a time domain may constitute a subframe 110.

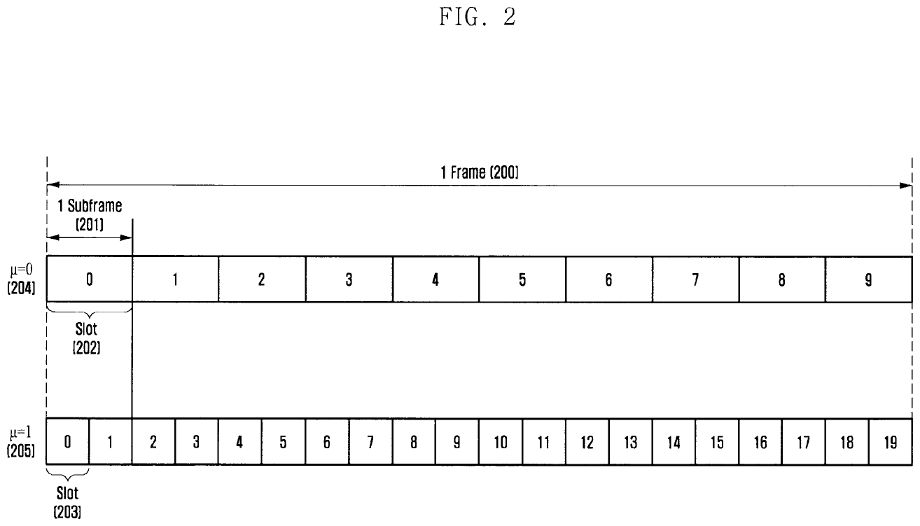

FIG. 2 is a view illustrating a structure of a frame, a subframe, and a slot in a wireless communication system according to an embodiment of the disclosure.

Referring to FIG. 2, an example of a structure including a frame 200, a subframe 201, and a slot 202 is illustrated. One frame 200 may be defined as 10 ms. One subframe 201 may be defined as 1 ms, and accordingly, one frame 200 may include a total of 10 subframes 201. One slot 202 or 203 may be defined as 14 OFDM symbols (that is, the number of symbols per slot (N_{symb}^{slot})=14). One subframe 201 may include one or multiple slots 202 and 203, and the number of slots 202 and 203 per subframe 201 may vary according to a configuration value μ (204 or 205) for subcarrier spacing. An example of FIG. 2 shows a case in which the subcarrier spacing configuration value corresponds to μ=0 (204) and a case in which the subcarrier spacing configuration value corresponds to μ=1 (205). In the case of μ=0 (204), one subframe 201 may include one slot 202, and, in the case of μ=1 (205), one subframe 201 may include two slots 203.

That is, the number (Nₛₗₒₜ^{subframe,μ}) of slots per subframe may vary according to the configuration value μ for subcarrier spacing, and accordingly, the number (Nₛₗₒₜ^{frame,μ}) of slots per frame may also vary. Nₛₗₒₜ^{subframe,μ} and Nₛₗₒₜ^{frame,μ} according to each subcarrier spacing configuration μ may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Bandwidth Part (BWP)

A bandwidth part (BWP) configuration in a 5G communication system will be described in detail with reference to drawings.

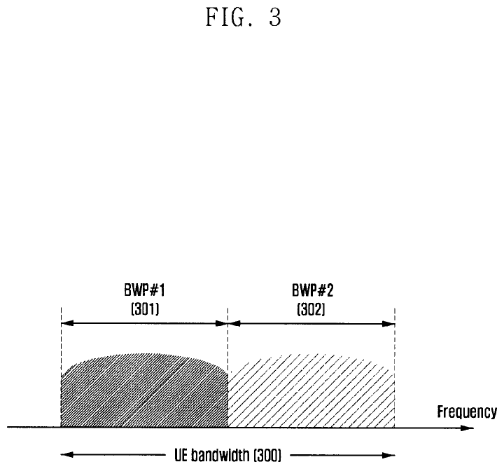

FIG. 3 is a view illustrating an example of a bandwidth part configuration in a wireless communication system according to an embodiment of the disclosure.

FIG. 3 shows an example in which a UE bandwidth (UE bandwidth) 300 is configured of two bandwidth parts, that is, bandwidth part #1 (BWP #1) 301 and bandwidth part #2 (BWP #2) 302. The base station may configure one or multiple bandwidth parts to the UE, and may configure information below for each bandwidth part.

TABLE 2

| | |
|---|---|
| BWP ::= | SEQUENCE { |
| bwp-Id | BWP-Id, |
| locationAndBandwidth | INTEGER(1..65536), |
| subcarrierSpacing | ENUMERATED {n0, n1, n2, n3, n4, |
| n5}, | |
| cyclicPrefix | ENUMERATED { extended } |
| } | |

Of course, without limitation to the examples described above, various parameters regarding a bandwidth part may be configured to the UE in addition to the configuration information. The information may be transferred to the UE by the base station through higher layer signaling, for example, radio resource control (RRC). Among one or multiple configured bandwidth parts, at least one bandwidth part may be activated. Information indicating whether the configured bandwidth parts is activated may be semi-statically transferred from the base station to the UE through RRC signaling or may be dynamically transferred through Downlink Control Information (DCI).

According to some embodiments, the UE before the radio resource control (RRC) connection may receive a configuration of an initial BWP for initial access from the base station through a master information block (MIB). More specifically, the UE may receive configuration information for a control resource set (CORESET) and a search space in which a physical downlink control channel (PDCCH) for receiving system information (possibly corresponding to remaining system information (RMSI) or system information block 1 (SIB1)) required for initial access through the MIB may be transmitted in an initial access step. Each of the control resource set and the search space configured through the MIB may be considered as an identity (ID) 0. The base station may inform the UE of configuration information such as frequency allocation information for control resource set #0, time allocation information, numerology, and the like through the MIB. Furthermore, the base station may inform the UE of configuration information for a monitoring period and an occasion of control resource set #0, that is, configuration information for search space #0 through the MIB. The UE may consider a frequency region configured as control resource set #0 acquired from the MIB as an initial bandwidth part for initial access. The ID of the initial BWP may be considered as 0.

The configuration of the bandwidth part supported by 5G may be used for various purposes.

According to some embodiments, when a bandwidth supported by the UE is smaller than the system bandwidth, the smaller bandwidth may be supported through the configuration of the bandwidth part. For example, the base station configures a frequency location (configuration information 2) of the bandwidth part in the UE, and thus the UE may transmit and receive data at a specific frequency location within the system bandwidth.

According to some embodiments, the base station may configure multiple bandwidth parts in the UE in order to support different numerologies. For example, in order to support a UE to perform data transmission and reception using both subcarrier spacing of 15 kHz and subcarrier spacing of 30 kHz, two bandwidth parts are configured as subcarrier spacings of 15 kHz and 30 kHz, respectively. Different bandwidth parts may be frequency-division-multiplexed, and when data is transmitted and received at particular subcarrier spacing, the bandwidth part configured at the corresponding subcarrier spacing may be activated.

Furthermore, according to some embodiments, the base station may configure bandwidth parts with different sized bandwidths in the UE in order to reduce power consumption of the UE. For example, when the UE supports a very large bandwidth, for example, a bandwidth of 100 MHz and always transmits and receives data through the corresponding bandwidth, very high power consumption may be caused. Particularly, monitoring an unnecessary downlink control channel through a large bandwidth of 100 MHz in a state having no traffic is very inefficient in terms of power consumption. In order to reduce power consumption of the UE, the base station may configure a bandwidth part having a relatively narrow bandwidth, for example, a bandwidth of 20 MHz to the UE. The UE may perform a monitoring operation in the bandwidth part of 20 MHz in the state having no traffic, and if data is generated, may transmit and receive data through the bandwidth part of 100 MHz according to an instruction from the base station.

In a method for configuring the bandwidth part, UEs before the RRC connection may receive configuration information for an initial bandwidth part through a master information block (MIB) in an initial access step. More specifically, the UE may receive a configuration of a control resource set (CORESET) for a downlink control channel in which downlink control information (DCI) for scheduling a system information block (SIB) may be transmitted from an MIB of a physical broadcast channel (PBCH). A bandwidth of the control resource set configured as the MIB may be considered as an initial bandwidth part, and the UE may receive a physical downlink shared channel (PDSCH), in which the SIB is transmitted, through the configured initial bandwidth part. The initial bandwidth part may be used not only for reception of the SIB but also used for other system information (OSI), paging, or random access.

Bandwidth Part (BWP) Switching

In a case that one or more bandwidth parts are configured in the UE, the base station may indicate a change (or change or transition) in the bandwidth parts to the UE through a bandwidth part indicator field within the DCI. For example, in FIG. 3, when a currently activated bandwidth part of the UE is bandwidth part #1 301, the base station indicates bandwidth part #2 302 to the UE through a bandwidth part indicator within downlink control information (DCI) and the UE makes a bandwidth part switching to bandwidth part #2 302 indicated by the received bandwidth part indicator within downlink control information (DCI).

As described above, since the DCI-based bandwidth part switching may be indicated by the DCI for scheduling the physical downlink shared channel (PDSCH) or the physical uplink shared channel (PUSCH), the UE should be able to receive or transmit the PDSCH or the PUSCH scheduled by the corresponding DCI in the changed bandwidth part without any difficulty if the UE receives a bandwidth part switching request. To this end, the standard has defined requirements for a delay time (T_{BWP}) required for the bandwidth part switching, and may be defined as Table 3, for example.

TABLE 3

| | |
|---|---|
| NR Slot length | BWP switch delay T_{BWP} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2
If the BWP switch involves changing of SCS, the BWP switch delay is determined by the larger one between the SCS before BWP switch and the SCS after BWP switch.

The requirements for the bandwidth part switching delay time support type 1 or type 2 according to a capability of the UE. The UE may report a supportable bandwidth part delay time type to the base station.

In a case that the UE receives DCI including a bandwidth part switching indicator in slot n according to the requirements for the bandwidth part switching delay time, the UE may complete a switching to a new bandwidth part indicated by the bandwidth part switching indicator at a time point that is not later than slot n+T_{BWP} and transmit and receive a data channel scheduled by the corresponding DCI in the switched new bandwidth part. In a case that the base station tries to schedule a data channel in the new bandwidth part, the base station may determine allocation of time domain resources for the data channel in consideration of the bandwidth part switching delay time (T_{BWP}) of the UE. That is, in case of scheduling the data channel in the new bandwidth part, the base station may schedule the corresponding data channel after the bandwidth part switching delay time when using a method of determining allocation of time domain resources for the data channel. Accordingly, the UE may not expect that the DCI indicating the bandwidth part switching indicates a slot offset (K0 or K2) value smaller than the bandwidth part switching delay time (T_{BWP}).

If the UE receives DCI (e.g., DCI format 1_1 or 0_1) indicating the bandwidth part switching, the UE may perform no transmission or reception during a time interval corresponding to symbols from a third symbol of a slot for receiving the PDCCH including the corresponding DCI to a start point of the slot indicated by the slot offset (K0 or K2) value indicated by a time domain resource allocation indicator field within the corresponding DCI. For example, in a case that the UE receives DCI indicating the bandwidth part switching in slot n and a slot offset value indicated by the corresponding DCI is K, the UE performs no transmission or reception from the third symbol of slot n to a symbol before slot n+K (that is, the last symbol of slot n+K−1).

Synchronization Signal (SS)/Physical Broadcast Channel (PBCH) Block

Subsequently, a synchronization signal (SS)/physical broadcast channel (PBCH) block in 5G to is described.

A synchronization signal (SS)/physical broadcast channel (PBCH) block may correspond to a physical layer channel block including a primary synchronization signal, (primary SS (PSS)), a secondary synchronization signal, (secondary SS (SSS)), and a physical broadcast channel (PBCH). A detailed description thereof is given below.
PSS: is a signal which is a reference of downlink time/frequency synchronization and provides partial information of a cell ID.
SSS: is a reference of downlink time/frequency synchronization and provides the remaining cell ID information which is not provided by the PSS. Additionally, the SSS serves as a reference signal (RS) for demodulation of a PBCH.
PBCH: provides necessary system information required for transmitting and receiving a data channel and a control channel by the UE. The necessary system information may include control information related to a search space indicating radio resource mapping information of a control channel, scheduling control information for a separate data channel for transmitting system information, and the like.
SS/PBCH block: includes a combination of PSS, SSS, and PBCH. One or multiple SS/PBCH blocks may be transmitted within a time of 5 ms, and each of the transmitted SS/PBCH blocks may be separated by an index.

The UE may detect the PSS and the SSS in an initial access stage and decode the PBCH. The UE may acquire a master information block (MIB) from the PBCH and receive a configuration of control resource set (CORESET) #0 (corresponding to a control resource set having control resource set index 0) therefrom. The UE may monitor control resource set #0 based on the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical random access channel (physical RACH (PRACH)) to the base station in consideration of the selected SS/PBCH block index, and the base station having received the PRACH may acquire the SS/PBCH block index selected by the UE. The base station may know which block is selected by the UE from among the SS/PBCH blocks and that control resource set #0 related thereto is monitored.

Physical downlink control channel (PDCCH): In relation to downlink control information (DCI)

Next, downlink control information (DCI) in a 5G system will be described in detail.

In the 5G system, scheduling information on uplink data (or a physical uplink shared channel (PUSCH)) or downlink data (or a physical downlink shared channel (PDSCH)) is transferred through DCI from a base station to a UE. The UE may monitor a fallback DCI format and a non-fallback DCI format for the PUSCH or the PDSCH. The fallback DCI format may be configured with a fixed field pre-defined between the base station and the UE, and the non-fallback DCI format may include a configurable field.

DCI may go through a channel coding and modulation process, and then be transmitted through a physical downlink control channel (PDCCH). A cyclic redundancy check (CRC) may be attached to a DCI message payload, and the CRC may be scrambled by a radio network temporary identifier (RNTI) corresponding to the identity of the UE.

Different types of RNTIs may be used according to the purpose of a DCI message, for example, UE-specific (UE-specific) data transmission, a power control command, a random access response, or the like. That is, an RNTI may not be explicitly transmitted, and may be transmitted after being included in a CRC calculation process. If the UE has received a DCI message transmitted on a PDCCH, the UE may identify a CRC by using an allocated RNTI, and if a CRC identification result is correct, the UE may identify that the message has been transmitted to the UE.

For example, a DCI scheduling the PDSCH for system information (SI) may be scrambled by a system information—radio network temporary identifier (system information RNTI (SI-RNTI)). DCI scheduling the PDSCH for a random access response (RAR) message may be scrambled by a random access—radio network temporary identifier (random access RNTI (RA-RNTI)). DCI scheduling the PDSCH for a paging (RAR) message may be scrambled by a paging—radio network temporary identifier (paging RNTI (P-RNTI)). DCI notifying a slot format indicator (SFI) may be scrambled by a slot format indicator-radio network temporary identifier (slot format indicator RNTI (SFI-RNTI)). DCI notifying a transmit power control (TPC) may be scrambled by a transmit power control—radio network temporary identifier (transmit power control RNTI (TPC-RNTI)). DCI scheduling a UE-specific PDSCH or PUSCH may be scrambled by a cell-radio network temporary identifier, cell RNTI (cell RNTI (C-RNTI)).

DCI format 0_0 may be used for fallback DCI scheduling a PUSCH, and in this case, a CRC may be scrambled by a C-RNTI. DCI format 0_0 having a CRC scrambled by a C-RNTI may include, for example, the information in Table 4.

TABLE 4
- Identifier for DCI formats - [1] bit
- Frequency domain resource assignment - [┌log₂ (N_{RB}^{UL, BWP} (N_{RB}^{UL, BWP} + 1)/2)┐] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- TPC command for scheduled PUSCH - [2] bits
- UL/SUL indicator - 0 or 1 bit

DCI format 0_1 may be used for non-fallback DCI scheduling a PUSCH, and in this case, a CRC may be scrambled by a C-RNTI. DCI format 0_1 having a CRC scrambled by a C-RNTI may include, for example, the information in Table 5.

```
TABLE 5
- Carrier indicator − 0 or 3 bits
- UL/SUL indicator − 0 or 1 bit
- Identifier for DCI formats − [1] bits
- Bandwidth part indicator − 0, 1 or 2 bits
- Frequency domain resource assignment
    • For resource allocation type 0, ┌N_{RB}^{UL,BWP} / P┐ bits
    • For resource allocation type 1, ┌log₂(N_{RB}^{UL,BWP}(N_{RB}^{UL,BWP} +
    1)/2)┐ bits
- Time domain resource assignment −1, 2, 3, or 4 bits
- VRB-to-PRB mapping − 0 or 1 bit, only for resource allocation type 1.
    • 0 bit if only resource allocation type 0 is configured;
    • 1 bit otherwise.
- Frequency hopping flag − 0 or 1 bit, only for resource allocation type 1.
    • 0 bit if only resource allocation type 0 is configured;
    • 1 bit otherwise.
- Modulation and coding scheme − 5 bits
- New data indicator − 1 bit
- Redundancy version − 2 bits
- HARQ process number − 4 bits
- 1st downlink assignment index − 1 or 2 bits
    • 1 bit for semi-static HARQ-ACK codebook;
    • 2 bits for dynamic HARQ-ACK codebook with single HARQ-ACK
    codebook.
- 2nd downlink assignment index − 0 or 2 bits
    • 2 bits for dynamic HARQ-ACK codebook with two HARQ-ACK
    sub-codebooks( [symbol]  HARQ-ACK;
    • 0 bit otherwise.
- TPC command for scheduled PUSCH − 2 bits
$\begin{matrix}‐ SRS resource indicator ( SRS ) - ⌈ {log}_{2} ( {\sum }_{k = 1}^{{L}_{max}} ( \begin{matrix}{N}_{SRS} \\ k\end{matrix} ) ) ⌉ or \\ ⌈ {log}_{2} ( {N}_{SRS} ) ⌉ bits\end{matrix}$
    $\begin{matrix} ⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH \\ transmission ;\end{matrix}$
    • ┌log₂(N_{SRS})┐ bits for codebook based PUSCH transmission
- Precoding information and number of layers−up to 6 bits
- Antenna ports − up to 5 bits
- SRS request − 2 bits
- CSI request − 0, 1, 2, 3, 4, 5, or 6 bits
- CBG transmission information − 0, 2, 4, 6, or 8 bits
- PTRS-DMRS association − 0 or 2 bits.
- beta_offset indicator − 0 or 2 bits
- DMRS sequence initialization − 0 or 1 bit
```

DCI format 1_0 may be used for fallback DCI scheduling a PDSCH, and in this case, a CRC may be scrambled by a C-RNTI. DCI format 1_0 having a CRC scrambled by a C-RNTI may include, for example, the information in Table 6.

TABLE 6
- Identifier for DCI formats - [1] bit
- Frequency domain resource assignment -[┌log₂ (N_{RB}^{DL, BWP} (N_{RB}^{DL, BWP} + 1)/2)┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- PUCCH resource indicator - 3 bits
- PDSCH-to-HARQ feedback timing indicator - [3] bits

DCI format 1_1 may be used for non-fallback DCI scheduling a PDSCH, and in this case, a CRC may be scrambled by a C-RNTI. DCI format 1_1 having a CRC scrambled by a C-RNTI may include, for example, the information in Table 7.

```
TABLE 7
- Carrier indicator - 0 or 3 bits
- Identifier for DCI formats - [1] bits
- Bandwidth part indicator - 0, 1 or 2 bits
- Frequency domain resource assignment
  • For resource allocation type 0, ┌N_{RB}^{DL, BWP}/P┐ bits
  • For resource allocation type 1, ┌log₂ (N_{RB}^{DL, BWP} (N_{RB}^{DL, BWP} + 1)/2)┐ bits
- Time domain resource assignment -1, 2, 3, or 4 bits
- VRB-to-PRB mapping - 0 or 1 bit, only for resource allocation type 1.
  • 0 bit if only resource allocation type 0 is configured;
  • 1 bit otherwise.
- PRB bundling size indicator - 0 or 1 bit
- Rate matching indicator - 0, 1, or 2 bits
- ZP CSI-RS trigger - 0, 1, or 2 bits
For transport block 1:
  - Modulation and coding scheme - 5 bits
  - New data indicator - 1 bit
  - Redundancy version - 2 bits
For transport block 2:
  - Modulation and coding scheme - 5 bits
  - New data indicator - 1 bit
  - Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

Physical Downlink Control Channel (PDCCH): Control Resource Set (CORESET), Resource Element Group (REG), Control Channel Element (CCE), and Search Space

The downlink control channel in the 5G communication system will be described below in more detail with reference to the drawings.

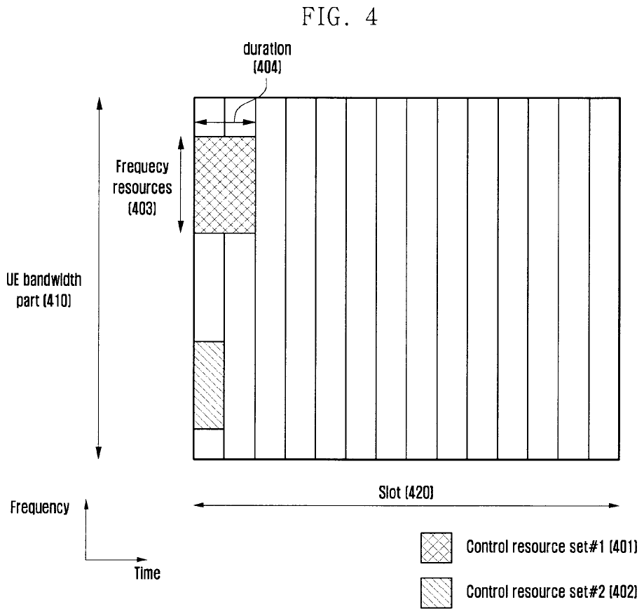

FIG. 4 is a view illustrating an example of a configuration of a control resource set (CORESET) through which a downlink control channel is transmitted in the 5G communication system according to an embodiment of the disclosure.

Referring to FIG. 4, a UE bandwidth part 410 is configured in the frequency axis and two control resource sets (control resource set #1 401 and control resource set #2 402) are configured within one slot 420 in the time axis. The control resource sets 401 and 402 may be configured in a specific frequency resource 403 within the entire UE bandwidth part 410 on the frequency axis. The control resource set may be configured as one or multiple orthogonal frequency division multiplexing (OFDM) symbols in the time axis, which may be defined as a control resource set duration 404. Referring to FIG. 4, control resource set #1 401 may be configured as a control resource set duration of 2 symbols, and control resource set #2 402 may be configured as a control resource set duration of 1 symbol.

The aforementioned control resource set in 5G may be configured in the UE by the base station via higher layer signaling (e.g., system information, a master information block (MIB), and radio resource control (RRC) signaling). Configuring a control resource set in a UE refers to providing information, such as an identity of the control resource set, a frequency position of the control resource set, and a symbol length of the control resource set. For example, information in Table 8 may be included.

TABLE 8

| | |
|---|---|
| ControlResourceSet ::= | SEQUENCE { |

```
    -- Corresponds to L1 parameter ‘CORESET-ID’
    controlResourceSetId
    ControlResourceSetId,
```

| | |
|---|---|
| frequencyDomainResources | BIT |

```
STRING(SIZE(45)),
    duration
    INTEGER(1..maxCoReSetDuration),
    cce-REG-MappingType
    CHOICE {
      interleaved
    SEQUENCE {
        reg-BundleSize
    ENUMERATED {n2, n3, n6},
        precoderGranularity
    ENUMERATED {sameAsREG-bundle, allContiguousRBs},
        interleaverSize
    ENUMERATED {n2, n3, n6}
        shiftIndex
    INTEGER(0..maxNrofPhysicalResourceBlocks-1)
          OPTIONAL
  },
```

| | |
|---|---|
| nonInterleaved | NULL |

```
    },
    tci-StatesPDCCH
    SEQUENCE(SIZE(1..maxNrofTCI-StatesPDCCH)) OF TCI-StateId
        OPTIONAL,
```

| | |
|---|---|
| tci-PresentInDCI | ENUMERATED |

```
{enabled}
        OPTIONAL, -- Need S
  }
```

In Table 8, tci-StatesPDCCH (simply, referred to as a transmission configuration indication (TCI) state) configuration information may include information on one or multiple synchronization signal (SS)/physical broadcast channel (PBCH) block indexes or channel state information reference signal (CSI-RS) indexes having the quasi co-located (QCL) relationship with a demodulation reference signal (DMRS) transmitted in the corresponding control resource set.

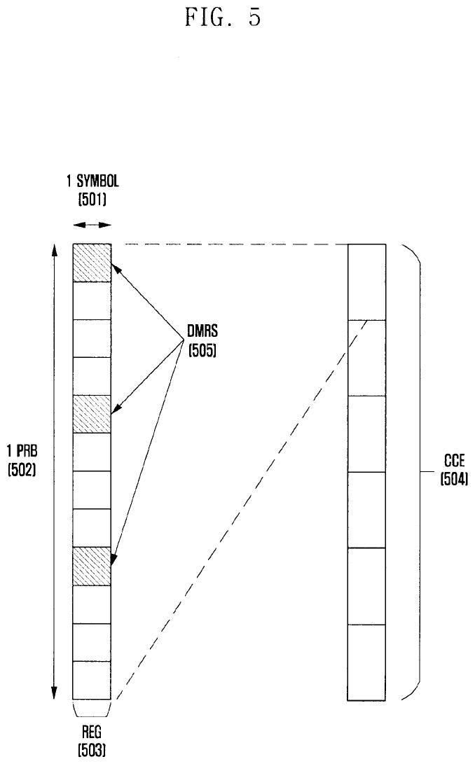

FIG. 5 is a view illustrating a structure of a downlink control channel in a wireless communication system according to an embodiment of the disclosure.

Referring to FIG. 5, the basic unit of time and frequency resources included in the control channel may be referred to as a resource element group (REG) 503, and the REG 503 may be defined as one orthogonal frequency division multiplexing (OFDM) symbol 501 in the time axis and one physical resource block (PRB) 502 in the frequency axis, that is, as 12 subcarriers. The base station may configure a downlink control channel allocation unit by concatenating the REGs 503.

As illustrated in FIG. 5, if the basic unit in which the downlink control channel is allocated in the 5G system is a control channel element (CCE) 504, one CCE 504 may consist of multiple REGs 503. Taking the REG 503 illustrated in FIG. 5 as an example, the REG 503 may include 12 resource elements (REs) and, when 1 CCE 504 includes 6 REGs 503, 1 CCE 504 may include 72 REs. In a case that a downlink control resource set is configured, the corresponding region may include multiple CCEs 504, and a specific downlink control channel may be mapped to one or multiple CCEs 504 according to an aggregation level (AL) within the control resource set and then transmitted. CCEs 504 within the control resource set may be distinguished by numbers and the numbers of the CCEs 504 may be assigned according to a logical mapping scheme.

The basic unit REG 503 of a downlink control channel shown in FIG. 5 may include both REs to which DCI is mapped and an area to which a demodulation reference signal (DMRS) 505 corresponding to a reference signal for decoding the REs are mapped. As shown in FIG. 5, 3 DMRSs 505 may be transmitted within 1 REG 503. The number of CCEs required to transmit a physical downlink control channel (PDCCH) may be 1, 2, 4, 8, or 16 depending on an aggregation level (AL), and different numbers of CCEs may be used to implement link adaptation of the downlink control channel. For example, in a case that AL=L, a single downlink control channel is transmitted via L CCEs. The UE needs to detect a signal without knowing information on the downlink control channel, wherein a search space representing a set of CCEs is defined for blind decoding. The search space is a set of downlink control channel candidates including CCEs, for which the UE needs to attempt decoding on a given aggregation level, and since there are various aggregation levels that make one bundle with 1, 2, 4, 8, or 16 CCEs, the UE may have multiple search spaces. The search space set may be defined to be a set of search spaces at all configured aggregation levels.

The search space may include a common search space and a UE-specific search space. A certain group of UEs or all UEs may monitor a common search space of a PDCCH in order to receive cell-common control information, such as a paging message or dynamic scheduling for system information. For example, physical downlink shared channel (PDSCH) scheduling allocation information for transmission of an SIB including cell operator information, and the like, is received by monitoring the common search space of the PDCCH. Since a certain group of UEs or all UEs need to receive the PDCCH, the common search space may be defined as a set of predetermined CCEs. Scheduling allocation information for a UE-specific PDSCH or PUSCH may be received by monitoring a UE-specific search space of the PDCCH. The UE-specific search space may be defined UE-specifically, based on an identity of the UE and functions of various system parameters.

In 5G, a parameter for a search space for a PDCCH may be configured for the UE by the base station through higher layer signaling (e.g., a system information block (SIB), a master information block (MIB), and radio resource control (RRC) signaling). For example, the base station is configured, for the UE, the number of PDCCH candidates of each aggregation level L, a monitoring periodicity for a search space, a monitoring occasion in units of symbols in a slot for the search space, a search space type (common search space or UE-specific search space), a combination of an RNTI and a DCI format, which is to be monitored in the search space, a control resource set index for monitoring of the search space, etc. For example, information in Table 9 may be included.

TABLE 9

| | |
|---|---|
| SearchSpace ::= | SEQUENCE { |

-- Identity of the search space. SearchSpaceId = 0 identifies the SearchSpace
configured via PBCH(MIB) or ServingCellConfigCommon.

| | |
|---|---|
| searchSpaceId | SearchSpaceId, |
| controlResourceSetId | ControlResourceSetId, |
| monitoringSlotPeriodicityAndOffset | CHOICE { |
| sl1 | NULL, |
| sl2 | INTEGER(0..1), |
| sl4 | INTEGER(0..3), |
| sl5 | INTEGER(0..4), |
| sl8 | INTEGER(0..7), |
| sl10 | INTEGER(0..9), |
| sl16 | INTEGER(0..15), |
| sl20 | INTEGER(0..19) |

}

OPTIONAL,

| | |
|---|---|
| duration | INTEGER(2..2559) |

| | |
|---|---|
| monitoringSymbolsWithinSlot | BIT |

STRING(SIZE(14))
OPTIONAL,

| | |
|---|---|
| nrofCandidates | SEQUENCE { |

```
        aggregationLevel1
      ENUMERATED {n0, n1, n2, n3, n4, n5, n6, n8},
        aggregationLevel2
      ENUMERATED {n0, n1, n2, n3, n4, n5, n6, n8},
        aggregationLevel4
      ENUMERATED {n0, n1, n2, n3, n4, n5, n6, n8},
        aggregationLevel8
      ENUMERATED {n0, n1, n2, n3, n4, n5, n6, n8},
        aggregationLevel16
      ENUMERATED {n0, n1, n2, n3, n4, n5, n6, n8}
      },
```

| | |
|---|---|
| searchSpaceType | CHOICE { |

```
        -- Configures this search space as common search space(CSS) and DCI
formats to monitor.
        common
      SEQUENCE {
}
        ue-Specific
      SEQUENCE {
```

-- Indicates whether the UE monitors in this USS for DCI

formats 0-0 and 1-0 or for formats 0-1 and 1-1.

formats

ENUMERATED {formats0-0-And-1-0, formats0-1-And-1-1},

...

}

According to configuration information, the base station may configure one or multiple search space sets in the UE. According to some embodiments, the base station may configure search space set 1 and search space 2 in the UE, and the configuration may be performed such that DCI format A scrambled by an X-RNTI in search space set 1 is monitored in the common search space and DCI format B scrambled by a Y-RNTI in search space set 2 is monitored in the UE-specific search space.

According to the configuration information, one or multiple search space sets may exist in the common search space or the UE-specific search space. For example, search space set #1 and search space set #2 are configured to be a common search space, and search space set #3 and search space set #4 may be configured to be a UE-specific search space.

In the common search space, the following combinations of DCI formats and RNTIs may be monitored. Of course, the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. Of course, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and uses below.

Cell RNTI (C-RNTI): For UE-specific PDSCH scheduling

Temporary cell RNTI (TC-RNTI): For UE-specific PDSCH scheduling

Configured scheduling RNTI (CS-RNTI): For semi-statically configured UE-specific PDSCH scheduling

Random-Access RNTI (RA-RNTI): For PDSCH scheduling during random-access

Paging RNTI (P-RNTI): For scheduling PDSCH on which paging is transmitted

System Information RNTI (SI-RNTI): For scheduling PDSCH on which system information is transmitted

Interruption RNTI (INT-RNTI): For indicating whether to puncture PDSCH

Transmit power control for PUSCH RNTI (TPC-PUSCH-RNTI): For indicating power control command for PUSCH

Transmit power control for PUCCH RNTI (TPC-PUCCH-RNTI): For indicating power control command for PUCCH

Transmit power control for SRS RNTI (TPC-SRS-RNTI): For indicating power control command for sounding reference signal (SRS)

The specified DCI formats described above may conform to the following definition in Table 10 below.

TABLE 10

| DCI format | Usage |
|---|---|
| 0-0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and PUSCH |
| 2_3 | Transmission of a group of TPC commands for SRS |
| | transmissions by one or more UEs |

In 5G, a control resource set p and a search space of aggregation level L in control resource set s may be expressed as Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing within control resource set p
n_{s,f}^{μ}: slot index
M_{s,max}^{(L)}: number of PDCCH candidates at aggregation level L
m_{s,n}_{_{CI=0}}, . . . , M_{s,max}^{(L)}−1: index of PDCCH candidate at aggregation level L
i=0, . . . , L−1
Y_{p,n}_{_{s,f}}_{^{μ}}=(Aₚ·Y_{p,n}_{_{s,f}}_{^{μ}}₋₁) mod D, Y_{p·-1}=n_{RNTI}≠0,
   Aₚ=39827 for pmod3=0, Aₚ=39829 for pmod3=1,
   Aₚ=39839 for pmod3=2, D=65537
n_{RNTI}: UE identifier
Y_{p,n}_{_{s,f}}_{^{μ}} value may correspond to 0 in the case of the common search space.
Y_{p,n}_{_{s,f}}_{^{μ}} value may correspond to a value varying depending on a UE identity (a C-RNTI or an ID configured in the UE by the base station) and a time index in the case of the UE-specific search space.

Since multiple search space sets may be configured as different parameters (e.g., the parameters in Table 9) in 5G, a search space set which the UE monitors may be different each time. For example, in a case that search space set #1 is configured on an X-slot period, search space set #2 is configured on a Y-slot period, and X and Y are different from each other, the UE may monitor all of search space set #1 and search space set #2 in a specific slot and monitor one of search space set #1 and search space set #2 in another specific slot.

Physical Downlink Shared Channel (PDSCH): In Relation to Frequency Resource Allocation

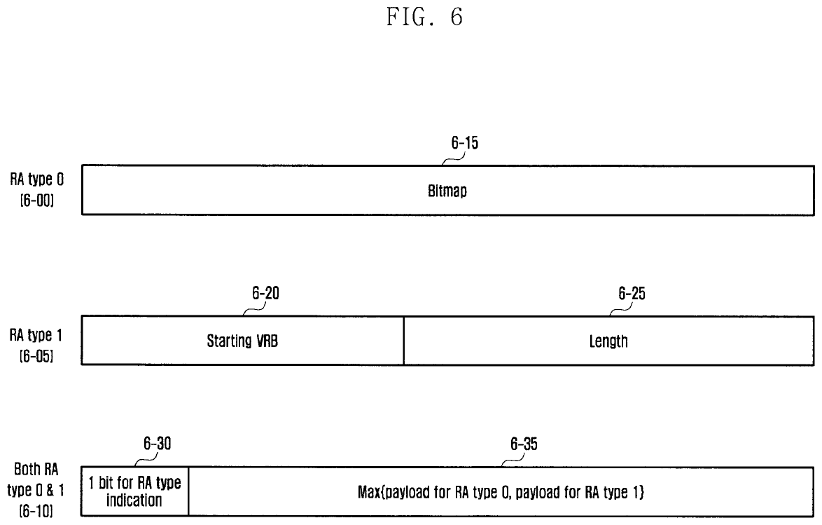

FIG. 6 is a view illustrating an example of a frequency axis resource allocation for a physical downlink shared channel (PDSCH) in a wireless communication system according to an embodiment of the disclosure.

FIG. 6 illustrates three frequency axis resource allocation methods of type 0 6-00, type 1 6-05, and dynamic switch 6-10 which may be configured through a higher layer in an NR wireless communication system.

Referring to FIG. 6, in a case that the UE is configured to use only resource type 0 through higher-layer signaling (6-00), some pieces of downlink control information (DCI) for allocating the PDSCH to the corresponding UE includes a bitmap of NRBG bits. A condition therefor will be described again below. In this case, NRBG is the number of resource block groups (RBGs) determined as shown in Table 11 below according to a BWP size allocated by a BWP indicator and a higher-layer parameter rbg-Size, and data is transmitted to an RBG indicated as 1 by the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In a case that the UE is configured to use only resource type 1 through higher-layer signaling (6-05), some pieces of DCI for allocating the PDSCH to the corresponding UE has frequency axis resource allocation information including ┌leg₂ (N_{RB}^{DL,BWP} (N_{RB}^{DL,BWP}+1)/2┐ bits. A condition therefor is described again below. The base station may configure a starting VRB 6-20 and a length 6-25 of frequency axis resources allocated sequentially therefrom.

In a case that the UE is configured to use both resource type 0 and resource type 1 through higher-layer signaling (6-10), some pieces of DCI for allocating the PDSCH to the corresponding UE includes frequency axis resource allocation information of bits of a larger value 6-35, including RA type indication 6-30, among payload 6-15 for configuring resource type 0 and payload 6-20 and 6-25 for configuring resource type 1. A condition therefor is described again below. One bit may be added to the first part (most significant bit (MSB)) of the frequency axis resource allocation information within the DCI, and the use of resource type 0 may be indicated when the corresponding bit is “0” and the use of resource type 1 may be indicated when the corresponding bit is “1”.

Physical Downlink Shared Channel (PDSCH)/Physical Uplink Shared Channel (PUSCH): In Relation to Time Resource Allocation

A time domain resource allocation method for a data channel in a next-generation mobile communication system (5G or NR system) is described below.

The base station may configure, for the UE via higher layer signaling (e.g., RRC signaling), a table for time domain resource allocation information on a downlink data channel (physical downlink shared channel (PDSCH)) and an uplink data channel (physical uplink shared channel (PUSCH)). A table including up to 16 entries (maxNrofDL-Allocations=16) may be configured for the PDSCH, and a table including up to 16 entries (maxNrofUL-Allocations=16) may be configured for the PUSCH. In an embodiment, the time domain resource allocation information may include a PDCCH-to-PDSCH slot timing (corresponding to a time interval in units of slots between a time point at which a PDCCH is received and a time point at which a PDSCH scheduled by the received PDCCH is transmitted, and denoted as K0), a PDCCH-to-PUSCH slot timing (corresponding to a time interval in units of slots between a time point at which a PDCCH is received and a time point at which a PUSCH scheduled by the received PDCCH is transmitted, and denoted as K2), information on a position and length of a start symbol in which the PDSCH or PUSCH is scheduled within a slot, a mapping type of the PDSCH or PUSCH, or the like. For example, information shown in Table 12 or Table 13 below may be transmitted from the base station to the UE.

TABLE 12
PDSCH-TimeDomainResourceAllocationList information element

| PDSCH-TimeDomainResourceAllocationList ::= SEQUENCE | |
|---|---|
| (SIZE(1..maxNrofDL-Allocations)) OF | |
| PDSCH-TimeDomainResourceAllocation | |
| PDSCH-TimeDomainResourceAllocation ::= SEQUENCE { | |
| k0 | INTEGER(0..32) |
| OPTIONAL, -- Need S | |
| mappingType | ENUMERATED {typeA, typeB}, |
| startSymbolAndLength | INTEGER (0..127) |

}

TABLE 13
PDSCH-TimeDomainResourceAllocationList information element

| | |
|---|---|
| PDSCH-TimeDomainResourceAllocationList ::= | SEQUENCE |

(SIZE(1..maxNrofDL-Allocations)) OF
PDSCH-TimeDomainResourceAllocation
PDSCH-TimeDomainResourceAllocation ::= SEQUENCE {

| | | |
|---|---|---|
| K2 | INTEGER(0..32) | OPTIONAL, |

-- Need S

| | |
|---|---|
| mappingType | ENUMERATED {typeA, typeB}, |
| startSymbolAndLength | INTEGER (0..127) |

}

The base station may notify of one among the entries in the tables for the time domain resource allocation information to the UE via L1 signaling (e.g., DCI) (e.g., the entry may be indicated by a “time domain resource allocation” field in the DCI). The UE may acquire the time domain resource allocation information for the PDSCH or PUSCH, based on the DCI received from the base station.

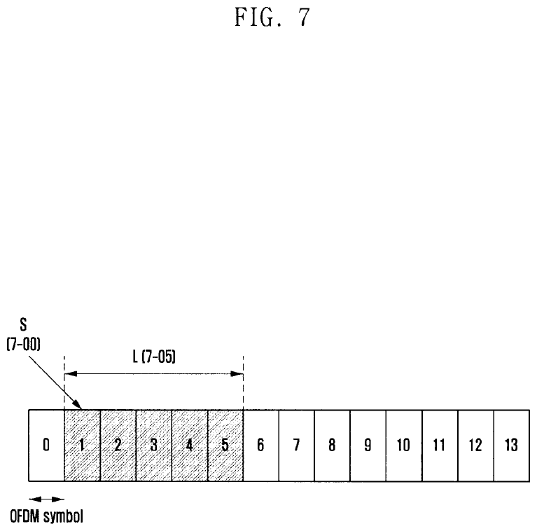

FIG. 7 is a view illustrating an example of a time axis resource allocation for a physical downlink shared channel (PDSCH) in a wireless communication system according to an embodiment of the disclosure.

Referring to FIG. 7, the base station may indicate a time axis location of PDSCH resources according to subcarrier spacing (SCS) (μ_{PDSCH}, μ_{PDCCH}) of a data channel and a control channel configured using a higher layer, a scheduling offset (K0) value, and an OFDM symbol start location 7-00 and length 7-05 within one slot dynamically indicated through DCI.

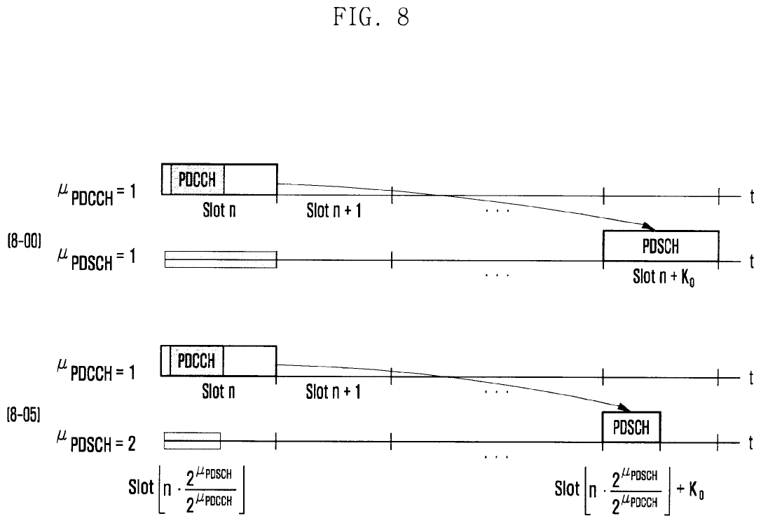

FIG. 8 is a view illustrating an example of a time axis resource allocation according to subcarrier spacings of a data channel and control channel in a wireless communication system according to an embodiment of the disclosure.

Referring to FIG. 8, in a case that subcarrier spacings of a data channel and a control channel are the same as each other (μ_{PDSCH}=μ_{PDCCH}) (8-00), slot numbers for the data and the control are the same as each other, and thus the base station and the UE may generate a scheduling offset according to a predetermined slot offset K0. On the other hand, in a case that subcarrier spacings of a data channel and a control channel are different from each other (μ_{PDSCH}≠μ_{PDCCH}) (8-05), slot numbers for the data and the control are different from each other, and thus the base station and the UE may generate a scheduling offset according to a predetermined slot offset K0 based on subcarrier spacing of the physical downlink control channel (PDCCH).

Physical Uplink Shared Channel (PUSCH): In Relation to Transmission Scheme

Next, a physical uplink shared channel (PUSCH) transmission scheduling scheme will be described. PUSCH transmission may be dynamically scheduled by a UL grant in downlink control information (DCI), or may be operated by configured grant Type 1 or Type 2. The indication of the dynamic scheduling for the PUSCH transmission may be by DCI format 0_0 or 0_1.

Configured grant Type 1 PUSCH transmission may be semi-statically configured through reception of configuredGrantConfig including rrc-ConfiguredUplinkGrant in Table 14 via higher signaling, without reception of the UL grant in the DCI. Configured grant Type 2 PUSCH transmission may be semi-persistently scheduled by the UL grant in the DCI after the reception of configuredGrantConfig not including rrc-ConfiguredUplinkGrant in Table 14, via higher signaling. When the PUSCH transmission is operated by a configured grant, parameters to be applied to the PUSCH transmission are applied via higher signaling configuredGrantConfig in Table 14, except dataScramblingIdentityPUSCH, txConfig, codebookSubset, maxRank, and scaling of UCI-OnPUSCH provided via higher signaling pusch-Config in Table 15. When the UE is provided with transformPrecoder in higher signaling configuredGrantConfig in Table 14, the UE applies tp-pi2BP2K in pusch-Config in Table 15 for the PUSCH transmission operated by the configured grant.

TABLE 14
ConfiguredGrantConfig ::= SEQUENCE {

| frequencyHopping | ENUMERATED {intraSlot, interSlot} | OPTIONAL, -- Need S, |
|---|---|---|
| cg-DMRS-Configuration | DMRS-UplinkConfig, | |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| uci-OnPUSCH | SetupRelease { CG-UCI-OnPUSCH } | OPTIONAL, -- Need M |
| resourceAllocation | ENUMERATED { resourceAllocationType0, resourceAllocationType1, dynamicSwitch }, | |
| rbg-Size | ENUMERATED {config2} | OPTIONAL, -- Need S |
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- Need S |
| nrofHARQ-Processes | INTEGER(1..16), | |
| repK | ENUMERATED {n1, n2, n4, n8}, | |
| repK-RV | ENUMERATED {s1-0231, s2-0303, s3-0000} | OPTIONAL, -- Need R |

| | |
|---|---|
| periodicity | ENUMERATED { |
| | sym2, sym7, sym1x14, sym2x14, sym4x14, sym5x14, sym8x14, sym10x14, sym16x14, |
| | sym20x14, sym32x14, sym40x14, sym64x14, sym80x14, sym128x14, sym160x14, sym256x14, |
| | sym320x14, sym512x14, sym640x14, sym1024x14, sym1280x14, sym2560x14, sym5120x14, |
| | sym6, sym1x12, sym2x12, sym4x12, sym5x12, sym8x12, sym10x12, sym16x12, sym20x12, |
| | sym32x12, sym40x12, sym64x12, sym80x12, sym128x12, sym160x12, sym256x12, sym320x12, |
| | sym512x12, sym640x12, sym1280x12, sym2560x12 |

},

| configuredGrantTimer | INTEGER (1..64) | OPTIONAL, -- Need R |
|---|---|---|
| rre-ConfiguredUplinkGrant | SEQUENCE { | |
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- Need R |
| precodingAndNumberOfLayers | INTEGER (0..63), | |
| srs-ResourceIndicator | INTEGER (0..15) | OPTIONAL, -- Need R |
| mcsAndTBS | INTEGER (0..31), | |
| frequencyHoppingOffset | INTEGER (1.. maxNrofPhysicalResourceBlocks-1) | OPTIONAL, -- Need R |

| | |
|---|---|
| pathlossReferenceIndex | INTEGER (0..maxNrofPUSCH-PathlossReferenceRSs-1), |

...

| | |
|---|---|
| } | OPTIONAL, -- Need R |

...
}

Next, a PUSCH transmission method will be described. A demodulation reference signal (DMRS) antenna port for PUSCH transmission is identical to an antenna port for sounding reference signal (SRS) transmission. The PUSCH transmission may follow a codebook-based transmission method or a non-codebook-based transmission method according to whether a value of txConfig in higher signaling pusch-Config in Table 15 is “codebook” or “nonCodebook”.

As described above, the PUSCH transmission may be dynamically scheduled through DCI format 0_0 or 0_1, and may be semi-statically configured by the configured grant.

If the scheduling for the PUSCH transmission is indicated to the UE through DCI format 0_0, the UE may perform beam configuration for PUSCH transmission by using pucch-spatialRelationInfoID corresponding to a UE-specific PUCCH resource corresponding to a minimum ID in an activated uplink BWP in a serving cell, wherein the PUSCH transmission is based on a single antenna port. The UE does not expect scheduling for PUSCH transmission through DCI format 0_0 in a BWP in which a PUCCH resource including pucch-spatialRelationInfo is not configured.

If txConfig in pusch-Config in Table 15 is not configured for the UE, the UE does not expect to be scheduled by DCI format 0_1.

TABLE 15

| PUSCH-Config ::= | SEQUENCE { | |
|---|---|---|
| dataScramblingIdentityPUSCH | INTEGER (0..1023) | OPTIONAL, -- Need S |
| txConfig | ENUMERATED {codebook, nonCodebook} | OPTIONAL, -- Need S |
| dmrs-UplinkForPUSCH-MappingTypeA | SetupRelease { DMRS-UplinkConfig } | OPTIONAL, -- Need M |
| dmrs-UplinkForPUSCH-MappingTypeB | SetupRelease { DMRS-UplinkConfig } | OPTIONAL, -- Need M |
| pusch-PowerControl | PUSCH-PowerControl | OPTIONAL, -- Need M |
| frequencyHopping | ENUMERATED {intraSlot, interSlot} | OPTIONAL, -- Need S |
| frequencyHoppingOffsetLists | SEQUENCE (SIZE (1..4)) OF INTEGER (1.. maxNrofPhysicalResourceBlocks-1) | |
| | | OPTIONAL, -- Need M |
| resourceAllocation | ENUMERATED { resourceAllocationType0, resourceAllocationType1, dynamicSwitch], | |
| pusch-TimeDomainAllocationList | SetupRelease { | OPTIONAL, -- Need M |
| | PUSCH-TimeDomainResourceAllocationList } | |
| pusch-AggregationFactor | ENUMERATED [ n2, n4, n8 ] | OPTIONAL, -- Need S |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| transformPrecoder | ENUMERATED {enabled, disabled} | OPTIONAL, -- Need S |
| codebookSubset | ENUMERATED {fullyAndPartialAndNonCoherent, partialAndNonCoherent,nonCoherent} | |
| | | OPTIONAL, -- Cond codebookBased |
| maxRank | INTEGER (1..4) | OPTIONAL, -- Cond codebookBased |
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK | ENUMERATED {enabled} | OPTIONAL, -- Need S |

...
}

Next, codebook-based PUSCH transmission will be described. The codebook-based PUSCH transmission may be dynamically scheduled by DCI format 0_0 or 0_1, and may be semi-statically operated by the configured grant. When the codebook-based PUSCH is dynamically scheduled by DCI format 0_1 or semi-statically configured by the configured grant, the UE may determine a precoder for PUSCH transmission, based on an SRS resource indicator (SRI), a transmission precoding matrix indicator (TPMI), and a transmission rank (the number of PUSCH transmission layers).

In this case, the SRI may be given via an SRS resource indicator field in the DCI, or may be configured through higher signaling srs-ResourceIndicator. When the codebook-based PUSCH transmission is performed, at least one SRS resource is configured for the UE, and maximum two SRS resources may be configured. When the SRI is provided to the UE via the DCI, the SRS resource indicated by the corresponding SRI means an SRS resource corresponding to the SRI, among SRS resources transmitted earlier than a PDCCH including the corresponding SRI. In addition, the TPMI and the transmission rank may be given via a precoding information and number of layers field in the DCI, or may be configured via higher signaling precodingAndNumberOfLayers. The TPMI is used to indicate a precoder applied to the PUSCH transmission. When one SRS resource is configured for the UE, the TPMI is used to indicate a precoder to be applied to the one configured SRS resource. When multiple SRS resources are configured for the UE, the TPMI is used to indicate a precoder to be applied to an SRS resource indicated via the SRI.

The precoder to be used for the PUSCH transmission is selected from an uplink codebook having the number of antenna ports, which is identical to a nrofSRS-Ports value in the higher signaling SRS-Config. In the codebook-based PUSCH transmission, the UE determines a codebook subset, based on the TPMI and codebookSubset in the higher signaling pusch-Config. The codebookSubset in the higher signaling pusch-Config may be configured as one of “fullyAndPartialAndNonCoherent”, “partialAndNonCoherent”, or “nonCoherent”, based on the UE capability reported to the base station by the UE. If the UE has reported “partialAndNonCoherent” as UE capability, the UE does not expect that a value of the higher signaling codebookSubset is to be configured as “fullyAndPartialAndNonCoherent”. In addition, when the UE has reported “nonCoherent” as UE capability, the UE does not expect that a value of the higher signaling codebookSubset is to be configured as “fullyAndPartialAndNonCoherent” or “partialAndNonCoherent”. When nrofSRS-Ports in the higher signaling SRS-ResourceSet indicates two SRS antenna ports, the UE does not expect that a value of the higher signaling codebookSubset is to be configured as “partialAndNonCoherent”.

One SRS resource set having the usage value configured as “codebook” within the higher signaling SRS-ResourceSet, may be configured for the UE, and one SRS resource in the corresponding SRS resource set may be indicated via the SRI. When there are several SRS resources configured in the SRS resource set having the usage value configured as “codebook” within the higher signaling SRS-ResourceSet, the UE expects that, as the value of nrofSRS-Ports in the higher signaling SRS-Resource, the same value is to be configured for all SRS resources.

The UE transmits one or multiple SRS resources included in the SRS resource set having the usage value configured as “codebook” according to the higher signaling, and the base station selects one of the SRS resources transmitted by the UE, and indicates the UE to perform PUSCH transmission, by using transmission beam information of the corresponding SRS resource. In this case, in the codebook-based PUSCH transmission, the SRI is used as information for selecting an index of the SRS resource, and is included in the DCI. Additionally, the base station includes information indicating the rank and the TPMI to be used when the UE performs PUSCH transmission, in the DCI. The UE performs the PUSCH transmission by applying a precoder indicated by the rank and the TPMI indicated based on the transmission beam of the corresponding SRS resource, by using the SRS resource indicated by the SRI.

Next, the non-codebook-based PUSCH transmission will be described. The non-codebook-based PUSCH transmission may be dynamically scheduled via DCI format 0_0 or 0_1, and may be semi-statically operated by the configured grant. When at least one SRS resource is configured in the SRS resource set having the usage value configured as “nonCodebook” within the higher signaling SRS-ResourceSet, the non-codebook-based PUSCH transmission may be scheduled to the UE via DCI format 0_1.

For the SRS resource set having the usage value configured as “nonCodebook” within the higher signaling SRS-ResourceSet, one connected non-zero power CSI-RS (NZP CSI-RS) resource may be configured for the UE. The UE may calculate a precoder for SRS transmission through measurement for an NZP CSI-RS resource connected to the SRS resource set. When the interval between the last reception symbol of the aperiodic NZP CSI-RS resource connected to the SRS resource set and the first symbol of the aperiodic SRS transmission has a value less than 42, the UE does not expect that information on the precoder for the SRS transmission is to be updated.

When the value of resourceType in the higher-layer signaling SRS-ResourceSet is configured as “aperiodic”, the connected NZP CSI-RS is indicated by an SRS request corresponding to a field in DCI format 0_1 or 1_1. In this case, when the connected NZP CSI-RS resource corresponds to an aperiodic NZP CSI-RS resource, it is indicated that the connected NZP CSI-RS exists for a case where a value of the SRS request field in DCI format 0_1 or 1_1 does not correspond to “00”. In this case, the corresponding DCI should not indicate cross-carrier or cross-BWP scheduling. In addition, when the value of the SRS request indicates the existence of the NZP CSI-RS, the corresponding NZP CSI-RS is positioned in a slot in which a PDCCH including the SRS request field is transmitted. In this case, TCI states configured for the scheduled subcarrier are not configured as QCL-TypeD.

When the periodic or semi-persistent SRS resource set is configured, the connected NZP CSI-RS may be indicated through associatedCSI-RS in the higher signaling SRS-ResourceSet. For the non-codebook-based transmission, the UE does not expect that higher signaling spatialRelationInfo for the SRS resource and the associatedCSI-RS in the higher signaling SRS-ResourceSet are configured together.

When multiple SRS resources are configured for the UE, the UE may determine the transmission rank and the precoder to be applied for the PUSCH transmission, based on the SRI indicated by the base station. In this case, the SRI may be indicated through an SRS resource indicator field in the DCI, or may be configured via higher signaling srs-ResourceIndicator. Similar to the above-described codebook-based PUSCH transmission, when the SRI is provided to the UE via the DCI, the SRS resource indicated by the corresponding SRI may mean an SRS resource corresponding to the SRI, among the SRS resources transmitted earlier than the PDCCH including the corresponding SRI. The UE may use one or multiple SRS resources for the SRS transmission, and the maximum number of SRS resources and the maximum number of SRS resources which may be simultaneously transmitted in the same symbol within one SRS resource set are determined by UE capability reported to the base station. In this case, the SRS resources simultaneously transmitted by the UE occupy the same RB. The UE configures one SRS port for each SRS resource. Only one SRS resource set having the usage value being configured as “nonCodebook” within the higher-layer signaling SRS-ResourceSet may be configured, and maximum four SRS resources for non-codebook-based PUSCH transmission may be configured.

The base station transmits one NZP-CSI-RS connected to the SRS resource set to the UE, and the UE calculates a precoder to be used during transmission of one or multiple SRS resources in the corresponding SRS resource set, based on the result of measurement during reception of the corresponding NZP-CSI-RS. The UE applies the calculated precoder when transmitting, to the base station, one or multiple SRS resources in the SRS resource set having the usage configured as “nonCodebook”, and the base station selects one or multiple SRS resources from among the received one or multiple SRS resources. In this case, the SRI in the non-codebook-based PUSCH transmission indicates an index which may represent one or a combination of multiple SRS resources, and the SRI is included in the DCI. The number of SRS resources indicated by the SRI transmitted by the base station may correspond to the number of transmission layers of the PUSCH, and the UE applies the precoder, applied to the SRS resource transmission, to each layer to transmit the PUSCH.

Hereinafter, an embodiment of the disclosure will be described in detail with reference to the accompanying drawings. The contents of the disclosure may be applicable to frequency division duplex (FDD) and time duplex division (TDD) systems. Hereinafter, in the disclosure, higher signaling (or higher-layer signaling) may be a method of transmitting a signal from the base station to the UE through a downlink data channel of a physical layer or from the UE to the base station through an uplink data channel of a physical layer, and may also be referred to as radio resource control (RRC) signaling, packet data convergence protocol (PDCP) signaling, or a medium access control (MAC) control element (CE) (MAC CE).

Hereinafter, in the disclosure, in case of determining whether to apply cooperative communication, the UE may use various methods by which PDCCH(s) allocating PDSCHs to which cooperative communication is applied have specific formats, PDCCH(s) allocating PDSCHs to which cooperative communication is applied include a specific indicator informing of whether cooperative communication is applied, PDCCH(s) allocating PDSCHs to which cooperative communication is applied are scrambled by a specific RNTI, or the application of cooperative communication to a specific section indicated by a higher layer is assumed. Hereinafter, for convenience of description, reception of, by the UE, a PDSCH to which cooperative communication is applied based on conditions similar to the above conditions is referred to as an NC-if case.

In the disclosure, determining the priority between A and B may refer to selecting the one having a higher priority according to a predetermined priority rule and performing an operation corresponding thereto, or omitting or dropping an operation corresponding to the one having a lower priority, etc.

In the disclosure, the embodiments are described above through multiple embodiments, but these are not independent and it is possible that one or multiple embodiments may be applied simultaneously or in combination.

Hereinafter, an embodiment of the disclosure will be described in detail with reference to the accompanying drawings. Hereinafter, a base station, as an entity that allocates resources to a UE, may be at least one of a gNode B, a gNB, an eNode B, a Node B, a base station (BS), a wireless access unit, a base station controller, and a node on a network. A user equipment (UE) may include a terminal, a mobile station (MS), a cellular phone, a smartphone, a computer, or a multimedia system capable of performing communication functions. Hereinafter, an embodiment of the disclosure will be described using a 5G system as an example, but the embodiment of the disclosure may be applied to other communication systems having a similar technical background or channel type. For example, an LTE or LTE-A mobile communication and a mobile communication technology developed after 5G are included therein. Accordingly, the embodiments of the disclosure can be applied to other communication systems through some modifications without significantly departing from the scope of the disclosure as determination made by a person skilled in the art. The contents of the disclosure may be applicable to FDD and TDD systems.

In the following description of the disclosure, a detailed description of related functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, a higher-layer signaling may be signaling corresponding to at least one or a combination of multiple of signalings below.
Master Information Block (MIB)
System Information Block (SIB) or SIB X (X=1, 2, . . . )
Radio Resource Control (RRC)
Medium Access Control (MAC) Control Element (CE)

In addition, L1 signaling may be signaling corresponding to at least one of signaling methods using the physical layer channels or signalings below or a combination of multiple of the methods.
Physical Downlink Control Channel (PDCCH)
Downlink Control Information (DCI)
UE-specific DCI
Group common DCI
Common DCI
Scheduling DCI (e.g., DCI used for scheduling downlink or uplink data)
Non-scheduling DCI (e.g., DCI not for scheduling downlink or uplink data)
Physical Uplink Control Channel (PUCCH)
Uplink Control Information (UCI)

In the disclosure, determining the priority between A and B may refer to selecting the one having a higher priority according to a predetermined priority rule and performing an operation corresponding thereto, or omitting or dropping an operation corresponding to the one having a lower priority, etc.

In the disclosure, the embodiments are described above through multiple embodiments, but these are not independent and it is possible that one or multiple embodiments may be applied simultaneously or in combination.

In Relation to Multi-Physical Downlink Shared Channel (PDSCH)/Physical Uplink Shared Channel (PUSCH) Scheduling

A new scheduling method has been introduced in Rel-17 new radio (NR) of 3^{rd} Generation Partnership Project (3GPP).

The new scheduling method may be applied to the disclosure. The new scheduling method introduced in Rel-17 NR is “multi-physical downlink shared channel scheduling (multi-PDSCH scheduling)” in which one piece of DCI enables scheduling of one or multiple physical downlink shared channels (PDSCHs) and “multi-physical downlink shared channel scheduling (multi-PUSCH scheduling)” in which one piece of downlink control information (DCI) enables scheduling of one or multiple physical uplink shared channels (PUSCHs). In multiple PDSCHs or multiple PUSCHs, each PDSCH or each PUSCH transmits a different transport block (TB).

By using the multi-PDSCH scheduling and the multi-PUSCH scheduling, the base station does not schedule multiple pieces of DCI for scheduling of each of multiple PDSCHs or multiple PUSCHs for the UE, and thus, overhead of a downlink control channel may be reduced. However, since one piece of DCI for the multi-PDSCH scheduling and multi-PUSCH scheduling needs to include scheduling information for multiple PDSCHs or multiple PUSCHs, the size of the DCI may be increased. To this end, when multi-PDSCH scheduling and multi-PUSCH scheduling are configured for the UE, a method for the UE to properly interpret the DCI is required.

The disclosure has described multi-PDSCH scheduling, but the embodiments proposed in the disclosure may be used in multi-PUSCH scheduling.

The base station may configure multi-PDSCH scheduling for the UE. This allows the base station to explicitly configure, for the UE, multi-PDSCH scheduling in a higher layer signal (e.g., a radio resource control (RRC) signal or RRC message). This allows the base station to implicitly configure, for the UE, multi-PDSCH scheduling in a higher layer signal (e.g., an RRC signal).

For multi-PDSCH scheduling for the UE, the base station may configure a time domain resource assignment (TDRA) table via a higher layer signal (e.g., an RRC signal) as follows. One or multiple rows of the TDRA table may be included. The number of the rows may be configured to be up to N_rows, and a unique index may be assigned to each row. The unique index may be one value among 1, 2, . . . , N_row. Here, N_row may preferably be 16.

One or multiple pieces of scheduling information may be configured for each row. In a case that one piece of scheduling information is configured in one row, the row schedules one PDSCH. That is, in a case that the row is indicated, it may be referred that single-PDSCH scheduling is indicated. When multiple pieces of scheduling information are configured in one row, the multiple pieces of scheduling information are used to schedule multiple PDSCHs in order. That is, in a case that the row is indicated, it may be referred that multi-PDSCH scheduling is indicated.

The scheduling information may correspond to K0, SLIV, and PDSCH mapping type. That is, in a case that multi-PDSCH scheduling is indicated, the row may include multiple K0, SLIV, and PDSCH mapping types. N-th K0, SLIV, and PDSCH mapping type are scheduling information of an N-th PDSCH. For reference, one row may include a maximum of N_pdsch K0 values, SLIVs, and PDSCH mapping types. Preferably, N_pdsch=8. That is, one row may schedule up to 8 PDSCHs.

K0 indicates a slot in which a PDSCH is scheduled, and indicates a slot difference between a slot, in which a PDCCH transmitting DCI for scheduling of the PDSCH is received, and the slot in which the PDSCH is scheduled. That is, if K0=0, the PDSCH and the PDCCH are the same slot. The starting and length indicator value (SLIV) indicates an index of a symbol in which the PDSCH starts and the number of consecutive symbols to which the PDSCH is allocated within one slot. The PDSCH mapping type indicates information related to a position of a first DMRS (front-loaded DMRS) of the PDSCH. In a case of PDSCH mapping type A, the first DMRS (front-loaded DMRS) of the PDSCH starts at a third symbol or a fourth symbol of the slot, and in a case of PDSCH mapping type B, the first DMRS (front-loaded DMRS) of the PDSCH starts at a first symbol of symbols in which the PDSCH is scheduled.

When the row of the TDRA table is configured in the higher layer signal, some of the K0 value, SLIV, PDSCH mapping type may be omitted from scheduling information. In this case, interpretation as a default value is possible. For example, if K0 is omitted, a value of K0 interpreted to be 0. When the row of the TDRA table is configured, information other than the K0 value, SLIV, and PDSCH mapping type may be additionally configured.

A description will be given assuming that multi-PDSCH scheduling is configured for the UE, but the disclosure is not limited thereto. The multi-PDSCH scheduling configuration is to configure multiple pieces of scheduling information in at least one row of the TDRA table. For reference, one piece of scheduling information may be configured in another row of the TDRA table. Therefore, even if multi-PDSCH scheduling is configured for the UE, single-PDSCH scheduling may be indicated or multi-PDSCH scheduling may be indicated to the UE according to a TDRA field of the received DCI. In other words, the multi-PDSCH scheduling indication is a case in which the row of the TDRA table indicated to the UE from the DCI includes multiple pieces of scheduling information, and the single-PDSCH scheduling indication is a case in which the row of the TDRA table indicated to the UE from the DCI includes one piece of scheduling information.

In the case of single-PDSCH scheduling indication, one PDSCH is scheduled, and the one PDSCH requires information, such as a modulation coding scheme (MCS), a new data indicator (NDI), a redundancy version (RV), and a hybrid automatic repeat request process number (HARQ Process Number (HPN)). To this end, DCI indicating single-PDSCH scheduling needs to include information, such as an MCS, an NDI, an RV, and an HPN of the one PDSCH.

More specifically,
The DCI indicating single-PDSCH scheduling may include one modulation coding scheme (MCS) field. An MCS (i.e., a modulation scheme and a code rate of a channel code) indicated in the MCS field may be applied to one PDSCH scheduled by the DCI.
The DCI indicating single-PDSCH scheduling may include a 1-bit new data indicator (NDI) field. An NDI value may be acquired from the 1-bit NDI field, and whether one PDSCH transmits a new transport block or retransmits a previous transport block may be determined based on the NDI value.
The DCI indicating single-PDSCH scheduling may include a 2-bit redundancy version (RV) field. An RV value may be acquired from the 2-bit RV field, and a redundancy version of one PDSCH may be determined based on the RV value.
The DCI for single-PDSCH scheduling may include one HARQ process number (HPN) field. The one HPN field may be 4 bits. (For reference, if the UE supports up to 32 HARQ processes, the HPN field may be extended to 5 bits, but an assumption of 4 bits is made for the convenience in description of the disclosure). One HARQ process ID may be indicated via the one HPN field. The one HARQ process ID may be an HARQ process ID of one scheduled PDSCH.

When multi-PDSCH scheduling is indicated, multiple PDSCHs are scheduled, and thus, each PDSCH needs information, such as an MCS, an NDI, an RV, and an HPN. To this end, DCI indicating multi-PDSCH scheduling needs to include information, such as an MCS, an NDI, an RV, and an HPN of each scheduled PDSCH.

More specifically,
The DCI indicating multi-PDSCH scheduling may include one MCS field. An MCS (i.e., a modulation scheme and a code rate of a channel code) indicated in the MCS field may be applied to all PDSCHs scheduled by the DCI. That is, the DCI for multi-PDSCH scheduling cannot schedule different PDSCHs by using different MCSs.
The DCI indicating multi-PDSCH scheduling may include a K-bit NDI field. K may be a largest value in the number of scheduling information included in each row of the TDRA table. For example, when the TDRA table includes two rows, a first row includes 4 pieces of scheduling information, and a second row includes 8 pieces of scheduling information, K is equal to 8 (K=8). A k-th bit of the K-bit NDI field may indicate an NDI value of the PDSCH corresponding to k-th scheduling information. That is, a k-th PDSCH acquires the NDI value from the k-th bit of the K-bit NDI field, and whether the k-th PDSCH transmits a new transport block or retransmits a previous transport block may be determined based on the NDI value.
The DCI indicating multi-PDSCH scheduling may include a K-bit RV field. A k-th bit of the K-bit RV field may indicate an RV value of the PDSCH corresponding to k-th scheduling information. That is, the k-th PDSCH acquires the RV value from the k-th bit of the K-bit RV field, and a redundancy version of the k-th PDSCH may be determined based on the RV value.
The DCI indicating multi-PDSCH scheduling may include one HPN field. The one HPN field may be 4 bits. (For reference, if the UE supports up to 32 HARQ processes, the HPN field may be extended to 5 bits, but an assumption of 4 bits is made for the convenience in description of the disclosure). One HARQ process ID may be indicated via the one HPN field. The one HARQ process ID may be an HARQ process ID of a first PDSCH among PDSCHs scheduled by the DCI indicating multi-PDSCH scheduling. The first PDSCH corresponds to first scheduling information. HPNs of subsequent PDSCHs are sequentially increased by 1. That is, in a case of a second PDSCH (corresponding to second scheduling information), an HPN is a value obtained by increasing the HARQ process ID of the first PDSCH by 1. For reference, if the HARQ process ID exceeds a maximum HARQ process ID number (numOfHARQProcessID) configured for the UE, a modulo operation is performed. In other words, if the HARQ process ID indicated by DCI is “x”, an HARQ process ID of the k-th PDSCH is determined as follows.

HPN of k-th PDSCH=(x+k−1) modulo numOfHARQProcessID

As described above, when DCI indicates single-PDSCH scheduling, the DCI includes a 1-bit NDI field or a 2-bit RV field, and when DCI indicates multi-PDSCH scheduling, the DCI includes a K-bit NDI field or a K-bit RV field. For reference, a single-PDSCH scheduling indication or a multi-PDSCH scheduling indication is made in a TDRA field of DCI (that is, whether single-PDSCH scheduling is indicated or multi-PDSCH scheduling is indicated is determined according to the number of pieces of scheduling information included in a row of the indicated TDRA field). Accordingly, one piece of DCI should support both single-PDSCH scheduling and multi-PDSCH scheduling. If a length of DCI for the single-PDSCH scheduling indication and a length of DCI for the multi-PDSCH scheduling indication are different from each other, “0” should be added (padded) to DCI of a shorter length so as to match the lengths.

A procedure of DCI interpretation by the UE is as follows.

The UE receives DCI. In this case, it is assumed that a length of the DCI is a larger value between the length of the DCI for single-PDSCH scheduling indication and the length of the DCI for multi-PDSCH scheduling indication.

The UE may identify a position of the TDRA field in the DCI. The position of the TDRA field in the DCI for single-PDSCH scheduling indication and that in the DCI for multi-PDSCH scheduling indication may be the same.

The UE may determine, through the TDRA field, whether the DCI is for single-PDSCH scheduling indication or for multi-PDSCH scheduling indication. If the number of pieces of scheduling information included in an indicated row of the TDRA field is one, the DCI is determined to be for single-PDSCH scheduling indication, and if the number of pieces of scheduling information included in the row is two or more, the DCI is determined to be for multi-PDSCH scheduling indication.

If the UE determines that the DCI is for single-PDSCH scheduling indication, the DCI may be interpreted according to the determination. That is, it may be interpreted that an NDI field is 1 bit and an RV field is 2 bits.

If the UE determines that the DCI is for multi-PDSCH scheduling indication, the DCI may be interpreted according to the determination. That is, it may be interpreted that an NDI field is K bit and an RV field is K bits. For reference, positions of other fields in the DCI may vary according to a length of the NDI field or a length of the RV field. Therefore, for other fields, according to whether the DCI is for single-PDSCH scheduling indication or for multi-PDSCH scheduling indication, bit lengths of other fields may be the same, but positions within the DCI may be different.

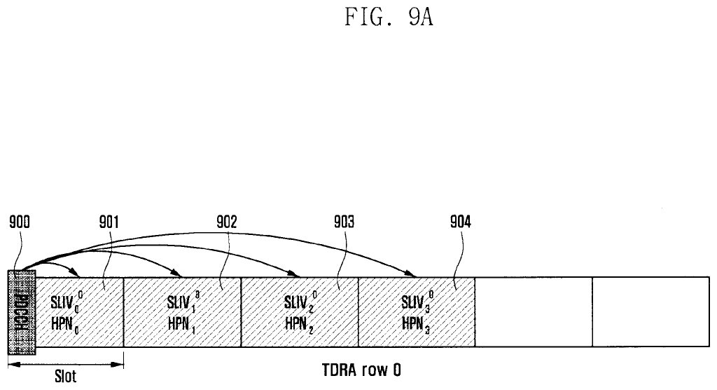

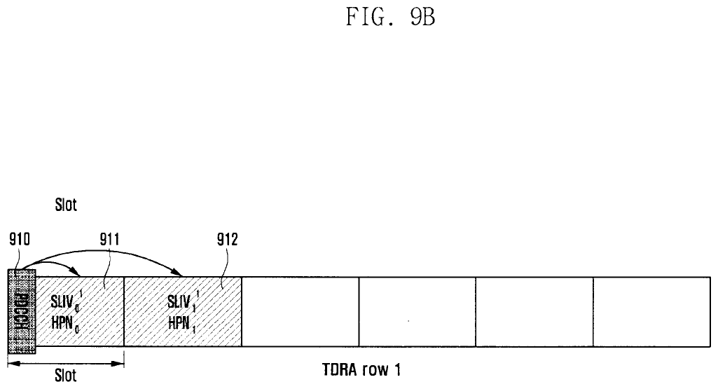

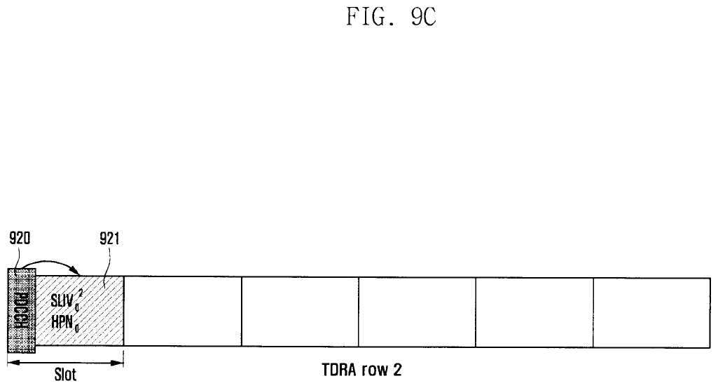

FIGS. 9A to 9C are views illustrating a physical downlink shared channel (PDSCH) scheduling scheme according to various embodiments of the disclosure.
A first row (row 0) of a time domain resource assignment (TDRA) table includes four pieces of scheduling information (K0, SLIV, and PDSCH mapping type). A first SLIV is referred to as SLIV⁰₀, a second SLIV is referred to as SLIV⁰₁, a third SLIV is referred to as SLIV⁰₂, and a fourth SLIV is referred to as SLIV⁰₃. Accordingly, when a UE is indicated with the first row (row 0) of the TDRA table, it may be determined that multi-PDSCH scheduling is indicated.
A second row (row 1) of a TDRA table includes four pieces of scheduling information (K0, SLIV, and PDSCH mapping type). A first SLIV is referred to as SLIV¹₀, and a second SLIV is referred to as SLIV¹₁. Accordingly, when the UE is indicated with the second row (row 1) of the TDRA table, it may be determined that multi-PDSCH scheduling is indicated.
A third row (row 2) of the TDRA table includes one piece of scheduling information (K0, SLIV, and PDSCH mapping type). An SLIV is referred to as SLIV²₀. Accordingly, when the UE is indicated with the third row (row 2) of the TDRA table, it may be determined that single-PDSCH scheduling is indicated.

FIG. 9A is a view illustrating a case in which the UE is indicated with the first row (row 0) of the TDRA table. In downlink control information (DCI) received by the UE in a physical downlink control channel (PDCCH) 900, the TDRA field may be indicated with the first row (row 0). Accordingly, the UE may receive four PDSCHs, based on four pieces of scheduling information (K0, SLIV, and PDSCH mapping type) in the first row (row 0). Symbols for receiving a first physical downlink shared channel (PDSCH) 901 may be identified based on SLIV⁰₀ that is a first start and length indicator value (SLIV), symbols for receiving a second PDSCH 902 may be identified based on SLIV⁰₁ that is a second SLIV, symbols for receiving a third PDSCH 903 may be identified based on SLIV⁰₂ that is a third SLIV, and symbols for receiving a fourth PDSCH 904 may be identified based on SLIV⁰₃ that is a fourth SLIV. Each of the four PDSCHs may have a unique hybrid automatic repeat request (HARQ) process ID.

That is, the first PDSCH may have HPN₀ as an HARQ process ID, the second PDSCH may have HPN₁ as an HARQ process ID, the third PDSCH may have HPN₂ as an HARQ process ID, and the fourth PDSCH may have HPN₃ as an HARQ process ID. The DCI indicates the HARQ process ID of the first PDSCH. For example, the DCI may indicate HPN₀=0 as the HARQ process ID of the first PDSCH. In this case, HPN₁=1 may be the HARQ process ID of the second PDSCH, HPN₁=2 may be the HARQ process ID of the third PDSCH, and HPN₁=3 may be the HARQ process ID of the fourth PDSCH.

FIG. 9B is a view illustrating a case in which the UE is indicated with the second row (row 1) of the TDRA table. In DCI received by the UE in a PDCCH 910, the TDRA field may be indicated with the second row (row 1). Accordingly, the UE may receive two PDSCHs, based on two pieces of scheduling information (K0, SLIV, and PDSCH mapping type) in the second row (row 1). Symbols for receiving a first PDSCH 911 may be determined based on SLIV¹₀ that is a first SLIV, and symbols for receiving a second PDSCH 912 may be determined based on SLIV¹₁ that is a second SLIV. Each of the two PDSCHs may have a unique HARQ process ID. That is, the first PDSCH may have HPN₀ as an HARQ process ID, and the second PDSCH may have HPN₁ as an HARQ process ID. The DCI indicates the HARQ process ID of the first PDSCH. For example, the DCI indicates HPN₀=0 as the HARQ process ID of the first PDSCH. In this case, the HARQ process ID of the second PDSCH may be HPN₁=1.

FIG. 9C is a view illustrating a case in which the UE is indicated with the third row (row 2) of the TDRA table. In DCI received by the UE in a PDCCH 920, the TDRA field may be indicated with the third row (row 2). Accordingly, the UE may receive one PDSCH, based on one piece of scheduling information (K0, SLIV, and PDSCH mapping type) in the third row (row 2). Symbols for receiving a PDSCH 921 may be determined based on SLIV²₀ that is one SLIV. The DCI indicates the HARQ process ID of one PDSCH, that is, HPN₀. For example, the DCI indicates HPN₀=0 as the HARQ process ID of the first PDSCH.

However, the PDSCH scheduling schemes illustrated in FIGS. 9A to 9C are merely examples for convenience in description and the disclosure is not limited thereto.

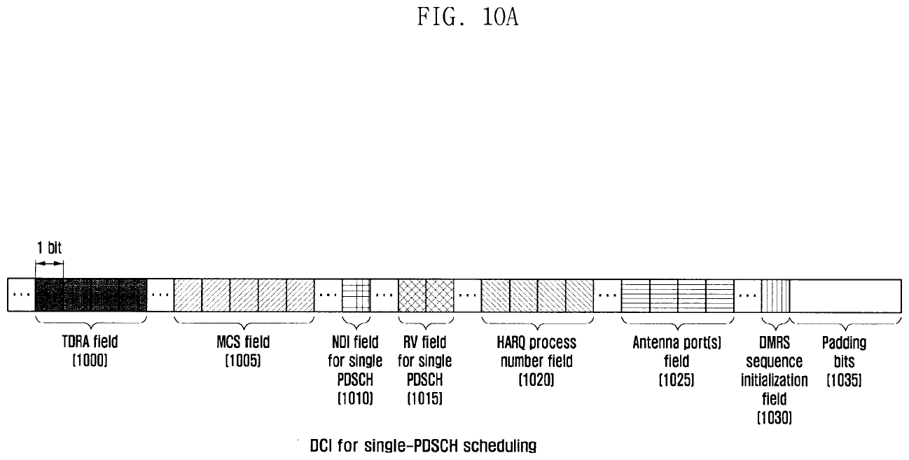

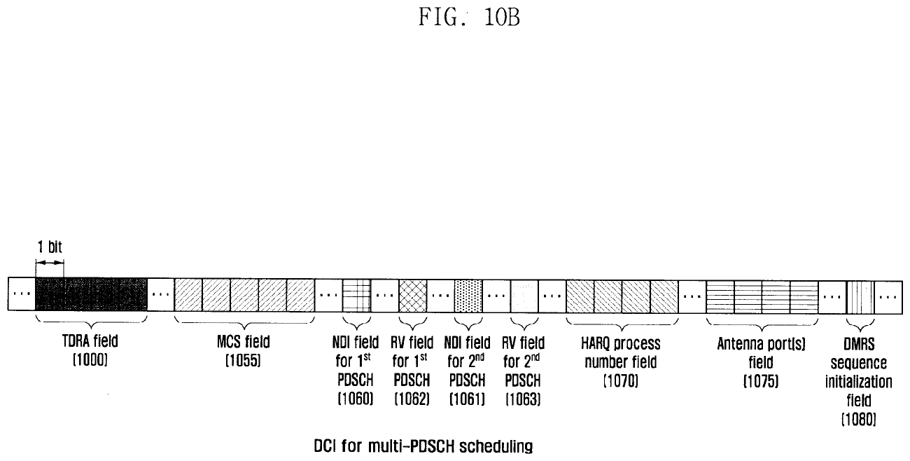

FIGS. 10A and 10B are views illustrating downlink control information (DCI) for single-physical downlink shared channel scheduling (single-PDSCH scheduling) and multi-physical downlink shared channel scheduling (multi-PDSCH scheduling) according to various embodiments of the disclosure.

Referring to FIGS. 10A and 10B, the UE may determine a position of the time domain resource assignment (TDRA) field 1000 in the received downlink control information (DCI). The position of the TDRA field in the DCI for indicating single-PDSCH scheduling and that in the DCI for indicating multi-PDSCH scheduling may be the same. The UE may determine, through the TDRA field value, whether the DCI is for indicating single-PDSCH scheduling or for multi-PDSCH scheduling.

If one piece of scheduling information (K0, SLIV, and PDSCH mapping type) is included in a row corresponding to the TDRA field value of the received DCI (e.g., the third row (row 2) in the TDRA table), the UE may interpret the DCI as single-PDSCH scheduling DCI as shown in FIG. 10A.

Referring to FIG. 10A, single-PDSCH scheduling DCI may include a 5-bit modulation coding scheme (MCS) field 1005, a 1-bit new data indicator (NDI) field 1010, a 2-bit redundancy version (RV) field 1015, and a 4-bit hybrid automatic repeat request (HARQ) field 1020. The single-PDSCH scheduling DCI may include other fields. For example, an antenna port(s) field 1025, a demodulation reference signal (DMRS) sequence initialization field 1030, or the like is included. If single-PDSCH scheduling DCI is shorter than multi-PDSCH scheduling DCI, padding bits 1035 may be included.

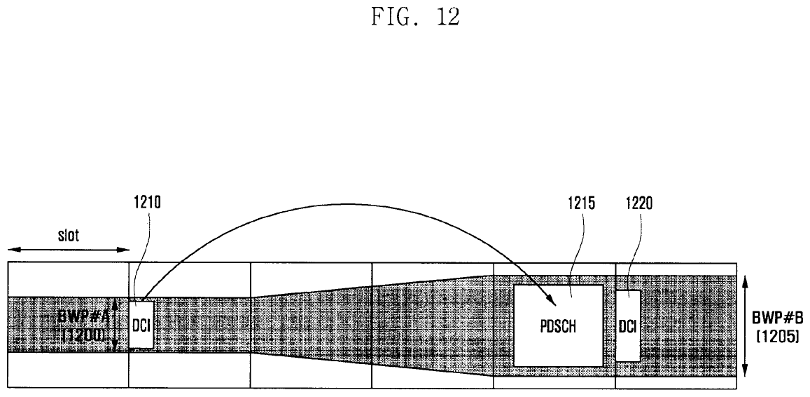

If two or more pieces of scheduling information (K0, SLIV, and PDSCH mapping type) are included in a row corresponding to the TDRA field value of the received DCI (e.g., the first row (row 0) or the second row (row 1) in the TDRA table), the UE may interpret the DCI as multi-PDSCH scheduling DCI as shown in FIG. 12. Referring to FIG. 10B, multi-PDSCH scheduling DCI may include a 5-bit MCS field 1055, K-bit NDI fields 1060 and 1061, K-bit RV fields 1062 and 1063, and a 4-bit HARQ field 1070. The multi-PDSCH scheduling DCI may include other fields. For example, an antenna port(s) field 1075, a DMRS sequence initialization field 1080, or the like is included. For reference, DCI for scheduling of up to two PDSCHs is described in FIG. 10B. The 2-bit NDI fields 1060 and 1061 are illustrated to be separate but may be attached to form 2 bits. Furthermore, the 2-bit RV fields 1062 and 1063 are illustrated to be separate in FIG. 10B but may be attached to form 2 bits.

Referring to FIGS. 10A and 10B, under the assumption that a length of DCI indicating single-PDSCH scheduling is shorter than a length of DCI indicating multi-PDSCH scheduling, padding bits 1035 are added to the single-PDSCH scheduling DCI. In a case that a length of DCI indicating single-PDSCH scheduling is longer than a length of DCI indicating multi-PDSCH scheduling, padding bits may be added to the DCI indicating multi-PDSCH scheduling.

However, the embodiment illustrated with reference to FIGS. 10A and 10B is merely an example for convenience in description, and the disclosure is not limited thereto.

Hereinafter, the disclosure assumes that a PDSCH transmits a single codeword unless otherwise specified. If transmission of two codewords is configured for a UE, fields of DCI are for a first codeword unless otherwise specified.

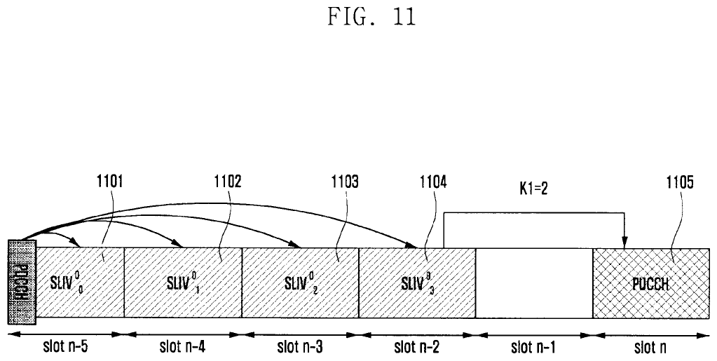

FIG. 11 is a view illustrating a method for transmitting hybrid automatic repeat request-acknowledgment (HARQ-ACK) of multiple physical downlink shared channels (PDSCHs) according to an embodiment of the disclosure.

FIG. 11 illustrates, in a case that the downlink control information (DCI) indicates multi-physical downlink shared channel scheduling (multi-PDSCH scheduling), a physical uplink control channel (PUCCH) 1105 for hybrid automatic repeat request-acknowledgment (HARQ-ACK) transmission of one or multiple physical downlink shared channels (PDSCHs) scheduled by the downlink control information (DCI).

Referring to FIG. 11, a base station may configure one or multiple K1 value(s) for a UE. This may be referred to as a K1 set. DCI indicating multi-PDSCH scheduling may include an indicator indicating one K1 value in the K1 set. More specifically, the DCI may include a PDSCH-to-HARQ feedback timing indicator field having up to 3 bits. The field may indicate one K1 value in the K1 set.

The UE may determine a slot for transmission of HARQ-ACK of multiple PDSCHs, based on one K1 value and a slot in which a last PDSCH of the multiple PDSCHs is scheduled. For reference, HARQ-ACK of all PDSCHs scheduled by one piece of DCI may be transmitted through one PUCCH in the slot for transmission of the HARQ-ACK. A slot after K1 slots from the slot in which the last PDSCH is scheduled is a slot for transmission of HARQ-ACK of multiple PDSCHs. That is, a PUCCH including the HARQ-ACK of multiple PDSCHs may be transmitted in the slot after K1 slots from the slot in which the last PDSCH is scheduled.

Referring to FIG. 11, it is assumed that DCI received by the UE indicates row 0 of the TDRA table as shown in FIGS. 10A and 10B, and according to row 0 of the TDRA table, a PDSCH has been scheduled in slot n−5, slot n−4, slot n−3, and slot n−2. In addition, it is assumed that the UE is indicated with 2 as a K1 value. In this case, the UE may determine slot n as a slot for transmission of HARQ-ACK, wherein slot n is a slot after two, corresponding to the K1 value, slots from slot n−2 that is the last slot in which the PDSCH is scheduled. That is, in the PUCCH 1105 of slot n, the UE may transmit HARQ-ACK information of a PDSCH 1101 of slot n−5, a PDSCH 1102 of slot n−4, a PDSCH 1103 of slot n−3, and a PDSCH 1104 of slot n−2.

In Relation to Downlink Control Information (DCI) Field Interpretation According to Bandwidth Part Switching (BWP Switching)

A UE according to an embodiment of the disclosure has been configured of multiple bandwidth parts in one cell but may activate one bandwidth part at a time point. Activated bandwidth part may be referred to as an active bandwidth part. For reference, the UE may receive a downlink signal or channel in an active downlink bandwidth part. The downlink signal or channel may be received within a bandwidth of the active downlink bandwidth part. Furthermore, the downlink signal or channel may follow subcarrier spacing and a cyclic prefix (CP) type of the active downlink bandwidth part.

The UE may transmit a uplink signal or channel in an active uplink bandwidth part. The uplink signal or channel may be transmitted within a bandwidth of the active uplink bandwidth part. Furthermore, the uplink signal or channel may follow subcarrier spacing and a CP type of the active uplink bandwidth part.

FIG. 12 is a view illustrating bandwidth part switching and physical downlink shared channel (PDSCH) scheduling in a downlink control information (DCI) format according to an embodiment of the disclosure.

A UE may be indicated of which bandwidth part is activated among multiple bandwidth parts. The indication may be made through a bandwidth part indicator field of a downlink control information (DCI) format monitored by the UE.

Referring to FIG. 12, in a case that the UE is configured of multiple downlink bandwidth parts, a method for identifying which downlink bandwidth is activated among the multiple downlink bandwidth parts is as follows.

A DCI format 1210 for scheduling a physical downlink shared channel (PDSCH) may include a bandwidth part indicator field. The UE may receive the DCI format 1210 in PDCCH monitoring occasion configured in an active bandwidth part 1200. For reference, as will be described later, the DCI may have an assigned length and the UE and the base station may know this in advance. The UE may receive the DCI format in the configured PDCCH monitoring occasion according to the assigned length.

The UE may acquire a downlink bandwidth part (BWP) index from the bandwidth part indicator field of the received DCI format. The UE may assume that a PDSCH 1215 scheduled by the DCI format is transmitted in a downlink BWP 1205 of the indicated index. Thereafter, fields of a DCI format 1220 may be interpreted according to a downlink BWP 1205 of the indicated index.

The DCI format scheduling a PDSCH may include DCI format 1_1 or DCI format 1_2. Hereinafter, the disclosure is described based on DCI format 1_1 for convenience in description but embodiments of the disclosure may be equally or similarly applied to other DCI formats.

Although not shown in FIG. 12, the method for determining an active bandwidth part as described above may be applied to an uplink. In a case that the UE is configured of multiple uplink bandwidth parts, a method for identifying which uplink bandwidth is activated among the multiple uplink bandwidth parts is as follows.

A DCI format for scheduling a PUSCH may include a bandwidth part indicator field. The UE may receive the DCI format in PUCCH monitoring occasion configured in an active downlink bandwidth part. For reference, as will be described later, the DCI may have an assigned length and the UE and the base station may know this in advance. The UE may receive the DCI format in the configured PDCCH monitoring occasion according to the assigned length. The UE may acquire an uplink BWP index from the bandwidth part indicator field of the received DCI format. The UE may assume that a PUSCH scheduled by the DCI format is transmitted in the uplink BWP of the index. Thereafter, fields of a DCI format may be interpreted according to an uplink BWP of the indicated index.

The DCI format scheduling a PUSCH may include DCI format 0_1 or DCI format 0_2. Hereinafter, the disclosure is described based on DCI format 0_1 for convenience in description but embodiments of the disclosure may be equally or similarly applied to other DCI formats.

Hereinafter, the DCI format is a DCI format for scheduling a PDSCH in the disclosure unless otherwise specified. However, this is for convenience in description and the disclosure is not limited thereto. Embodiments of the disclosure may be equally applied to a DCI format for scheduling a PUSCH.

It has been described that a UE receives a DCI format having an assigned length in PDCCH monitoring occasion of an active downlink bandwidth part. The assigned length is a value known to the base station and the UE in advance and a method for determining the assigned length as follows.

A DCI format (e.g., DCI format 1_1) scheduling a PDSCH may include multiple DCI fields. A length of each of multiple DCI fields may be determined according to an active downlink bandwidth part in which a PDCCH is received. By way of example, a length of a frequency domain resource assignment (FDRA) field may be determined according to the number of RBs included in an active downlink bandwidth part in which a PDCCH is received. By way of example, a length of a time domain resource assignment (TDRA) field may be determined according to the number of rows of a TDRA table configured in an active downlink bandwidth part in which a PDCCH is received. In other words, in case of receiving a PDCCH in an active downlink bandwidth part, the UE may determine a length of each DCI field based on information on the active downlink bandwidth part or information configured in the active downlink bandwidth part.

For reference, a DCI field corresponding to information not configured in the active downlink bandwidth part may not be included in a DCI format. For convenience, it is assumed that the length of the DCI field is 0 bits. For example, in a case that codeblock group (CBG)-based reception is not configured in an active downlink bandwidth part, the DCI format received in PDCCH monitoring occasion of the active downlink bandwidth part does not include a codeblock group transmission indicator (CBGTI) field or a codeblock group flushing indicator (CBGFI) field. That is, it may be described that 0 bit CBGTI or 0 bit CBGFI is included.

As described above, the UE may be indicated of the active bandwidth part from the bandwidth part indicator field of the received DCT format in the active downlink bandwidth part. The bandwidth part indicated by the bandwidth part indicator field may be the same as or different from the active downlink bandwidth part in which the DCI format is received. The case that the active bandwidth part indicated by the bandwidth part indicator field is different from the active downlink bandwidth part in which the DCI format is received is referred to as bandwidth part switch.

Hereinafter, for convenience, the active downlink bandwidth part in which the DCI format is received is referred to as an active downlink bandwidth part or BWP #A, and the active bandwidth part indicated by the bandwidth part indicator field is referred to as an indicated bandwidth part or BWP #B.

The case not corresponding to the bandwidth part switch is the case in which the active downlink bandwidth part and the indicated bandwidth part are the same, and, for example, correspond to BWP #A=BWP #B. In this case, the DCI format includes DCI fields having lengths determined based on information of the active downlink bandwidth part and thus, the DCI fields may be interpreted as information on the active downlink bandwidth part. For example, in a case that the active downlink part includes four rows in the TDRA table, the DCI format includes a TDRA field of 2 bits for indicating rows of four TDRA tables. The UE may interpret the 2-bit TDRA field as information of the indicated downlink bandwidth part. Since this does not pertain to bandwidth part switch, the indicated downlink bandwidth part BWP #B may be the same as the active downlink bandwidth part BWP #A (that is, BWP #A=BWP #B), and the 2-bit TDRA field may indicate one row of the four TDRA tables.

The case corresponding to the bandwidth part switch is the case in which the active downlink bandwidth part and the indicated bandwidth part are different, and, for example, correspond to BWP #A and BWP #B are different from each other. In this case, although the DCI format includes DCI fields having lengths determined based on information of the active downlink bandwidth part, the DCI fields need to be interpreted as information on the indicated bandwidth part. In case of interpreting as information of the indicated bandwidth part, the length of the DCI field may be insufficient or surplus.

For example, in a case that the active downlink part includes rows in four TDRA tables, the DCI format includes a TDRA field of 2 bits for indicating rows of four TDRA tables. The UE may interpret the 2-bit TDRA field as information of the indicated downlink bandwidth part. However, rows of eight TDRA tables are configured in the indicated downlink bandwidth part and 3-bit TDRA fields is needed to indicate one row of the eight TDRA tables. Since a 2-Bit TDRA field is included in the DCI format, the UE needs to perform a process of converting the 2-bit TDRA field into a 3-bit TDRA field. For this end, the UE may acquire a required TDRA field by adding binary (or bit) “0” to a most significant bit (MSB) of the TDRA field of the DCI format. That is, if the 2-bit TDRA field has a value of “ab”, a 3-bit TDRA field value of “0ab” may be acquired by adding 1-bit “0” to the MSB. Here, “a” and “b” are “0” or “1” in binary numbers (or bits). A process of adding “0” to the MSB in a case that the length of the DCI field of the DCI format received in the active bandwidth part is shorter than a required length of the DCI field of the indicated bandwidth part as described above may be referred to as zero-prepending.

For example, in a case that the active downlink part includes four rows in the TDRA table, the DCI format may include a TDRA field of 2 bits for indicating rows of four TDRA tables. The UE may interpret the 2-bit TDRA field as information of the indicated downlink bandwidth part. However, rows of two TDRA tables are configured in the indicated downlink bandwidth part and 1-bit TDRA fields is needed to indicate one row of the two TDRA tables. Since a 2-Bit TDRA field is included in the DCI format, the UE needs to perform a process of converting the 2-bit TDRA field into a 1-bit TDRA field. To this end, the UE may acquire a required TDRA field from a required number of bits of least significant bits (LSBs) in the TDRA field of the DCI format. That is, if the 2-bit TDRA field has a value of “ab”, 1 bit is needed and thus is borrowed to acquire a 1-bit TDRA field value of “b” may be acquired by bringing 1-bit LSB. Here, “a” and “b” are “0” or “1” in binary numbers (or bits). A process of bringing the required number of bits of LSBs and removing unnecessary bits in a case that the length of the DCI field of the DCI format received in the active bandwidth part is greater than a desired length of the DCI field of the indicated bandwidth part as described above may be referred to as truncation.

The zero-prepending and the truncation may be applied to each DCI field. That is, although the TDRA field has been described above as an example, the disclosure may be independently applied to other fields, for example, an FDRA field.

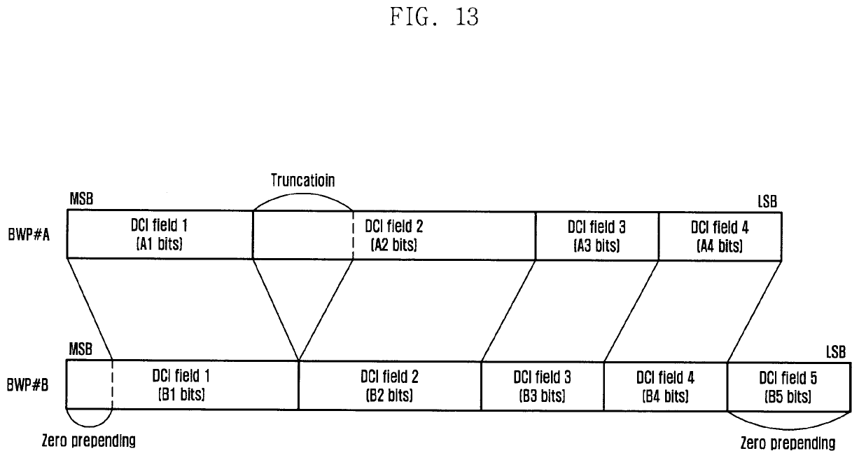

Furthermore, the zero-prepending and the truncation may be applied to each of all DCI fields. That is, although the TDRA field has been described above as an example, the disclosure may be applied to all fields included in the DCI format. Hereinafter, a detailed description thereof will be given with reference to FIG. 13.

FIG. 13 is a view illustrating applying of zero-prepending and truncation to a DCI field in case of switching a downlink control information (DCI) format according to an embodiment of the disclosure.

Referring to FIG. 13, BWP #A corresponds to an active bandwidth part in which a DCI format is received and BWP #B corresponds to a bandwidth part indicated by a bandwidth part indicator field of the DCI format. BWP #A may be referred to as an active bandwidth part and BWP #B may be referred to as an indicated bandwidth part. The DCI format received in BWP #A may include four downlink control information (DCI) fields. A first DCI field is A1 bits, a second DCI field is A2 bits, a third DCI field is A3 bits, and a fourth DCI field is A4bits. A length of each DCI field may be determined based on information configured in BWP #A.

BWP #B may require five DCI fields. A first DCI field is B1 bits, a second DCI field is B2 bits, a third DCI field is B3 bits, a fourth DCI field is B4 bits, and a fifth DCI field is B5 bits. A required length of each DCI field may be determined based on information configured in BWP #B.

A length of the first DCI field required by BWP #B is longer than a length A1 of the first DCI field of the DCI format received in BWP #A (B1>A1), the UE may add “0” of B1-A1 bits to an MSB of the first DCI field of the DCI format received in BWP #A. As such, the first DCI field of B1 bits required by BWP #B may be acquired.

Since a length of the second DCI field required by BWP #B is shorter than a length A2 of the second DCI field of the DCI format received in BWP #A (B2>A2), the UE may remove MSB A2-B2 bits of the second DCI field of the DCI format received in BWP #A. As such, the second DCI field of B2 bits required by BWP #B may be acquired.

Since a length of the third DCI field required by BWP #B is the same as a length A3 of the third DCI field of the DCI format received in BWP #A (B3=A3), the UE may interpret the third DCI field of the DCI format received in BWP #A as the third DCI field of B3 bits required by BWP #B.

Since a length of the fourth DCI field required by BWP #B is the same as a length A4 of the fourth DCI field of the DCI format received in BWP #A (B4=A4), the UE may interpret the fourth DCI field of the DCI format received in BWP #A as the fourth DCI field of B4 bits required by BWP #B.

The DCI format received in BWP #A does not include a fifth DCI field but BWP #B requires a fifth DCI field. Accordingly, the UE may add “0” of B5 bits to the fifth DCI field having a length of B5 bits to generate a fifth DCI field.

The method for DCI field interpretation in case of bandwidth part switching described above may refer to Table 16 below.

```
TABLE 16
If a bandwidth part indicator field is configured in a DCI format, the bandwidth part indicator field value
indicates the active DL BWP, from the configured DL BWP set, for DL receptions as described in [5, TS
38.212]. If a bandwidth part indicator field is configured in a DCI format, the bandwidth part indicator
field value indicates the active UL BWP, from the configured UL BWP set, for UL transmissions as
described in [5, TS 38.212]. If a bandwidth part indicator field is configured in a DCI format and indicates
an UL BWP or a DL BWP different from the active UL BWP or DL BWP, respectively, the UE shall
  - for each information field in the DCI format
    - if the size of the information field is smaller than the one required for the DCI format
interpretation for the UL BWP or DL BWP that is indicated by the bandwidth part indicator, the
UE prepends zeros to the information field until its size is the one required for the interpretation
of the information field for the UL BWP or DL BWP prior to interpreting the DCI format
information fields, respectively
    - if the size of the information field is larger than the one required for the DCI format interpretation
for the UL BWP or DL BWP that is indicated by the bandwidth part indicator, the UE uses a
number of least significant bits of the DCI format equal to the one required for the UL BWP or
DL BWP indicated by bandwidth part indicator prior to interpreting the DCI format information
fields, respectively
  - set the active UL BWP or DL BWP to the UL BWP or DL BWP indicated by the bandwidth part
indicator in the DCI format
```

As described above, in a case that some fields (e.g., an NDI field) of DCI fields interpreted in the active bandwidth part are smaller than fields required for the indicated bandwidth part, the UE of the disclosure may interpret the DCI field by performing zero padding on the fields. However, in this case, the UE may not be able to operate according to scheduling intended by the base station. Accordingly, the disclosure provides a method by the UE for interpreting a DCI field without performing of zero padding or interpreting a DCI field by performing zero padding while considering a zero padded-bit. Hereinafter, a detailed description thereof will be given through embodiments suggested by the disclosure.

Method for Downlink Control Information (DCI) Field/Redundancy Version (RV) Field Interpretation

### Embodiment 1

As embodiment 1, a UE may have limitation to a time domain resource assignment (TDRA) field value which may be indicated by a downlink control information (DCI) format indicating bandwidth part switching. That is, the UE may be indicated of some TDRA field values, but not all TDRA field values in the DCI format indicating bandwidth part switching. An indicatable TDRA field value may be referred to as valid TDRA field value or a valid value. The TDRA field value is a value (valid TDRA field value) indicatable for correct new data indicator (NDI) field interpretation and may be determined according to a TDRA table of an active bandwidth part, a TDRA table of an indicated bandwidth part, or a combination thereof.

Furthermore, a validity may be determined based on the number of pieces of scheduling information of a row of the TDRA table configured in the active bandwidth part corresponding to the TDRA field value, the number of pieces of scheduling information of a row of the TDRA table configured in the indicated bandwidth part, or a combination thereof.

Still furthermore, a validity may be determined based on a maximum value of pieces of scheduling information of rows of the TDRA table configured in the active bandwidth part, a maximum value of pieces of scheduling information of rows of the TDRA table configured in the indicated bandwidth part, or a combination thereof. Still furthermore, a validity may be determined based on a length of a DCI field of the DCI format received in the active bandwidth part and a length of a DCI field required by the indicated bandwidth part.

In the following description, symbols are defined and used as follows.
X: The number of pieces of scheduling information of a TDRA row of an active bandwidth part corresponding to a TDRA field value
Y: The number of pieces of scheduling information of a TDRA row of an indicated bandwidth part corresponding to a TDRA field value
Xₘₐₓ: A maximum value of pieces of scheduling information of TDRA rows of an active bandwidth part
Yₘₐₓ: A maximum value of pieces of scheduling information of TDRA rows of an indicated bandwidth part

### Embodiment 1-1

As embodiment 1-1, in a case that both of a TDRA row of an active bandwidth part corresponding to a TDRA field value and a TDRA row of an indicated bandwidth part, have one piece of scheduling information, a UE may identify the TDRA field value is a valid TDRA field value.

That is, if X=Y, it may be identified that the value of the TDRA field is valid. In a case that the number X of pieces of scheduling information of a TDRA row of an active bandwidth part corresponding to a TDRA field value and the number Y of pieces of scheduling information of a TDRA row of an indicated bandwidth part are the same as 1, a UE may identify the TDRA field value is a valid TDRA field value. On the contrary, in a case that at least one of the TDRA row of the active bandwidth part corresponding to the TDRA field value and the TDRA row of the indicated bandwidth part has at least one piece or two or more pieces of scheduling information, a UE may identify that the TDRA field value is not a valid TDRA field value.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below.

The UE may identify an indicated bandwidth part from a bandwidth part indicator field of the DCI format. The bandwidth part indicator field may indicate another bandwidth part other than a current active bandwidth part. The UE may be indicated from a TDRA field of the DCI format of one row (e.g., a first row) of a TDRA table of the active bandwidth part and one row (e.g., a second row) of a TDRA table of the indicated bandwidth part. Indexes of the two rows (the first row and the second row) are the same and the indexes are indexes indicated from the TDRA field. The two rows (the first row and the second row) must include one piece of scheduling information.

The indicated row (the first row) of the TDRA table of the active bandwidth part include one piece of scheduling information and the DCI format may include a 1-bit NDI field and a 2-bit RV field. The indicated row (the second row) of the TDRA table of the indicated bandwidth part includes one piece of scheduling information, and thus an NDI value or an RV value of a TB scheduled in the indicated bandwidth part may be acquired by using the 1-bit NDI field and the 2-bit RV field.

Embodiment 1-1 is advantageous in that since one row (a first row) of the TDRA table of the active bandwidth part and one row (a second row) of the TDRA table of the indicated bandwidth part include the same number of pieces of scheduling information from the TDRA field of the DCI format, the UE does not need to perform zero prepending or truncation for an NDI field and an RV field in the DCI format indicating bandwidth part switching.

Desirable operations of a base station according to embodiment 1-1 are as follows.

In a case that both the TDRA row of the active bandwidth part of the UE and the TDRA row of the indicated bandwidth part include only one piece of scheduling information, the base station may use a value corresponding to the index as the TDRA field value, add the TDRA field to the DCI format indicating bandwidth part switching, and transmit the DCI format to the UE. The TDRA row of the active bandwidth part and the TDRA row of the indicated bandwidth part of the UE have the same index. A 1-bit NDI field and a 2-bit RV field may be always included in the DCI format and an NDI value and an RV value of the TB scheduled by the DCI format may be included in the NDI field and the RV field.

According to embodiment 1-1, in a case that the number of pieces of scheduling information of the TDRA row of the active bandwidth part corresponding to the TDRA field value and the number of pieces of scheduling information of the TDRA row of the indicated bandwidth part are greater than 1, the base station may not transmit bandwidth part switching DCI by using the TDRA field value. Therefore, for the bandwidth part switching of the base station, at least one row (a row having the same index) of each of the TDRA table of the active bandwidth part and the TDRA table of the indicated bandwidth part must include only one piece of scheduling information.

### Embodiment 1-2

As embodiment 1-2, in a case that a TDRA row of an indicated bandwidth part corresponding to a TDRA field value has only one piece of scheduling information, a UE may identify the TDRA field value is a valid TDRA field value. That is, if Y=1, it may be identified that the value of the TDRA field is valid. On the contrary, in a case that the TDRA row of the indicated bandwidth part corresponding to the TDRA field value has two or more pieces of scheduling information, a UE may identify that the TDRA field value is not a valid TDRA field value.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below. The UE may identify an indicated bandwidth part from a bandwidth part indicator field of the DCI format. The bandwidth part indicator field may indicate another bandwidth part other than a current active bandwidth part. The UE may be indicated from a TDRA field of the DCI format of one row (e.g., a third row) of a TDRA table of the active bandwidth part and one row (e.g., a fourth row) of a TDRA table of the indicated bandwidth part. Indexes of the two rows (the third row and the fourth row) are the same and the indexes are indexes indicated from the TDRA field. In this case, one indicated row (the fourth row) of the TDRA table of the indicated bandwidth part may necessarily include one piece of scheduling information. However, one indicated row (the third row) of the TDRA table of the active bandwidth part may include one piece of scheduling information or multiple pieces of scheduling information.

If the third row includes one piece of scheduling information, the DCI format includes 1-bit NDI field and 2-bit RV field. In this case, since it is the same as embodiment 1-1, a detailed description thereof will be omitted.

If the third row includes multiple pieces of scheduling information, the DCI format includes an Xₘₐₓ-bit NDI field and an Xₘₐₓ-bit RV field. Since the third row includes multiple pieces of scheduling information, Xₘₐₓ≥2. The UE may apply truncation on the Xₘₐₓ-bit NDI field and the Xₘₐₓ-bit RV field to acquire a 1-bit NDI field and a 2-bit RV field. That is, a 1-bit LSB of the Xₘₐₓ-bit NDI field is borrowed to be used for the NDI field and MSB Xₘₐₓ−1 may be discarded. That is, a 2-bit LSB of the Xₘₐₓ-bit RV field is borrowed to be used for the RV field and an MSB Xₘₐₓ−2 may be discarded.

In another way, a 1-bit MSB of the Xₘₐₓ-bit NDI field is borrowed to be used for the NDI field and a LSB Xₘₐₓ−1 may be discarded. That is, a 2-bit MSB of the Xₘₐₓ-bit RV field is borrowed to be used for the RV field and a LSB Xₘₐₓ−2 may be discarded. The indicated row (the fourth row) of the TDRA table of the indicated bandwidth part includes one piece of scheduling information, and thus an NDI value and an RV value of a TB scheduled in the indicated bandwidth part may be acquired by using the acquired 1-bit NDI field and the 2-bit RV field.

Embodiment 1-2 is advantageous in that the UE has no separate restriction on one row (the third row) of the TDRA table of the active bandwidth part from the TDRA field of the DCI format. Therefore, a base station may identify more TDRA field values as valid and use the values to the DCI format indicating bandwidth part switching.

Desirable operations of a base station according to embodiment 1-2 are as follows. In a case that the TDRA row of the indicated bandwidth part of the UE includes only one piece of scheduling information, the base station may use a value corresponding to an index of the row as the TDRA field value, add the TDRA field to the DCI format indicating bandwidth part switching, and transmit the DCI format to the UE. According to the selected TDRA field value, the DCI format may include a 1-bit NDI field and a 2-bit RV field, or an Xₘₐₓ-bit NDI field and an Xₘₐₓ-bit RV field. In a case that the TDRA row of the active bandwidth part of the UE, which corresponds to the selected TDRA field value has one piece of scheduling information, the DCI format includes a 1-bit NDI field and a 2-bit RV field, and an NDI value and an RV value of a TB to be scheduled may be included in the 1-bit NDI field and 2-bit RV field.

In a case that the TDRA row of the active bandwidth part of the UE, which corresponds to the selected TDRA field value, has multiple pieces of scheduling information, the DCI format includes an Xₘₐₓ-bit NDI field and an Xₘₐₓ-bit RV field, a 1-bit LSB of the Xₘₐₓ-bit NDI field is considered as an NDI field, and a 2-bit LSB of the Xₘₐₓ-bit RV field is considered as an RV field. Alternatively, a 1-bit MSB of the Xₘₐₓ-bit NDI field is considered as an NDI field, and a 2-bit MSB of the Xₘₐₓ-bit RV field is considered as an RV field. The NDI value and the RV value of a TB to be scheduled may be included in the considered 1-bit NDI field and the 2-bit RV field.

According to embodiment 1-2, in a case that the number of pieces of scheduling information of the TDRA row of the indicated bandwidth part corresponding to the TDRA field value is greater than 1, the base station may not transmit bandwidth part switching DCI by using the TDRA field value. Therefore, for the bandwidth part switching of the base station, at least one row of the TDRA table of the indicated bandwidth part must include only one piece of scheduling information.

### Embodiment 1-3

As embodiment 1-3, assuming that the number of pieces of scheduling information of a TDRA row of an active bandwidth part corresponding to a TDRA field value is X, and the number of pieces of scheduling information of a TDRA row of an indicated bandwidth part is Y, in a case that X=Y, a UE may identify the TDRA field value is a valid TDRA field value.

That is, in a case that the number X of pieces of scheduling information of the TDRA row of the active bandwidth part corresponding to the TDRA field value is equal to the number Y of pieces of scheduling information of the TDRA row of the indicated bandwidth part, the UE may identify the TDRA field value is valid, and in a case that the number X of pieces of scheduling information of the TDRA row of the active bandwidth part corresponding to the TDRA field value is different from the number Y of pieces of scheduling information of the TDRA row of the indicated bandwidth part, the UE may identify that the TDRA field value is invalid.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below.

The UE may identify an indicated bandwidth part from a bandwidth part indicator field of the DCI format. The bandwidth part indicator field may indicate another bandwidth part other than a current active bandwidth part. The UE may be indicated from a TDRA field of the DCI format of one row (e.g., a fifth row) of a TDRA table of the active bandwidth part and one row (e.g., a sixth row) of a TDRA table of the indicated bandwidth part. Indexes of the two rows (the fifth row and the sixth row) are the same and the indexes are indexes indicated from the TDRA field. The indicated row (the fifth row) of the TDRA table of the active bandwidth part and the indicated row (the sixth row) of the TDRA table of the indicated bandwidth part may necessarily have the same number of pieces of scheduling information.

If the fifth row and the sixth row include one piece of scheduling information, the DCI format includes 1-bit NDI field and 2-bit RV field. In this case, since it is the same as embodiment 1-1, a detailed description thereof will be omitted.

If the fifth row and the sixth row include multiple pieces of scheduling information, for example, X pieces of scheduling information, the DCI format includes an Xₘₐₓ-bit NDI field and an Xₘₐₓ-bit RV field. Since the fifth row includes multiple pieces of scheduling information, Xₘₐₓ≥X=Y. The UE may apply truncation on the Xₘₐₓ-bit NDI field and the Xₘₐₓ-bit RV field to acquire a Y-bit NDI field and a Y-bit RV field for Y pieces of scheduling information of the indicated bandwidth part. That is, a Y-bit LSB of the Xₘₐₓ-bit NDI field is borrowed to be used for the NDI field and MSB Xₘₐₓ−Y may be discarded. In addition, a Y-bit LSB of the Xₘₐₓ-bit RV field is borrowed to be used for the RV field and MSB Xₘₐₓ−Y may be discarded.

In another way, a Y-bit MSB of the Xₘₐₓ-bit NDI field is borrowed to be used for the NDI field and MSB Xₘₐₓ−Y may be discarded. In addition, a Y-bit MSB of the Xₘₐₓ-bit RV field is borrowed to be used for the RV field and LSB Xₘₐₓ−Y may be discarded.

The indicated row (the sixth row) of the TDRA table of the indicated bandwidth part includes Y pieces of scheduling information, and thus an NDI value and an RV value of Y number of TBs corresponding to Y pieces of scheduling information scheduled in the indicated bandwidth part may be acquired by using the acquired Y-bit NDI field and Y-bit RV field.

Compared to embodiment 1-1, embodiment 1-3 is advantageous in that as the TDRA field value of the DCI format, the numbers of pieces of scheduling information in the TDRA row of the active bandwidth part and the TDRA row of the indicated bandwidth part need to be the same, the UE may have more valid TDRA field values.

Compared to embodiment 1-2, embodiment 1-3 is advantageous in that as multiple pieces of scheduling information are allowed in the TDRA row of the bandwidth part indicated by the TDRA field value of the DCI format, the UE may schedule multiple PDSCHs or PUSCHs together with bandwidth part switching.

Desirable operations of a base station according to embodiment 1-3 are as follows.

In a case that both the TDRA row of the active bandwidth part of the UE and the TDRA row of the indicated bandwidth part include the same number of pieces of scheduling information, the base station may use a value corresponding to an index of the row as the TDRA field value, add the TDRA field to the DCI format indicating bandwidth part switching, and transmit the DCI format to the UE. The TDRA row of the active bandwidth part and the TDRA row of the indicated bandwidth part of the UE have the same index. According to the selected TDRA field value, the DCI format may include a 1-bit NDI field and a 2-bit RV field, or an Xₘₐₓ-bit NDI field and an Xₘₐₓ-bit RV field. In a case that the TDRA row of the active bandwidth part of the UE, which corresponds to the selected TDRA field value has one piece of scheduling information, the DCI format includes a 1-bit NDI field and a 2-bit RV field, and an NDI value and an RV value of a TB to be scheduled may be included in the 1-bit NDI field and 2-bit RV field.

In a case that the TDRA row of the active bandwidth part of the UE, which corresponds to the selected TDRA field value, has multiple pieces of scheduling information (X pieces of scheduling information), the DCI format includes an Xₘₐₓ-bit NDI field and an Xₘₐₓ-bit RV field. X bits of the Xₘₐₓ-bit NDI field are considered as an NDI field, and X bits of the Xₘₐₓ-bit RV field are considered as an RV field. When selecting X bits of Xₘₐₓ bits, X-bit MSB may be selected. When selecting X bits of Xₘₐₓ bits, X-bit LSB may be selected. The NDI value and the RV value of each TB to be scheduled according to the X pieces of scheduling information may be included in the considered X-bit NDI field and the X-bit RV field.

According to embodiment 1-3, in a case that the number of pieces of scheduling information of the TDRA row of the active bandwidth part corresponding to the TDRA field value and the number of pieces of scheduling information of the TDRA row of the indicated bandwidth part are not the same, the base station may not transmit bandwidth part switching DCI by using the TDRA field value.

Therefore, for the bandwidth part switching of the base station, at least one row (a row having the same index) of each of the TDRA table of the active bandwidth part and the TDRA table of the indicated bandwidth part must include the same number of pieces of scheduling information.

For reference, it has been described above that Y bits of the Xₘₐₓ-bit NDI field is borrowed to be used for the NDI field and Y bits of Xₘₐₓ-bit RV field is borrowed to be used for the RV field. This may be interpreted using zero padding or truncation as follows.

If Yₘₐₓ>Xₘₐₓ, a Yₘₐₓ-bit NDI field and a Yₘₐₓ-bit RV field may be acquired by adding (zero padding) “0” of Yₘₐₓ-Xₘₐₓ bits to an MSB in the Xₘₐₓ-bit NDI field and the Xₘₐₓ-bit RV field.

If Yₘₐₓ≤Xₘₐₓ, a Yₘₐₓ-bit NDI field and a Yₘₐₓ-bit RV field may be acquired by borrowing (truncation) Yₘₐₓ-bit LSB to the Xₘₐₓ-bit NDI field and the Xₘₐₓ bit RV field. An NDI value and an RV value of Y pieces of scheduling information may be acquired by using the acquired Yₘₐₓ-bit NDI field and Yₘₐₓ-bit RV field.

An i-th bit of each of the Yₘₐₓ-bit NDI field and Yₘₐₓ-bit RV field corresponds to an NDI value and an RV value of i-th scheduling information. That is, first bits (MSBs) of the Yₘₐₓ-bit NDI field and the Yₘₐₓ-bit RV field correspond to an NDI value and an RV value of first scheduling information. (i=1, 2, . . . , Y). For reference, “0” may be added to the MSB bits of the Yₘₐₓ-bit NDI field and the Yₘₐₓ-bit RV field. Therefore, it may be preferable to interpret as follows.
Interpretation except bits with “0” added: Respective max(0,Yₘₐₓ-Xₘₐₓ)+i-th bits of a Yₘₐₓ-bit NDI field and a Yₘₐₓ-bit RV field are an NDI value and an RV value of i-th scheduling information. Here, max(0,Yₘₐₓ-Xₘₐₓ) bits is the number of bits with “0” added. That is, first bits of the Yₘₐₓ-bit NDI field and the Yₘₐₓ-bit RV field after bits with “0” added correspond to an NDI value and an RV value of first scheduling information. (i=1, 2, . . . , Y) For reference, this is the same as not performing unnecessary zero padding on the NDI field or the RV field.
Interpretation in reverse order (from a LSB); Yₘₐₓ−(i+1)th bits of each of a Yₘₐₓ-bit NDI field and a Yₘₐₓ-bit RV field are an NDI value and an RV value of i-th scheduling information, respectively. That is, last bits (LSBs) of the Yₘₐₓ-bit NDI field and the Yₘₐₓ-bit RV field correspond to an NDI value and an RV value of first scheduling information. (i=1, 2, . . . , Y)

### Embodiment 1-4

As embodiment 1-4, assuming that the number of pieces of scheduling information of a TDRA row of an active bandwidth part corresponding to a TDRA field value is X, and the number of pieces of scheduling information of a TDRA row of an indicated bandwidth part is Y, in a case that X≥Y, a UE may identify the TDRA field value is a valid TDRA field value.

That is, in a case that the number X of pieces of scheduling information of the TDRA row of the active bandwidth part corresponding to the TDRA field value is greater than or equal to the number Y of pieces of scheduling information of the TDRA row of the indicated bandwidth part, the UE may identify the TDRA field value is a valid TDRA field value, and in a case that the number X of pieces of scheduling information of the TDRA row of the active bandwidth part corresponding to the TDRA field value is smaller than the number Y of pieces of scheduling information of the TDRA row of the indicated bandwidth part, the UE may identify that the TDRA field value is invalid.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below.

The UE may identify an indicated bandwidth part from a bandwidth part indicator field of the DCI format. The bandwidth part field may indicate another bandwidth part other than a current active bandwidth part.

The UE may be indicated from a TDRA field of the DCI format of one row (e.g., a seventh row) of a TDRA table of the active bandwidth part and one row (e.g., an eighth row) of a TDRA table of the indicated bandwidth part. Indexes of the two rows (the seventh row and the eighth row) are the same and the indexes are indexes indicated from the TDRA field. The number X of pieces of scheduling information of the indicated row (the seventh row) in the TDRA table of the active bandwidth part must be greater than or equal to the number Y of pieces of scheduling information of the indicated row (the eighth row) in the TDRA table of the indicated bandwidth part.

If the seventh row and the eighth row include one piece of scheduling information, the DCI format includes a 1-bit NDI field and a 2-bit RV field. In this case, since it is the same as embodiment 1-1, a detailed description thereof will be omitted.

If the seventh row includes X pieces of scheduling information, the DCI format includes an Xₘₐₓ-bit NDI field and an Xₘₐₓ-bit RV field. Since the seventh row includes multiple pieces of scheduling information, Xₘₐₓ≥X≥Y. Since the eighth row includes Y pieces of scheduling information, the UE may apply truncation on the Xₘₐₓ-bit NDI field and the Xₘₐₓ-bit RV field to acquire a Y-bit NDI field and a Y-bit RV field for Y pieces of scheduling information.

That is, a Y-bit LSB of the Xₘₐₓ-bit NDI field is borrowed to be used for the NDI field, and MSB Xₘₐₓ−Y may be discarded. In addition, a Y-bit LSB of the Xₘₐₓ-bit RV field is borrowed to be used for the RV field and MSB Xₘₐₓ−Y may be discarded.

The indicated row (the eighth row) of the TDRA table of the indicated bandwidth part includes Y pieces of scheduling information, and thus an NDI value and an RV value of Y number of TBs corresponding to Y pieces of scheduling information scheduled in the indicated bandwidth part may be acquired by using the acquired Y-bit NDI field and Y-bit RV field.

Compared to embodiment 1-3, embodiment 1-4 is advantageous in that as the TDRA field value of the DCI format, the number of pieces of scheduling information of the TDRA row of the active bandwidth part needs to be greater than or equal to the number of pieces of scheduling information of the TDRA row of the indicated bandwidth part, the UE may have more valid TDRA field values.

Desirable operations of a base station according to embodiment 1-4 are as follows.

In a case that the number of pieces of scheduling information of the TDRA row of the active bandwidth part of the UE is greater than or equal to the number of pieces of scheduling information of the TDRA row of the indicated bandwidth part, the base station may use a value corresponding to an index of the row as the TDRA field value, add the TDRA field to the DCI format indicating bandwidth part switching, and transmit the DCI format to the UE. The TDRA row of the active bandwidth part and the TDRA row of the indicated bandwidth part of the UE have the same index.

According to the selected TDRA field value, the DCI format may include a 1-bit NDI field and a 2-bit RV field, or an Xₘₐₓ-bit NDI field and an Xₘₐₓ-bit RV field. In a case that the TDRA row of the active bandwidth part of the UE, which corresponds to the selected TDRA field value has one piece of scheduling information, the DCI format includes a 1-bit NDI field and a 2-bit RV field, and an NDI value and an RV value of a TB to be scheduled may be included in the 1-bit NDI field and 2-bit RV field.

In a case that the TDRA row of the active bandwidth part of the UE, which corresponds to the selected TDRA field value, has multiple pieces of scheduling information (X pieces of scheduling information) and the TDRA row of the indicated bandwidth part has multiple pieces of scheduling information (Y pieces of scheduling information, wherein X≥Y), the DCI format includes an Xₘₐₓ-bit NDI field and an Xₘₐₓ-bit RV field, a Y-bit LSB of the Xₘₐₓ-bit NDI field is considered as an NDI field, and an X-bit LSB of the Xₘₐₓ-bit RV field is considered as an RV field. The NDI value and the RV value of each TB to be scheduled according to the Y pieces of scheduling information may be included in the considered Y-bit NDI field and the Y-bit RV field.

According to embodiment 1-4, in a case that the number of pieces of scheduling information of the TDRA row of the active bandwidth part corresponding to the TDRA field value is not greater than or equal to the number of pieces of scheduling information of the TDRA row of the indicated bandwidth part, the base station may not transmit bandwidth part switching DCI by using the TDRA field value. Therefore, for the bandwidth part switching, the base station needs to configure at least one row (a row having the same index) of each of the TDRA table of the active bandwidth part and the TDRA table of the indicated bandwidth part so that the number of pieces of scheduling information of the TDRA row of the active bandwidth part must be greater than or equal to the number of pieces of scheduling information of the TDRA row of the indicated bandwidth part.

For reference, it has been described above that Y bits of the Xₘₐₓ-bit NDI field is borrowed to be used for the NDI field and Y bits of Xₘₐₓ-bit RV field is borrowed to be used for the RV field. This may be interpreted using zero padding or truncation as follows.

If Yₘₐₓ>Xₘₐₓ, a Yₘₐₓ-bit NDI field and a Yₘₐₓ-bit RV field may be acquired by adding (zero padding) “0” of Yₘₐₓ−Xₘₐₓ bits to an MSB in the Xₘₐₓ-bit NDI field and the Xₘₐₓ-bit RV field. If Yₘₐₓ≤Xₘₐₓ, a Yₘₐₓ-bit NDI field and a Yₘₐₓ-bit RV field may be acquired by borrowing (truncation) Yₘₐₓ-bit LSB to the Xₘₐₓ-bit NDI field and the Xₘₐₓ-bit RV field. An NDI value and an RV value of Y pieces of scheduling information may be acquired by using the acquired Yₘₐₓ-bit NDI field and Yₘₐₓ-bit RV field.

An i-th bit of each of the Yₘₐₓ-bit NDI field and Yₘₐₓ-bit RV field corresponds to an NDI value and an RV value of i-th scheduling information. That is, first bits (MSBs) of the Yₘₐₓ bit NDI field and the Yₘₐₓ bit RV field correspond to an NDI value and an RV value of first scheduling information. (i=1, 2, . . . , Y). For reference, “0” may be added to the MSB bits of the Yₘₐₓ-bit NDI field and the Yₘₐₓ bit RV field. Therefore, it may be preferable to interpret as follows.
Interpretation except bits with “0” added: Respective max(0,Yₘₐₓ−Xₘₐₓ)+i-th bits of a Yₘₐₓ-bit NDI field and a Yₘₐₓ-bit RV field are an NDI value and an RV value of i-th scheduling information. Here, max(0,Yₘₐₓ−Xₘₐₓ) bits is the number of bits with “0” added. That is, first bits of the Yₘₐₓ-bit NDI field and the Yₘₐₓ-bit RV field after bits with “0” added correspond to an NDI value and an RV value of first scheduling information. (i=1, 2, . . . , Y) For reference, this is the same as not performing unnecessary zero padding on the NDI field or the RV field.
Interpretation in reverse order (from a LSB); Respective Yₘₐₓ−(i+1)th bits of each of a Yₘₐₓ-bit NDI field and a Yₘₐₓ-bit RV field are an NDI value and an RV value of i-th scheduling information. That is, last bits (LSBs) of the Yₘₐₓ-bit NDI field and the Yₘₐₓ-bit RV field correspond to an NDI value and an RV value of first scheduling information. (i=1, 2, . . . , Y)

### Embodiment 1-5

As embodiment 1-5, assuming that the number of pieces of scheduling information of a TDRA row of an active bandwidth part corresponding to a TDRA field value is X, the number of pieces of scheduling information of a TDRA row of an indicated bandwidth part is Y and a maximum value of the number of pieces of scheduling information of the TDRA rows in the indicated bandwidth part is Yₘₐₓ, in a case that X≥Yₘₐₓ, a UE may identify the TDRA field value is a valid TDRA field value.

That is, in a case that the number X of pieces of scheduling information of the TDRA row of the active bandwidth part corresponding to the TDRA field value is greater than or equal to the maximum value Yₘₐₓ of the numbers Y of pieces of scheduling information of the TDRA rows of the indicated bandwidth part, the UE may identify the TDRA field value is valid, and in a case that the number X of pieces of scheduling information of the TDRA row of the active bandwidth part corresponding to the TDRA field value is smaller than the maximum value Y. of the numbers Y of pieces of scheduling information of the TDRA rows of the indicated bandwidth part, the UE may identify that the TDRA field value is invalid.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below.

The UE may identify an indicated bandwidth part from a bandwidth part indicator field of the DCI format. The bandwidth part indicator field may indicate another bandwidth part other than a current active bandwidth part.

The UE may be indicated from a TDRA field of the DCI format of one row (e.g., a ninth row) of a TDRA table of the active bandwidth part and one row (e.g., a tenth row) of a TDRA table of the indicated bandwidth part. Indexes of the two rows (the ninth row and the tenth row) are the same and the indexes are indexes indicated from the TDRA field. The number X of pieces of scheduling information of the indicated row (the ninth row) of the TDRA table of the active bandwidth part must be greater than or equal to the maximum value Y. of the numbers Y of pieces of scheduling information of rows (all rows including the tenth row) of the TDRA table of the indicated bandwidth part.

If the ninth row includes X pieces of scheduling information, the DCI format includes an Xₘₐₓ-bit NDI field and an Xₘₐₓ-bit RV field. Since the tenth row includes multiple pieces of scheduling information, Xₘₐₓ≥X≥Yₘₐₓ≥Y. Since the tenth row includes Y pieces of scheduling information, the UE may apply truncation on the Xₘₐₓ-bit NDI field and the Xₘₐₓ-bit RV field to acquire a Yₘₐₓ-bit NDI field and a Yₘₐₓ-bit RV field. That is, a Yₘₐₓ-bit LSB of the Xₘₐₓ-bit NDI field is borrowed to be used for the NDI field and MSB Xₘₐₓ−Yₘₐₓ may be discarded.

In addition, a Yₘₐₓ-bit LSB of the Xₘₐₓ-bit RV field is borrowed to be used for the RV field and MSB Xₘₐₓ−Yₘₐₓ may be discarded. The indicated row (the tenth row) of the TDRA table of the indicated bandwidth part includes Y pieces of scheduling information, and thus an NDI value and an RV value of Y number of TBs corresponding to Y pieces of scheduling information scheduled in the indicated bandwidth part may be acquired by using the acquired Y-bit NDI field and Y-bit RV field. An i-th bit of each of the Y-bit NDI field and Y-bit RV field corresponds to an NDI value and an RV value of i-th scheduling information.

Desirable operations of a base station according to embodiment 1-5 are as follows.

In a case that the number of pieces of scheduling information of the TDRA row of the active bandwidth part of the UE is greater than or equal to the maximum value of the numbers of pieces of scheduling information of the TDRA rows of the indicated bandwidth part, the base station may use a value corresponding to an index of the row as the TDRA field value, add the TDRA field to the DCI format indicating bandwidth part switching, and transmit the DCI format to the UE. According to the selected TDRA field value, the DCI format may include a 1-bit NDI field and a 2-bit RV field, or an Xₘₐₓ-bit NDI field and an Xₘₐₓ-bit RV field.

In a case that the TDRA row of the active bandwidth part of the UE, which corresponds to the selected TDRA field value has one piece of scheduling information, the DCI format includes a 1-bit NDI field and a 2-bit RV field, and an NDI value and an RV value of a TB to be scheduled may be included in the 1-bit NDI field and 2-bit RV field. For reference, in a case that the TDRA row of the active bandwidth part of the UE, corresponding to the selected TDRA field value, has one piece of scheduling information, the TDRA row of the indicated bandwidth part of the UE, corresponding to the selected TDRA field value has one piece of scheduling information. Accordingly, the NDI value and the RV value of each TB to be scheduled by one piece of scheduling information may be indicated with 1-bit NDI field and 2-bit RV field.

In a case that the TDRA row of the active bandwidth part of the UE, which corresponds to the selected TDRA field value, has multiple pieces of scheduling information (X pieces of scheduling information) and the TDRA row of the indicated bandwidth part has Y pieces of scheduling information (wherein, Xₘₐₓ≥Y), the DCI format includes an Xₘₐₓ-bit NDI field and an Xₘₐₓ-bit RV field. An Yₘₐₓ-bit LSB of the Xₘₐₓ-bit NDI field is considered as an NDI field, and a Yₘₐₓ-bit LSB of the Xₘₐₓ-bit RV field is considered as an RV field. The NDI value and the RV value of each TB to be scheduled according to the Y pieces of scheduling information may be included in the considered Yₘₐₓ-bit NDI field and the Yₘₐₓ-bit RV field.

According to embodiment 1-5, in a case that the number of pieces of scheduling information of the TDRA row of the active bandwidth part corresponding to the TDRA field value is not greater than or equal to the maximum value of the numbers of pieces of scheduling information of the TDRA rows of the indicated bandwidth part the base station may not transmit bandwidth part switching DCI by using the TDRA field value. Therefore, for bandwidth part switching, the base station needs to configure the number of pieces of scheduling information of at least one row of the TDRA table of the active bandwidth part to be greater or equal to the maximum value of the numbers of pieces of scheduling information of the TDRA rows of the indicated bandwidth part.

### Embodiment 1-6

As embodiment 1-6, assuming that the number of pieces of scheduling information of a TDRA row of an active bandwidth part corresponding to a TDRA field value is X, the number of pieces of scheduling information of a TDRA row of an indicated bandwidth part is Y, and a maximum value of the numbers of pieces of scheduling information of the TDRA rows in the active bandwidth part is Xₘₐₓ, in a case that Xₘₐₓ≥Y, a UE may identify the TDRA field value is a valid TDRA field value.

That is, in a case that the maximum value Xₘₐₓ of the numbers X of pieces of scheduling information of the TDRA rows of the active bandwidth part is greater than or equal to the number Y of pieces of scheduling information of the TDRA rows of the indicated bandwidth part corresponding to the TDRA field value, the UE may identify the TDRA field value is valid, and in a case that the maximum value Xₘₐₓ of the numbers X of pieces of scheduling information of the TDRA rows of the active bandwidth part is smaller than the numbers Y of pieces of scheduling information of the TDRA rows of the indicated bandwidth part corresponding to the TDRA field value, the UE may identify that the TDRA field value is invalid.

In case of receiving a DCI format indicating bandwidth part switching having an invalid TDRA field value, the UE may not perform a UE operation according to the DCI format. That is, the DCI format may be considered to be false DCI reception or a false alarm. The UE may ignore the DCI format.

In case of receiving a DCI format having a valid TDRA field value and indicating bandwidth part switching, the UE may perform operations below. The UE may identify an indicated bandwidth part from a bandwidth part indicator field of the DCI format. The bandwidth part field may indicate another bandwidth part other than a current active bandwidth part.

The UE may be indicated from a TDRA field of the DCI format of one row (e.g., an eleventh row) of a TDRA table of the active bandwidth part and one row (e.g., a twelfth row) of a TDRA table of the indicated bandwidth part. Indexes of the two rows (the eleventh row and the twelfth row) are the same and the indexes are indexes indicated from the TDRA field.

The maximum value X. of the numbers X of pieces of scheduling information of the rows in the TDRA table of the active bandwidth part must be greater than or equal to the number Y of pieces of scheduling information of the indicated row in the TDRA table of the indicated bandwidth part.

If the eleventh row and the twelfth row include one piece of scheduling information, the DCI format includes 1-bit NDI field and 2-bit RV field. In this case, since embodiment 1-1 may be followed, a detailed description thereof will be omitted.

If the eleventh row includes X pieces of scheduling information (and in a case that X>1), the DCI format includes an Xₘₐₓ bit NDI field and an Xₘₐₓ-bit RV field. In addition, Xₘₐₓ≥Y. Since the twelfth row includes Y pieces of scheduling information, the UE may apply truncation on the Xₘₐₓ-bit NDI field and the Xₘₐₓ-bit RV field to acquire an NDI field and an RV field for Y pieces of scheduling information.

In a case that the number of pieces of scheduling information included in the TDRA row in the indicated bandwidth part is greater than 1 (Y>1), the UE may apply truncation on the Xₘₐₓ-bit NDI field and the Xₘₐₓ-bit RV field to acquire a Yₘₐₓ-bit NDI field and a Yₘₐₓ-bit RV field. That is, a Yₘₐₓ-bit LSB of the Xₘₐₓ-bit NDI field is borrowed to be used for the NDI field and MSB Xₘₐₓ−Yₘₐₓ may be discarded.

In addition, a Yₘₐₓ-bit LSB of the Xₘₐₓ-bit RV field is borrowed to be used for the RV field and MSB Xₘₐₓ−Ymax may be discarded.

The indicated row (the twelfth row) of the TDRA table of the indicated bandwidth part includes Y pieces of scheduling information, and thus an NDI value and an RV value of Y number of TBs corresponding to Y pieces of scheduling information scheduled in the indicated bandwidth part may be acquired by using the acquired Yₘₐₓ-bit NDI field and Yₘₐₓ-bit RV field. For reference, since Yₘₐₓ≥Y, the Yₘₐₓ−Y LSB of each of the NDI field and the RV field may not be used.

In a case that the number of pieces of scheduling information included in the TDRA row in the indicated bandwidth part is 1 (Y=1), the UE may apply truncation on the Xₘₐₓ-bit NDI field and the Xₘₐₓ-bit RV field to acquire a 1-bit NDI field and an 2-bit RV field. That is, a 1-bit LSB of the Xₘₐₓ-bit NDI field is borrowed to be used for the NDI field and MSB Xₘₐₓ−1 may be discarded. In addition, a 2-bit LSB of the Xₘₐₓ-bit RV field is borrowed to be used for the RV field and MSB Xₘₐₓ−2 may be discarded. The indicated row (the twelfth row) of the TDRA table of the indicated bandwidth part includes one piece of scheduling information, and thus an NDI value and an RV value of a TB corresponding to the one piece of scheduling information scheduled in the indicated bandwidth part may be acquired by using the acquired 1-bit NDI field and 2-bit RV field. For reference, since Yₘₐₓ≥2, a Yₘₐₓ−1-bit LSB of the NDI field and Yₘₐₓ−2-bit LSB of the RV field may not be used.

Desirable operations of a base station according to embodiment 1-6 are as follows.

In a case that the maximum value of the numbers of pieces of scheduling information of the TDRA rows of the active bandwidth part of the UE is greater than or equal to the number of pieces of scheduling information of the TDRA row of the indicated bandwidth part, the base station may use a value corresponding to an index of the row as the TDRA field value, add the TDRA field to the DCI format indicating bandwidth part switching, and transmit the DCI format to the UE. According to the selected TDRA field value, the DCI format may include a 1-bit NDI field and a 2-bit RV field, or an Xₘₐₓ-bit NDI field and an Xₘₐₓ-bit RV field.

In a case that the TDRA row of the active bandwidth part of the UE, which corresponds to the selected TDRA field value has one piece of scheduling information, the DCI format includes a 1-bit NDI field and a 2-bit RV field, and an NDI value and an RV value of a TB to be scheduled may be included in the 1-bit NDI field and 2-bit RV field.

In a case that the TDRA row of the active bandwidth part of the UE, which corresponds to the selected TDRA field value, has multiple pieces of scheduling information (X pieces of scheduling information) and the TDRA row of the indicated bandwidth part has Y pieces of scheduling information (wherein, Xₘₐₓ≥Y), the DCI format includes an Xₘₐₓ-bit NDI field and an Xₘₐₓ-bit RV field, a Yₘₐₓ-bit LSB of the Xₘₐₓ-bit NDI field is considered as an NDI field, and a Yₘₐₓ-bit LSB of the Xₘₐₓ-bit RV field is considered as an RV field. The NDI value and the RV value of each TB to be scheduled according to the Y pieces of scheduling information may be included in the considered Y-bit NDI field and the Y-bit RV field.

According to embodiment 1-6, in a case that the maximum value of the numbers of pieces of scheduling information of the TDRA rows of the active bandwidth part corresponding to the TDRA field value is not greater than or equal to the number of pieces of scheduling information of the TDRA row of the indicated bandwidth part, the base station may not transmit bandwidth part switching DCI by using the TDRA field value. Therefore, for bandwidth part switching, the base station needs to configure the number of pieces of scheduling information of at least one row of the TDRA table of the indicated bandwidth part to be smaller or equal to the maximum value of the numbers of pieces of scheduling information of the TDRA rows of the active bandwidth part.

### Embodiment 1-7

As embodiment 1-7, a UE may determine a validity based on a length of a DCI field of the DCI format received in the active bandwidth part corresponding to a TDRA field value and a length of a DCI field required by the indicated bandwidth part.

In other words, in a case that the length of the DCI field of the DCI format received in the active bandwidth part corresponding to the TDRA field value is greater than or equal to the length of the DCI field required in the indicated bandwidth part, the UE may identify the TDRA field value is valid, and in a case that the length of the DCI field of the DCI format received in the active bandwidth part corresponding to the TDRA field value is smaller than the length of the DCI field required in the indicated bandwidth part, the UE may identify the TDRA field value is invalid.

The DCI field may be a field having a length variable according to a TDRA table configuration and TDRA row indication. The DCI field may include an NDI field, an RV field, and the like.

For example, a UE determines a validity based on a length of an NDI field of the DCI format received in the active bandwidth part corresponding to a TDRA field value and a length of an NDI field required in the indicated bandwidth part. In other words, in a case that the length of the NDI field of the DCI format received in the active bandwidth part corresponding to the TDRA field value is greater than or equal to the length of the NDI field required in the indicated bandwidth part, the UE may identify the TDRA field value is valid, and in a case that the length of the NDI field of the DCI format received in the active bandwidth part corresponding to the TDRA field value is smaller than the length of the NDI field required in the indicated bandwidth part, the UE may identify the TDRA field value is invalid.

The length of the NDI field of the DCI format received in the active bandwidth part may be determined according to the number X of scheduling of the TDRA row of the active bandwidth part corresponding to the TDRA field value. If the number scheduling is 1 (X=1), the NDI field has 1 bit. If the number scheduling is 2 or more (X>1), the NDI field has Xₘₐₓ bits.

The length of the NDI field required in the indicated bandwidth part may be determined according to the number Y of scheduling of the TDRA row of the indicated bandwidth part corresponding to the TDRA field value. If the number of scheduling is 1 (Y=1), the NDI field has 1 bit. If the number of scheduling is 2 or more (Y>1), the NDI field has Yₘₐₓ bits.

Meanwhile, the length of the NDI field required in the indicated bandwidth part in embodiment 1-7 may be Yₘₐₓ.

The UE may borrow 1 bit (in a case that Y=1) to Y bits (in a case that Y>1) of the Xₘₐₓ-bit NDI field of the DCI format to generate an NDI field for Y pieces of scheduling information. The NDI field may be used as an NDI value of a TB corresponding to Y pieces of scheduling information. For reference, in a case that Y>1, an i-th bit of the Yₘₐₓ-bit NDI field corresponds to an NDI value of an TB corresponding to i-th scheduling information. In addition, a Yₘₐₓ−Y-bit LSB of the Yₘₐₓ-bit NDI field may not be used.

For another example, the length of the NDI field required in the indicated bandwidth part may be determined according to the number Y of scheduling of the TDRA row of the indicated bandwidth part corresponding to the TDRA field value. If the number of scheduling of the TDRA row in the indicated bandwidth part is 1 (Y=1), the NDI field has 1 bit. If the number of scheduling is 2 or more (Y>1), a required NDI field is Y bits.

The UE may borrow a Y-bit of LSB of the Xₘₐₓ-bit NDI field of the DCI format to generate an NDI field for Y pieces of scheduling information. The NDI field may be used as an NDI value of a TB corresponding to Y pieces of scheduling information. For reference, in a case that Y>1, an i-th bit of the Y-bit NDI field corresponds to an NDI value of an TB corresponding to i-th scheduling information.

For another example, a UE may determine a validity based on a length of an RV field of the DCI format received in the active bandwidth part corresponding to a TDRA field value and a length of an RV field required in the indicated bandwidth part. In other words, in a case that the length of the NDI field of the RV format received in the active bandwidth part corresponding to the TDRA field value is greater than or equal to the length of the RV field required in the indicated bandwidth part, the UE may identify the TDRA field value is valid, and in a case that the length of the RV field of the DCI format received in the active bandwidth part corresponding to the TDRA field value is smaller than the length of the RV field required in the indicated bandwidth part, the UE may identify the TDRA field value is invalid.

The length of the RV field of the DCI format received in the active bandwidth part may be determined according to the number X of scheduling of the TDRA row of the active bandwidth part corresponding to the TDRA field value. If the number of scheduling is 1 (X=1), the RV field has 2 bits. If the number of scheduling is 2 or more (X>1), the RV field has Xₘₐₓ bits.

The length of the RV field required in the indicated bandwidth part may be determined according to the number Y of scheduling of the TDRA row of the indicated bandwidth part corresponding to the TDRA field value. If the number of scheduling is 1 (Y=1), the RV field has 2 bits. If the number of scheduling is 2 or more (Y>1), the RV field has Yₘₐₓ bits.

The UE may borrow a 2-bit LSB (in a case that Y=1) to a Yₘₐₓ-bit LSB (in a case that Y>1) of the Xₘₐₓ-bit RV field of the DCI format to generate an RV field for Y pieces of scheduling information. The RV field may be used as an RV value of a TB corresponding to Y pieces of scheduling information. For reference, in a case that Y>1, an i-th bit of the Yₘₐₓ-bit RV field corresponds to an RV value of an TB corresponding to i-th scheduling information. In addition, a Yₘₐₓ−Y-bit LSB of the Yₘₐₓ-bit RV field may not be used.

For another example, the length of the RV field required in the indicated bandwidth part may be determined according to the number Y of scheduling of the TDRA row of the indicated bandwidth part corresponding to the TDRA field value. If the number of scheduling is 1 (Y=1), the RV field has 2 bits. If the number of scheduling is 2 or more (Y>1), the RV field has Y bits.

The UE may borrow 2 bits (in a case that Y=1) to Yₘₐₓ bits (in a case that Y>1) of the Xₘₐₓ-bit RV field of the DCI format to generate an RV field for Y pieces of scheduling information. The RV field may be used as an RV value of a TB corresponding to Y pieces of scheduling information. For reference, in a case that Y>1, an i-th bit of the Y-bit RV field corresponds to an RV value of an TB corresponding to i-th scheduling information.

For reference, it has been described above that in a case that Y>1, Y bits of the Xₘₐₓ-bit NDI field is borrowed to be used for the NDI field and Y bits of Xₘₐₓ-bit RV field is borrowed to be used for the RV field. This may be interpreted using zero padding or truncation as follows. If Yₘₐₓ>Xₘₐₓ, a Yₘₐₓ-bit NDI field and a Yₘₐₓ-bit RV field may be acquired by adding (zero padding) “0” of Yₘₐₓ−Xₘₐₓ bits to an MSB in the Xₘₐₓ-bit NDI field and the Xₘₐₓ-bit RV field. If Yₘₐₓ−Xₘₐₓ, a Yₘₐₓ-bit NDI field and a Yₘₐₓ-bit RV field may be acquired by borrowing (truncation) Yₘₐₓ-bit LSB to the Xₘₐₓ-bit NDI field and the Xₘₐₓ-bit RV field. An NDI value and an RV value of Y pieces of scheduling information may be acquired by using the acquired Yₘₐₓ-bit NDI field and Yₘₐₓ-bit RV field.

An i-th bit of each of the Yₘₐₓ-bit NDI field and Yₘₐₓ-bit RV field corresponds to an NDI value and an RV value of i-th scheduling information. That is, first bits (MSBs) of the Yₘₐₓ-bit NDI field and the Yₘₐₓ-bit RV field correspond to an NDI value and an RV value of first scheduling information. (i=1, 2, . . . , Y). For reference, “0” may be added to the MSB bits of the Yₘₐₓ-bit NDI field and the Yₘₐₓ-bit RV field. Therefore, it may be preferable to interpret as follows.
Interpretation except bits with “0” added: Respective max(0,Yₘₐₓ−Xₘₐₓ)+i-th bits of a Yₘₐₓ-bit NDI field and a Yₘₐₓ-bit RV field are an NDI value and an RV value of i-th scheduling information. Here, max(0,Yₘₐₓ−Xₘₐₓ) bits is the number of bits with “0” added. That is, first bits of the Yₘₐₓ-bit NDI field and the Yₘₐₓ-bit RV field after bits with “0” added correspond to an NDI value and an RV value of first scheduling information. (i=1, 2, . . . , Y) For reference, this is the same as not performing unnecessary zero padding on the NDI field or the RV field.
Interpretation in reverse order (from an LSB); Respective Yₘₐₓ-(i+1)th bits of each of a Yₘₐₓ-bit NDI field and a Yₘₐₓ-bit RV field are an NDI value and an RV value of i-th scheduling information. That is, last bits (LSBs) of the Yₘₐₓ-bit NDI field and the Yₘₐₓ-bit RV field correspond to an NDI value and an RV value of first scheduling information. (i=1, 2, . . . , Y)

It has been described above that Y=1, 1 bit of the Xₘₐₓ-bit NDI field is borrowed to be used for the NDI field and 2 bits of Xₘₐₓ-bit RV field is borrowed to be used for the RV field. This may be interpreted using zero padding or truncation as follows. If Yₘₐₓ>Xₘₐₓ, a Yₘₐₓ-bit NDI field and a Yₘₐₓ-bit RV field may be acquired by adding (zero padding) “0” of Yₘₐₓ−Xₘₐₓ bits to an MSB in the Xₘₐₓ-bit NDI field and the Xₘₐₓ-bit RV field. If Yₘₐₓ≤Xₘₐₓ, a Yₘₐₓ-bit NDI field and a Yₘₐₓ-bit RV field may be acquired by borrowing (truncation) Yₘₐₓ-bit LSB to the Xₘₐₓ-bit NDI field and the Xₘₐₓ-bit RV field. An NDI value and an RV value of one piece of scheduling information may be acquired by using the acquired Yₘₐₓ-bit NDI field and Yₘₐₓ-bit RV field.
Interpretation except bits with “0” added: A (Z+1)th bit of a Yₘₐₓ-bit NDI field is a 1-bit NDI value of one piece of scheduling information, and a (Z+1) bit and a (Z+2)th bit of a Yₘₐₓ-bit RV field is a 2-bit RV value of one piece of scheduling information. Z is the number of bits with “0” added by zero padding and may be Z=max(0,Yₘₐₓ−Xₘₐₓ) bits. That is, a first bit after a bit to which “0” added to and Yₘₐₓ-bit NDI field is an NDI value of one piece of scheduling information, and a first and a second bits after a bit to which “0” added to and Yₘₐₓ-bit RV field are an RV value of one piece of scheduling information. For reference, this is the same as interpreting a 1-bit MSB of an NDI field as an NDI value and a 2-bit MSB of an RV field as an RV value without performing unnecessary zero padding on the NDI field or the RV field.
Interpretation in reverse order (from an LSB); Last 1 bit of a Yₘₐₓ-bit NDI field may be interpreted as an NDI value and last 2 bits of an RV field may be interpreted as an RV value.

Desirable operations of a base station according to embodiment 1-7 are as follows.

The base station may identify a length of a DCI field of a DCI format to be transmitted in an active bandwidth part according to a TDRA field configuration or a TDRA field value. In addition, the base station may identify a length of a DCI field required in an indicated bandwidth part according to a TDRA field configuration or a TDRA field value. If a length of a specific DCI field (e.g., an NDI field) of the DCI format to be transmitted in the active bandwidth part is not greater than or equal to a length of a specific DCI field (e.g., an NDI field) required in the indicated bandwidth part, the TDRA field value may be transmitted to a TDRA field of the DCI format. Some bits (bits corresponding to a length of the DCI field required in the indicated bandwidth part) of the DCI format may be used as scheduling information of the indicated bandwidth part.

According to embodiment 1-7, in a case that a length of a specific DCI field (e.g., an NDI field) of the DCI format in the active bandwidth part is shorter than a length of a DCI field (e.g., an NDI field) required in the indicated bandwidth part, the base station may not indicate bandwidth part switching through the DCI format. Accordingly, in order to indicate bandwidth part switching, the base station needs to configure a length of a specific DCI field (e.g., an NDI field) of the DCI format to be transmitted to be greater than or equal to a length of an DCI field (e.g., an NDI field) required in the indicated bandwidth part.

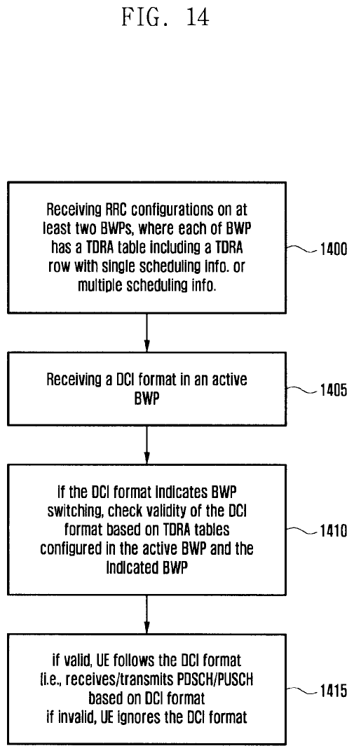

FIG. 14 is a view illustrating an operation of a UE according to an embodiment of the disclosure.

Referring to FIG. 14, in operation 1400, a UE may receive a configuration of at least two bandwidth parts from a higher-layer. A time domain resource assignment (TDRA) table may be configured in each bandwidth part, and each row of the TDRA table may include one piece of scheduling information or multiple pieces of scheduling information.

In operation 1405, the UE may receive a downlink control information (DCI) format in an active bandwidth part of the at least two configured bandwidth parts. A length of a DCI field included in the DCI format may be identified based on a configuration of the active bandwidth part.

In operation 1410, in a case that the received DCI format indicates bandwidth part switching, the UE may determine a validity of the DCI format based on the TDRA table in the active bandwidth part and a TDRA table in an indicated bandwidth part. The UE may perform operation 1410 according to embodiment 1-1 to embodiment 1-7.

In operation 1415, in a case that the DCI format is identified to be valid, the UE may perform operations according to the DCI format. For example, the UE receives (or transmits) a PDSCH (or PUSCH) according to the DCI format. However, in a case that the DCI format is identified to be invalid, the UE may ignore the DCI format. Ignoring of the DCI format by the UE may mean omitting of receiving (or transmitting) a PDSCH (or PUSCH) according to the DCI format.

### Embodiment 2

As embodiment 2, a UE may receive (or transmit) some PDSCHs (or PUSCHs) among PDSCHs (or PUSCHs) scheduled in a DCI format indicating bandwidth part switching and may not receive (or transmit) the other PDSCHs (or PUSCHs). A time domain resource assignment (TDRA) row of an indicated bandwidth part corresponding to a TDRA field value of the downlink control information (DCI) format includes multiple pieces of scheduling information. Hereinafter, in a detailed example of the disclosure, which PDSCHs (or PUSCHs) are received (or transmitted) will be described.

### Embodiment 2-1

As embodiment 2-1, a UE may receive (or transmit) one PDSCH (or PUSCH) among PDSCHs (or PUSCHs) scheduled in a DCI format indicating bandwidth part switching and may not receive (or transmit) the other PDSCHs (or PUSCHs). Although a TDRA row of an indicated bandwidth part corresponding to a TDRA field value of the DCI format includes multiple pieces of scheduling information, the UE may assume that only one piece of scheduling information is scheduled among the multiple pieces of scheduling information the TDRA row and receive (or transmit) a PDSCH (or PUSCH) corresponding to the one piece of scheduling information. Even though the other PDSCHs (or PUSCHs) are actually scheduled, the UE may not receive (or transmit) the other PDSCHs (or PUSCHs).

To this end, the UE may select one piece of scheduling information from among the multiple pieces of scheduling information. For example, the UE selects scheduling information according to methods below or a combination thereof.

As a first method, the UE may select scheduling information scheduled at the most advanced position in time. The first method is a method for enabling receiving (or transmitting) of a PDSCH (or PUSCH) in the fastest time.

As a second method, the UE may select scheduling information scheduled at the latest position in time. The second method is a method for selecting scheduling information that may guarantee sufficient time for bandwidth part switching of the UE since a PDSCH (or PUSCH) scheduled last is received (received or transmitted).

As a third method, the UE may select scheduling information scheduled at the most advanced position in time after a time taken for bandwidth part switching. The UE may complete bandwidth part switching within a time taken for bandwidth part switching after a time point at which the DCI format is received. See Table 3 for the time taken for bandwidth part switching. The UE may receive (or transmit) a PDSCH (or PUSCH) of certain scheduling information after the time taken for bandwidth part switching. Accordingly, by selecting scheduling information scheduled at the most advanced position in time after a time taken for bandwidth part switching, a PDSCH (or PUSCH) may be received (or transmitted) in the fastest time. The third method is a method for enabling receiving (or transmitting) of a PDSCH (or PUSCH) in the fastest time by selecting scheduling information scheduled at the most advanced position in time after a time taken for bandwidth part switching.

The UE may select one piece of scheduling information and acquire an NDI value and an RV value of the one piece of scheduling information from the DCI format. The DCI format received in the active bandwidth part may include a 1-bit NDI field and a 2-bit RV field, or an Xₘₐₓ-bit NDI field and an Xₘₐₓ-bit RV field.

In a case that a TDRA row of the active bandwidth part corresponding to the TDRA field value indicated by the DCI format includes one piece of scheduling information, the DCI format includes a 1-bit NDI field and a 2-bit RV field. Accordingly, the 1-bit NDI field and the 2-bit RV field may indicate an NDI value and an RV value of the selected one piece of scheduling information.

In a case that a TDRA row of the active bandwidth part corresponding to the TDRA field value indicated by the DCI format includes multiple pieces of scheduling information, the DCI format includes an Xₘₐₓ-bit NDI field and an Xₘₐₓ-bit RV field. Accordingly, a 1-bit LSD of the Xₘₐₓ-bit NDI field and a 2-bit LSB of the Xₘₐₓ-bit RV field may indicate an NDI value and an RV value of the selected one piece of scheduling information.

Although it has been described that only one PDSCH (or PUSCH) is received (or transmitted) in embodiment 2-1, the disclosure is not limited thereto. Actually, the UE may receive (or transmit) multiple PDSCHs (or PUSCHs).

### Embodiment 2-2

As embodiment 2-2, a UE may receive (or transmit) only the number of PDSCHs (or PUSCHs) determined according to a length of a DCI field included in a DCI format among PDSCHs (or PUSCHs) scheduled in the DCI format indicating bandwidth part switching and may not receive (or transmit) the other PDSCHs (or PUSCHs). Although a TDRA row of an indicated bandwidth part corresponding to a TDRA field value of the DCI format includes multiple pieces of scheduling information, the UE may assume that only the determined number of pieces of scheduling information are scheduled among the multiple pieces of scheduling information of the TDRA row and receive (or transmit) a PDSCH (or PUSCH) corresponding to the determined number of pieces of scheduling information. Even though the other PDSCHs (or PUSCHs) are actually scheduled, the UE may not receive (or transmit) the other PDSCHs (or PUSCHs).

The number determined according to a length of the DCI field included in the DCI format may be the same as the number of bits of an NDI field included in the DCI format. That is, the DCI format received in an active bandwidth part may include the NDI field having a determined length. The length of the NDI field may be determined according to the number of pieces of scheduling information included in the TDRA row of the active bandwidth part corresponding to the TDRA field value.

In a case that the number of pieces of scheduling information included in the TDRA row of the active bandwidth part corresponding to the TDRA field value is 1 (X=1), the NDI field has a length of 1. Therefore, the UE may assume that only one piece of scheduling information is scheduled and receive (or transmit) a PDSCH (or PUSCH) corresponding to the one piece of scheduling information. Even though the other PDSCHs (or PUSCHs) are actually scheduled, the UE may not receive (or transmit) the other PDSCHs (or PUSCHs).

In a case that the number of pieces of scheduling information included in the TDRA row of the active bandwidth part corresponding to the TDRA field value is 2 or higher (X>1), the NDI field has a length of Xₘₐₓ. Therefore, the UE may assume that Xₘₐₓ number of pieces of scheduling information are scheduled and receive (or transmit) a PDSCH (or PUSCH) corresponding to the Xₘₐₓ number of pieces of scheduling information. Even though the other PDSCHs (or PUSCHs) are actually scheduled, the UE may not receive (or transmit) the other PDSCHs (or PUSCHs). For reference, in a case that the number of pieces of scheduling information is smaller than Xₘₐₓ, a PDSCH (or PUSCH) corresponding to all pieces of scheduling information may be received (or transmitted).

To this end, the UE may select the determined number of pieces of scheduling information from among the multiple pieces of scheduling information. For example, the UE selects the determined number of pieces of scheduling information according to methods below or a combination thereof.

As a first method, the UE may select the determined number of pieces of scheduling information scheduled at the most advanced position in time. The first method is a method for enabling receiving (or transmitting) of PDSCHs (or PUSCHs) in the fastest time.

As a second method, the UE may select the determined number of pieces of scheduling information scheduled at the latest position in time. The second method is a method for selecting scheduling information that may guarantee sufficient time for bandwidth part switching of the UE since PDSCHs (or PUSCHs) scheduled last is received (received or transmitted).

As a third method, the UE may select the determined number of pieces of scheduling information scheduled at the most advanced position in time after a time taken for bandwidth part switching. The UE may complete bandwidth part switching within a time taken for bandwidth part switching after a time point at which the DCI format is received. See Table 3 for the time taken for bandwidth part switching. The UE may receive (or transmit) PDSCHs (or PUSCHs) of certain scheduling information after the time taken for bandwidth part switching. Accordingly, by selecting scheduling information scheduled at the most advanced position in time after a time taken for bandwidth part switching, PDSCHs (or PUSCHs) may be received (or transmitted) in the fastest time. The third method is a method for enabling receiving (or transmitting) of PDSCHs (or PUSCHs) in the fastest time by selecting scheduling information scheduled at the most advanced position in time after a time taken for bandwidth part switching.

The UE may select the determined number of pieces of scheduling information and acquire an NDI value and an RV value of the determined number of pieces of scheduling information from the DCI format. The DCI format received in the active bandwidth part may include a 1-bit NDI field and a 2-bit RV field, or an Xₘₐₓ-bit NDI field and an Xₘₐₓ-bit RV field.

In a case that a TDRA row of the active bandwidth part corresponding to the TDRA field value indicated by the DCI format includes one piece of scheduling information, the DCI format includes a 1-bit NDI field and a 2-bit RV field. Accordingly, the determined number is 1. Therefore, the UE assumes that only the selected one piece of scheduling information is scheduled. The 1-bit NDI field and the 2-bit RV field may indicate an NDI value and an RV value of the selected one piece of scheduling information.

In a case that a TDRA row of the active bandwidth part corresponding to the TDRA field value indicated by the DCI format includes multiple pieces of scheduling information, the DCI format includes an Xₘₐₓ-bit NDI field and an Xₘₐₓ-bit

RV field. Accordingly, the determined number is Xₘₐₓ. Therefore, the UE assumes that the selected Xₘₐₓ pieces of scheduling information are scheduled. Accordingly, the Xₘₐₓ-bit NDI field and the Xₘₐₓ-bit RV field may indicate an NDI value and an RV value of the selected Xₘₐₓ pieces of scheduling information. For reference, in a case that the number Y of pieces of scheduling information is smaller than Xₘₐₓ, all scheduling information is assumed to be scheduled. Accordingly, the Xₘₐₓ-bit NDI field and the Xₘₐₓ-bit RV field may indicate an NDI value and an RV value of the Y pieces of scheduling information.

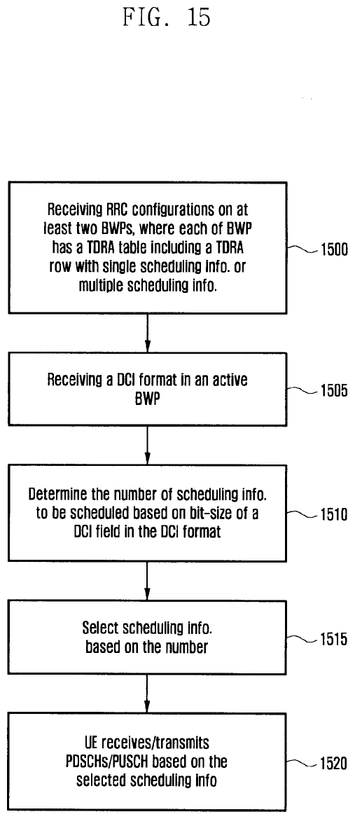

FIG. 15 is a view illustrating an operation of a UE according to an embodiment of the disclosure.

Referring to FIG. 15, in operation 1500, a UE may receive a configuration of at least two bandwidth parts from a higher-layer. A time domain resource allocation (TDRA) table may be configured in each bandwidth part, and each row of the TDRA table may include one piece of scheduling information or multiple pieces of scheduling information.

In operation 1505, the UE may receive a downlink control information (DCI) format in an active bandwidth part of the at least two configured bandwidth parts. A length of a DCI field included in the DCI format is identified based on a configuration of the active bandwidth part.

In operation 1510, the UE may determine the number of pieces of scheduling information based on the length of the DCI field of the received DCI format. The DCI field may include a new data indicator (NDI) field or a redundancy version (RV) field.

In operation 1515, the UE may select the determined number of pieces of scheduling information. The UE may perform operation 1515 according to the first method to third method of embodiment 2-1 and embodiment 2-2, or a combination thereof.

In operation 1520, the UE may receive (or transmit) physical downlink shared channels (PDSCHs) or physical uplink shared channels (PUSCHs) according to the selected determined number of pieces of scheduling information.

### Embodiment 3

As embodiment 3, in a case that a new data indicator (NDI) value of certain scheduling information is zero prepended to be “0”, a UE may ignore “0” and perform one of UE operation methods below.

As a first method, the UE may always assume retransmission. That is, regardless of an NDI value, the UE may assume retransmission of a transport block (TB) included in a PDSCH (or PUSCH) previously scheduled.

For example, the UE receives a PDSCH scheduled in an active bandwidth part at a first time point. The scheduled PDSCH may be indexed with a first NDI value. At a second time point after the first time point, the UE may receive a DCI format indicating bandwidth part switching. If the NDI value of scheduling information in the DCI format is zero prepended to be “0”, the UE may ignore the NDI value of “0” and consider the first NDI value as an NDI value of the corresponding scheduling information. That is, the NDI value of the PDSCH scheduled at the first time point is the same as the NDI value of the PDSCH scheduled in the DCI format indicating bandwidth part switching, thus the UE may identify that the transmission is retransmission.

It may be assumed that there is an HARQ process ID corresponding to the NDI value and a TB corresponding to the HARQ process ID is retransmitted.

As a second method, the UE may always assume new initial transmission. That is, regardless of an NDI value, the UE may assume that a new TB included a PDSCH (or PUSCH) scheduled by the DCI indicating bandwidth part switching is transmitted.

For example, the UE receives a PDSCH scheduled in an active bandwidth part at a first time point. The scheduled PDSCH may be indexed with a first NDI value. At a second time point after the first time point, the UE may receive a DCI format indicating bandwidth part switching. If the NDI value of scheduling information in the DCI format is zero prepended to be “0”, the UE may ignore the NDI value of “0” and consider a value (i.e., “1” if the first NDI value is “0”, and “0” if the first NDI value is “1”) toggled from the first NDI value as an NDI value of the corresponding scheduling information. That is, the NDI value of the PDSCH scheduled at the first time point is different from the NDI value of the PDSCH scheduled in the DCI format indicating bandwidth part switching, thus the UE may identify that the transmission is new initial transmission.

It may be assumed that there is an HARQ process ID corresponding to the NDI value and a TB corresponding to the HARQ process ID is retransmitted.

As a third method, a UE may identify whether transmission is retransmission or new initial transmission from a DCI field of a DCI format. For example, the DCI field is a modulation and coding scheme (MCS) field. In a case that the MSC field indicates only a modulation order, the UE may identify retransmission. In this case, the UE may perform operations according to the first method. On the contrary, in a case that the MSC field indicates a modulation order and a code rate, the UE may identify initial transmission. In this case, the UE may perform operations according to the second method.

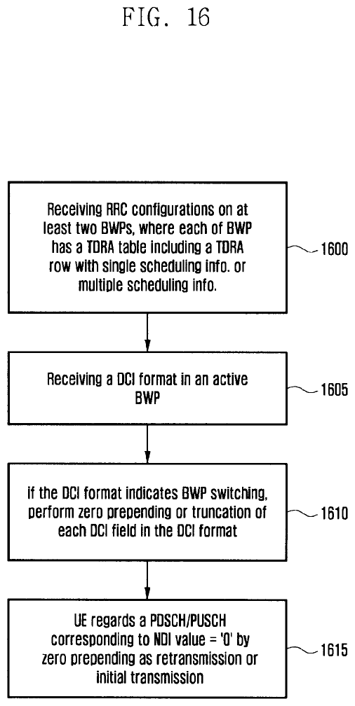

FIG. 16 is a view illustrating an operation of a UE according to an embodiment of the disclosure.

Referring to FIG. 16, in operation 1600, a UE may receive a configuration of at least two bandwidth parts from a higher-layer. A time domain resource allocation (TDRA) table may be configured in each bandwidth part, and each row of the TDRA table may include one piece of scheduling information or multiple pieces of scheduling information.

In operation 1605, the UE may receive a downlink control information (DCI) format in an active bandwidth part of the at least two configured bandwidth parts. A length of a DCI field included in the DCI format is identified based on a configuration of the active bandwidth part.

In operation 1610, in a case that the received DCI format indicates bandwidth part switching, the UE performs zero prepending or truncation to acquire a length of the DCI field required in the indicated bandwidth part with respect to each DCI field of the DCI format.

In operation 1615, the UE may consider the PDSCH (or PUSCH) of which NDI value is determined to be “0” by zero prepending according to the first method to the third method of embodiment 3, or a combination thereof as a PDSCH received through retransmission or through new initial transmission.

Method for Code Block Group (CBG) Field Interpretation

### Embodiment 4

Embodiment 4 of the disclosure provides a method for code block group (CBG) interpretation in case of bandwidth part switching.

For code block group (CBG)-based physical uplink shared channel (PUSCH) transmission, a codeblock group transmission indicator (CBGTI) field may be configured in a downlink control information (DCI) format scheduling a PUSCH. Each bit of the CBGTI field indicates whether a corresponding CBG is included in the PUSCH. If a bit of the CBGTI field is “0”, it indicates that the corresponding CBG is not included in the PUSCH, and if a bit of the CBGTI field is “1”, it indicates that the corresponding CBG is included in the PUSCH. Accordingly, in case of receiving the DCI format scheduling the PUSCH, the UE may identify CBGs including the PUSCH from the CBGTI field.

The CBG-based PUSCH transmission may be commonly configured in bandwidth parts in a cell. That is, CBG-based PUSCH transmission is configured in all bandwidth parts in the cell and regardless of which bandwidth part is activated, the UE may consider that CBG-based PUSCH transmission is possible in all bandwidth parts. Accordingly, the DCI format indicating bandwidth part switching may indicate PUSCH transmission based on the CBG.

Even if the CBG-based PUSCH transmission is configured in all bandwidth parts in the cell, CBG-based transmission may not be possible depending on a TDRA value of the DCI format.

More specifically, in a case that there is one piece of scheduling information scheduled by the TDRA field of the DCI format, the DCI format may include the CBGTI field. That is, in a case that there is one piece of scheduling information scheduled by the TDRA field of the DCI format, CBG-based PUSCH transmission is possible. However, in a case that there are multiple pieces of scheduling information scheduled by the TDRA field of the DCI format, the DCI format may not include the CBGTI field. That is, in a case that there are multiple pieces of scheduling information scheduled by the TDRA field of the DCI format, CBG-based PUSCH transmission is impossible. Accordingly, presence or absence of the CBGTI field of the DCI format may be determined according to the TDRA field value.

Meanwhile, even though the CBGTI field is not included in the received DCI format in the active bandwidth part, the UE may need the CBGTI field for CBG-based PUSCH transmission in the indicated bandwidth part. In this case, according to the zero prepending method described above, the required CBGTI field is not included in the DCI format and thus the CBGTI field may be filled with “0”.

As described above, “0” denotes that the corresponding CBG is not included, and thus the UE may interpret that the CBGs are not included in the PUSCH. The DCI format indicating bandwidth part switching may not schedule the PUSCH. Therefore, embodiment 4 of the disclosure provides a method to solve this problem.

### Embodiment 4-1

As embodiment 4-1, in a case that a CBG transmission information (CBGTI) field is not included in a DCI format indicating bandwidth part switching and a UE needs a CBGTI field for CBG-based PUSCH transmission in an indicated bandwidth part, the UE may not interpret the CBGTI field according to the zero prepending method and may interpret the CBGTI field according to methods described below.

As a first method, the UE may assume that all required CBGTI fields are “1”. That is, since the UE assumes “1” as a bit value of all CBGTI fields, and thus identify that all CBGs are included in the PUSCH. In other words, in a case that bandwidth part switching is indicated, the UE may always identify that the PUSCH including all CBGs is transmitted.

As a second method, the UE may transmit the PUSCH under the assumption of TB-based PUSCH transmission rather than CBG-based PUSCH transmission. The TB-based PUSCH transmission may mean that a TB is not divided into CBG units and transmitted like the CBG-based PUSCH transmission. Therefore, according to the second method, the PUSCH may include the TB.

### Embodiment 4-2

As embodiment 4-2, a CBGTI field is not included in a received DCI format indicating bandwidth part switching, and the UE does not expect that the CBGTI field is needed for CBG-based PUSCH transmission in an indicated bandwidth part. That is, the CBGTI field is not included in the received DCI format indicating bandwidth part switching, and a base station does not indicate, to the UE, a case that the CBGTI field is needed for CBG-based PUSCH transmission in the indicated bandwidth part. In other words, in a case that the CBGTI field is not included in the DCI format indicating bandwidth part switching, the base station needs to indicate a scheduling method not requiring the CBGTI field in the indicated bandwidth part. Only in a case that the CBGTI field is included in the DCI format indicating bandwidth part switching, the base station may indicate a scheduling method requiring the CBGTI field in the indicated bandwidth part.

The case that the CBGTI field is included in the DCI format received in the active bandwidth part may correspond to the case that a TDRA row of the active bandwidth part corresponding to a TDRA field value of the DCI format includes one piece of scheduling information.

The case that the CBGTI field is not included in the DCI format received in the active bandwidth part may correspond to the case that a TDRA row of the active bandwidth part corresponding to a TDRA field value of the DCI format includes multiple pieces of scheduling information.

The case that the CBGTI field is required in the indicated bandwidth part may correspond to the case that the TDRA row of the active bandwidth part corresponding to the TDRA field value of the DCI format includes one piece of scheduling information.

The case that the CBGTI field is not required in the indicated bandwidth part may correspond to the case that the TDRA row of the active bandwidth part corresponding to the TDRA field value of the DCI format includes multiple pieces of scheduling information.

According to embodiment 4-2, in a case that the CBGTI field is required in the indicated bandwidth part, the UE may always acquire the CBGTI field from the DCI format. Accordingly, CBG-based PUSCH transmission may be possible at the same time as bandwidth part switching.

In embodiment 4-2, the base station may not be able to transmit the DCI indicating bandwidth part switching in following cases.

For example, subcarrier spacing of the active bandwidth part of the UE is configured to be 480 kHz or 960 kHz. CBG-based transmission is impossible in the subcarrier spacing. Accordingly, the base station may not configure CBG-based transmission in the active bandwidth part and the DCI format received by the base station in the active bandwidth part does not include a CBG-related field (e.g., the CBGTI field).

Alternatively, subcarrier spacing of the indicated bandwidth part of the UE may be configured to be 120 kHz. CBG-based transmission may be configured in the indicated bandwidth part. Accordingly, in a case that the base station indicates a TDRA row including only one piece of scheduling information in the indicated bandwidth part to the UE through the DCI, CBG-based transmission needs to be performed.

In a case that the base station intends to indicate bandwidth part switching through the DCI to the UE having the active bandwidth part and the indicated bandwidth part, the TDRA row of the indicated bandwidth part corresponding to the TDRA field must include two or more pieces of scheduling information. Otherwise, the base station may not be able to indicate bandwidth part to the UE through the DCI.

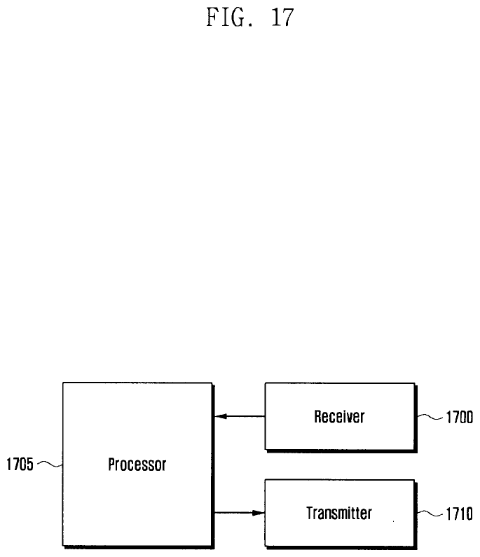

FIG. 17 is a view illustrating a structure of a UE in a wireless communication system according to an embodiment of the disclosure.

Referring to FIG. 17, the UE may include a transceiver indicating a receiver 1700 and a transmitter 1710, a memory (not shown), and a processor 1705 (or a controller). The transceiver (i.e., received 1700 and transmitter 1710), the memory, and the processor 1705 of the UE may operate according to the above-described UE communication method. However, the components of the UE are not limited to the examples described above. For example, the UE includes more or fewer components than the above-described components. In addition, the transceiver, the memory, and the processor may be implemented in the form of a single chip.

The transceiver may transmit or receive a signal to or from a base station. The signal may include control information and data. To this end, the transceiver may include an RF transmitter configured to up-convert and amplify the frequency of the transmitted signal, an RF receiver configured to amplify the received signal with low noise and down-convert the frequency, and the like. However, this is only an embodiment of the transceiver, and the components of the transceiver are not limited to the RF transmitter and the RF receiver.

In addition, the transceiver may receive a signal through a wireless channel, output the signal to the processor, and transmit a signal output from the processor through the wireless channel.

The memory may store programs and data necessary for the operation of the UE. In addition, the memory may store control information or data included in signals transmitted and received by the UE. The memory may include a storage medium such as a ROM, a RAM, a hard disk, a CD-ROM, and a DVD, or a combination of storage media. In addition, there may be multiple memories.

In addition, the processor may control a series of processes so that the UE operates according to the embodiments described above. For example, the processor controls a component of the UE to simultaneously receive multiple PDSCHs by receiving DCI including two layers. There may be multiple processors, and the processor may perform an operation of controlling components of the UE by executing a program stored in the memory.

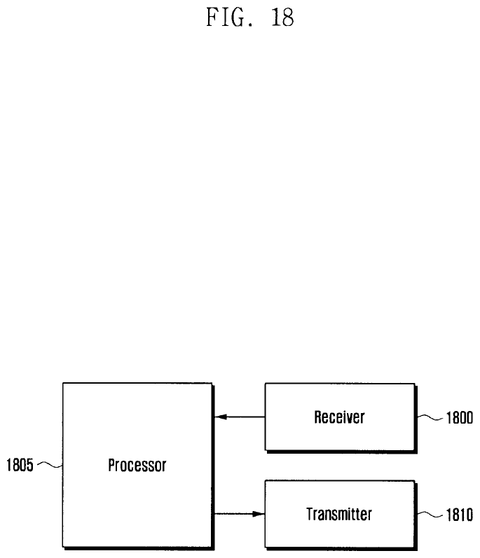

FIG. 18 is a view illustrating a structure of a base station in a wireless communication system according to an embodiment of the disclosure.

Referring to FIG. 18, the base station may include a transceiver indicating a receiver 1800 and a transmitter 1810, a memory (not shown), and a processor 1805 (or a controller). The transceiver (i.e., receiver 1800 and transmitter 1810), the memory, and the processor 1805 may operate according to the above-described base station communication method. However, the components of the base station are not limited to the examples described above. For example, the base station includes more or fewer components than the above-described components. In addition, the transceiver, the memory, and the processor may be implemented in the form of a single chip.

The transceiver may transmit or receive a signal to or from a UE. The signal may include control information and data. To this end, the transceiver may include an RF transmitter configured to up-convert and amplify the frequency of the transmitted signal, an RF receiver configured to amplify the received signal with low noise and down-convert the frequency, and the like. However, this is only an embodiment of the transceiver, and the components of the transceiver are not limited to the RF transmitter and the RF receiver.

In addition, the transceiver may receive a signal through a wireless channel, output the signal to the processor, and transmit a signal output from the processor through the wireless channel.

The memory may store programs and data necessary for the operation of the base station. In addition, the memory may store control information or data included in signals transmitted and received by the base station. The memory may include a storage medium such as a ROM, a RAM, a hard disk, a CD-ROM, and a DVD, or a combination of storage media. In addition, there may be multiple memories.

The processor may control a series of processes so that the base station operates according to an embodiment of the disclosure. For example, the processor controls a component of the base station to configure DCI of two layers including allocation information of multiple PDSCHs and controls each component of the base station in order to transmit the same. There may be multiple processors, and the processor may perform an operation of controlling components of the base station by executing a program stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure is combined with a part of another embodiment to operate a base station and a terminal. As an example, a part of embodiment 1 of the disclosure may be combined with a part of embodiment 2 to operate a base station and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a radio resource control (RRC) message including a time domain resource assignment (TDRA) table information for scheduling multiple physical downlink shared channels (PDSCHs) for at least one bandwidth part (BWP);
receiving, from the base station, downlink control information (DCI) including a bandwidth part indicator field and a time domain resource assignment (TDRA) field on an activated BWP of the base station;
determining whether to switch the activated BWP, based on the bandwidth part indicator field; and
in case that the bandwidth part indicator field indicates to switch the activated BWP, receiving at least one PDSCH on an indicated BWP, based on at least one of the TDRA field, first TDRA table information of the activated BWP, or second TDRA table information of the indicated BWP.

2. The method of claim 1, wherein receiving the at least one PDSCH comprising:
comparing a maximum value of the number of PDSCH scheduling information configured in each row of the first TDRA table and the number of PDSCH scheduling information corresponding to a row indicated by the TDRA field in the second TDRA table; and
in case that the maximum value of the number of PDSCH scheduling information configured in each row of the first TDRA table is greater than or equal to the number of PDSCH scheduling information corresponding to the row indicated by the TDRA field in the second TDRA table, receiving the at least one PDSCH on the indicated BWP based on at least one information included in the DCI.

3. The method of claim 2, wherein receiving the at least one PDSCH comprising:
interpreting a partial field of a new data indication (NDI) field or a redundancy version (RV) field included in the DCI format as a field for receiving the at least one PDSCH on the indicated BWP.

4. The method of claim 1, wherein receiving the at least one PDSCH comprising:
identifying whether the TDRA field is valid based on the number of PDSCH scheduling information configured in a row indicated by the TDRA field in the first TDRA table and the number of PDSCH scheduling information corresponding to a row indicated by the TDRA field in the second TDRA table; and
in case that the TDRA field of the received DCI is determined to be valid, receiving the at least one PDSCH on the indicated BWP based on the received DCI.

5. The method of claim 4, wherein identifying whether the TDRA field is valid comprising:
in case that each of the number of PDSCH scheduling information corresponding to a row indicated by the TDRA field in the first TDRA table and the number of PDSCH scheduling information corresponding to a row indicated by the TDRA field in the second TDRA table is one;
in case that the number of PDSCH scheduling information corresponding to a row indicated by the TDRA field in the second TDRA table is one;
in case that the number of PDSCH scheduling information corresponding to a row indicated by the TDRA field in the first TDRA table and the number of PDSCH scheduling information corresponding to a row indicated by the TDRA field in the second TDRA table are equal to each other;
in case that the number of PDSCH scheduling information corresponding to a row indicated by the TDRA field in the first TDRA table is greater than or equal to the number of PDSCH scheduling information corresponding to a row indicated by the TDRA field in the second TDRA table; or
in case that the number of PDSCH scheduling information corresponding to a row indicated by the TDRA field in the first TDRA table is greater than or equal to a maximum value of the number of PDSCH scheduling information configured in each row of the second TDRA table,
determining that the TDRA field is valid.

6. The method of claim 1, the method further comprising:
receiving a PDSCH based on scheduling information on at least one PDSCH of scheduling information on a PDSCH of a row of a TDRA table on the indicated BWP corresponding to the row indicated by the TDRA field.

7. The method of claim 1, the method further comprising:
in case that a new data indicator (NDI) field included in the DCI is zero prepended, considering a PDSCH corresponding to 0 due to the zero prepending as a PDSCH received through retransmission or through new initial transmission, or determining whether the PDSCH is received through retransmission or not based on an MCS field included in the DCI.

8. The method of claim 1,
wherein the TDRA table information includes at least one of K0, start length indicator value (SLIV), and PDSCH mapping type, and
wherein the DCI includes at least one of a new data indicator (NDI) field and redundancy version (RV) field.

9. A method performed by a base station in a wireless communication system, the method comprising:
Transmitting, to a user equipment (UE), a radio resource control (RRC) message including a time domain resource assignment (TDRA) table information for scheduling multiple physical downlink shared channels (PDSCHs) for at least one bandwidth part (BWP); and
transmitting, to the UE, downlink control information (DCI) including a bandwidth part indicator field and a time domain resource assignment (TDRA) field on an activated BWP,
wherein whether to switch the activated BWP is determined based on the bandwidth part indicator field, and
wherein at least one PDSCH is received on the indicated BWP based on at least one of the TDRA field, first TDRA table information of the activated BWP, or second TDRA table information of an indicated BWP.

10. The method of claim 9, the method further comprising:
in case that the maximum value of the number of PDSCH scheduling information configured in each row of the first TDRA table is greater than or equal to the number of of PDSCH scheduling information corresponding to a row indicated by the TDRA field in the second TDRA table, scheduling to receive the at least one PDSCH on the indicated BWP based on at least one information included in the DCI.

11. A user equipment (UE) in a wireless communication system, the UE comprising:
a transceiver configured to transmit or receive a signal; and
at least one processor,
wherein the at least one processor is configured to:
receive, from a base station, a radio resource control (RRC) message including a time domain resource assignment (TDRA) table information for scheduling multiple physical downlink shared channels (PDSCHs) for each of at least one bandwidth part (BWP),
receive, from the base station, downlink control information (DCI) including a bandwidth part indicator field and a time domain resource assignment (TDRA) field on an activated BWP of the base station,
determine whether to switch the activated BWP, based on the bandwidth part indicator field, and
in case that the bandwidth part indicator field indicates to switch the activated BWP, receive at least one PDSCH on an indicated BWP, based on at least one of the TDRA field, first TDRA table information of the activated BWP, or second TDRA table information of the indicated BWP.

12. The UE of claim 11, wherein the at least one processor is further configured to:
compare a maximum value of the number of PDSCH scheduling information configured in each row of the first TDRA table and the number of PDSCH scheduling information corresponding to a row indicated by the TDRA field in the second TDRA table; and
in case that the maximum value of the number of PDSCH scheduling information configured in each row of the first TDRA table is greater than or equal to the number of PDSCH scheduling information corresponding to the row indicated by the TDRA field in the second TDRA table, receive the at least one PDSCH on the indicated BWP based on at least one information included in the DCI.

13. The UE of claim 12, wherein the at least one processor is further configured to:
interpret a partial field of a new data indication (NDI) field or a redundancy version (RV) field included in the DCI format as a field for receiving the at least one PDSCH on the indicated BWP.

14. The UE of claim 11, wherein the at least one processor is further configured to:
identify whether the TDRA field is valid based on the number of PDSCH scheduling information configured in a row indicated by the TDRA field in the first TDRA table and the number of PDSCH scheduling information corresponding to a row indicated by the TDRA field in the second TDRA table; and
in case that the TDRA field of the received DCI is determined to be valid, receive the at least one PDSCH on the indicated BWP based on the received DCI.

15. The UE of claim 14, wherein the at least one processor is further configured to determine that the TDRA field is valid:
in case that each of the number of PDSCH scheduling information corresponding to a row indicated by the TDRA field in the first TDRA table and the number of PDSCH scheduling information corresponding to a row indicated by the TDRA field in the second TDRA table is one;
in case that the number of PDSCH scheduling information corresponding to a row indicated by the TDRA field in the second TDRA table is one,
in case that the number of PDSCH scheduling information corresponding to a row indicated by the TDRA field in the first TDRA table and the number of PDSCH scheduling information corresponding to a row indicated by the TDRA field in the second TDRA table are equal to each other;
in case that the number of PDSCH scheduling information corresponding to a row indicated by the TDRA field in the first TDRA table is greater than or equal to the number of PDSCH scheduling information corresponding to a row indicated by the TDRA field in the second TDRA table; or
in case that the number of PDSCH scheduling information corresponding to a row indicated by the TDRA field in the first TDRA table is greater than or equal to a maximum value of the number of PDSCH scheduling information configured in each row of the second TDRA table.

16. The UE of claim 11, wherein the at least one processor is further configured to receive a PDSCH based on scheduling information on at least one PDSCH among scheduling information on a PDSCH of a row of a TDRA table on the indicated BWP corresponding to the row indicated by the TDRA field.

17. The UE of claim 11, wherein the at least one processor is further configured to:
in case that a new data indicator (NDI) field included in the DCI is zero prepended, consider a PDSCH corresponding to 0 due to the zero prepending as a PDSCH received through retransmission or through new initial transmission, or determine whether the PDSCH is received through retransmission or not, based on an MCS field included in the DCI.

18. The UE of claim 11,
wherein the TDRA table information includes at least one of K0, start length indicator value (SLIV), and PDSCH mapping type, and
wherein the DCI includes at least one of a new data indicator (NDI) field and redundancy version (RV) field.

19. A base station in a wireless communication system, the base station comprising:
a transceiver configured to transmit or receive a signal; and
at least one processor,
wherein the at least one processor is configured to:
transmit, to a user equipment (UE) a radio resource control (RRC) message including a time domain resource assignment (TDRA) table information for scheduling multiple physical downlink shared channels (PDSCHs) for each of at least one bandwidth part (BWP) to a user equipment (UE), and
transmit, to the UE, downlink control information (DCI) including a bandwidth part indicator field and a time domain resource assignment (TDRA) field on an activated BWP,
wherein whether to switch the activated BWP is determined based on the bandwidth part indicator field, and
wherein at least one PDSCH is received on an indicated BWP based on at least one of the TDRA field, first TDRA table information of the activated BWP, or second TDRA table information of the indicated BWP.

20. The base station of claim 19, wherein the at least one processor is further configured to:
in case that the maximum value of the number of PDSCH scheduling information configured in each row of the first TDRA table is greater than or equal to the number of PDSCH scheduling information corresponding to a row indicated by the TDRA field in the second TDRA table, schedule to receive the at least one PDSCH on the indicated BWP based on at least one information included in the DCI.
